(19) United States
(12) Patent Application Publication
(10) Pub. No.: US 2026/0195658 A1
(43) Pub. Date: Jul. 9, 2026

(54) DOMAIN-SPECIFIC NATURAL LANGUAGE DATA GENERATION BASED ON ITERATIVE VALIDATION OF DOMAIN-SPECIFIC ONTOLOGICAL DATA

(71) Applicant: Citibank, N.A., New York, NY (US)

(72) Inventors: Ramee S. KARTHIKEYAN, Monmouth Junction, NJ (US); Ganesh Prasad BHAT, West Orange, NJ (US); John E. ORTEGA, New York, NY (US); James Randolph MYERS, Clearwater Beach, FL (US); Tariq Husayn MAONAH, London (GB)

(21) Appl. No.: 19/376,612

(22) Filed: Oct. 31, 2025

Related U.S. Application Data
(63) Continuation-in-part of application No. 19/369,205, filed on Oct. 25, 2025.
Application No. 19/369,205 is a continuation-in-part of application No. 19/334,772, filed on Sep. 19, 2025.
Application No. 19/334,772 is a continuation-in-part of application No. 19/050,102, filed on Feb. 10, 2025.
(63) Continuation-in-part of application No. 19/369,206, filed on Oct. 25, 2025.
Application No. 19/369,206 is a continuation-in-part of application No. 19/334,772, filed on Sep. 19, 2025.
Application No. 19/334,772 is a continuation-in-part of application No. 19/050,102, filed on Feb. 10, 2025.
(63) Continuation-in-part of application No. 19/334,772, filed on Sep. 19, 2025.
Application No. 19/334,772 is a continuation-in-part of application No. 19/050,102, filed on Feb. 10, 2025.
(63) Continuation-in-part of application No. 19/050,102, filed on Feb. 10, 2025.
(63) Continuation-in-part of application No. 19/319,633, filed on Sep. 4, 2025, now Pat. No. 12,614,124.
Application No. 19/319,633 is a continuation-in-part of application No. 19/038,662, filed on Jan. 27, 2025.
(63) Continuation-in-part of application No. 19/038,662, filed on Jan. 27, 2025.
Application No. 19/038,662 is a continuation of application No. 18/781,985, filed on Jul. 23, 2024, now Pat. No. 12,210,949.
Application No. 18/781,985 is a continuation-in-part of application No. 18/535,001, filed on Dec. 11, 2023, now Pat. No. 12,045,610.
(63) Continuation-in-part of application No. 19/061,982, filed on Feb. 24, 2025.
Application No. 19/061,982 is a continuation-in-part of application No. 18/781,965, filed on Jul. 23, 2024, now Pat. No. 12,271,720.
Application No. 18/781,965 is a continuation-in-part of application No. 18/535,001, filed on Dec. 11, 2023, now Pat. No. 12,045,610.
(63) Continuation-in-part of application No. PCT/US24/51150, filed on Oct. 11, 2024.
Application No. PCT/US24/51150 is a continuation of application No. 18/669,421, filed on May 20, 2024, now Pat. No. 12,182,539.
Application No. 18/669,421 is a continuation of application No. 18/535,001, filed on Dec. 11, 2023, now Pat. No. 12,045,610.
Application No. 18/535,001 is a continuation of application No. 18/781,965, filed on Jul. 23, 2024, now Pat. No. 12,271,720.
Application No. 18/781,965 is a continuation of application No. 18/781,977, filed on Jul. 23, 2024, now Pat. No. 12,210,858.
Application No. 18/781,977 is a continuation of application No. 18/781,985, filed on Jul. 23, 2024, now Pat. No. 12,210,949.
(63) Continuation-in-part of application No. 18/951,120, filed on Nov. 18, 2024.
Application No. 18/951,120 is a continuation of application No. 18/633,293, filed on Apr. 11, 2024, now Pat. No. 12,147,513.
(63) Continuation-in-part of application No. 18/907,414, filed on Oct. 4, 2024.
Application No. 18/907,414 is a continuation of application No. 18/661,532, filed on May 10, 2024, now Pat. No. 12,111,747.
Application No. 18/661,532 is a continuation-in-part of application No. 18/661,519, filed on May 10, 2024, now Pat. No. 12,106,205.
Application No. 18/661,519 is a continuation-in-part of application No. 18/633,293, filed on Apr. 11, 2024, now Pat. No. 12,147,513.
(63) Continuation-in-part of application No. 19/196,702, filed on May 1, 2025, now Pat. No. 12,602,624.
Application No. 19/196,702 is a continuation-in-part of application No. 18/669,421, filed on May 20, 2024, now Pat. No. 12,182,539.
Application No. 18/669,421 is a continuation-in-part of application No. 18/535,001, filed on Dec. 11, 2023, now Pat. No. 12,045,610.

(51) Int. Cl. G06N 20/20

(52) U.S. Cl. CPC G06N 20/20

(57) ABSTRACT

The systems and methods disclosed herein enable generation of domain-specific data using generative artificial intelligence models by leveraging domain-specific ontology maps and lexical data. For example, the system can obtain an input prompt, a domain-specific key-value dataset and a domain-specific ontology map. The system can input the input prompt, key-value dataset, and ontology map into a domain-sensitive artificial intelligence (AI) model to generate an output that can be validated for adherence to domain-specified constraints and/or for domain-specificity by comparison with a generalized output by a non-specialized base model. Based on the validation, the system can transmit the generated output to a suitable device for data dissemination, use, or validation.

### CROSS-REFERENCE TO RELATED APPLICATIONS

This application is a continuation-in-part of U.S. patent application Ser. No. 19/369,205, entitled “FEDERATED SYNTHETIC DATA GENERATION BASED ON BYZANTINE-ROBUST MODEL PARAMETER UPDATE AGGREGATION” and filed Oct. 25, 2025, which is a continuation-in-part of U.S. patent application Ser. No. 19/334,772, entitled “ARTIFICIAL INTELLIGENCE-BASED, GRAPH-DRIVEN SYNTHETIC DATA GENERATION WITH STATISTICAL DISTRIBUTION AND TEMPORAL PATTERN PRESERVATION” and filed Sep. 19, 2025, which is a continuation-in-part of U.S. patent application Ser. No. 19/050,102 entitled “APPLICATION DOMAIN-BASED GENERATION AND CALIBRATION OF SYNTHETIC DATASETS USING ARTIFICIAL INTELLIGENCE MODELS” and filed Feb. 10, 2025. The content of the foregoing applications is incorporated herein by reference in its entirety.

This application is a continuation-in-part of U.S. patent application Ser. No. 19/369,206, entitled “POST-GENERATION INPUT STREAM MODIFICATION FOR INFERRED NETWORK-BASED SIMULATED DATA” and filed Oct. 25, 2025, which is a continuation-in-part of U.S. patent application Ser. No. 19/334,772, entitled “ARTIFICIAL INTELLIGENCE-BASED, GRAPH-DRIVEN SYNTHETIC DATA GENERATION WITH STATISTICAL DISTRIBUTION AND TEMPORAL PATTERN PRESERVATION” and filed Sep. 19, 2025, which is a continuation-in-part of U.S. patent application Ser. No. 19/050,102 entitled “APPLICATION DOMAIN-BASED GENERATION AND CALIBRATION OF SYNTHETIC DATASETS USING ARTIFICIAL INTELLIGENCE MODELS” and filed Feb. 10, 2025. The content of the foregoing applications is incorporated herein by reference in its entirety.

This application is a continuation-in-part of U.S. patent application Ser. No. 19/334,772, entitled “ARTIFICIAL INTELLIGENCE-BASED, GRAPH-DRIVEN SYNTHETIC DATA GENERATION WITH STATISTICAL DISTRIBUTION AND TEMPORAL PATTERN PRESERVATION” and filed Sep. 19, 2025, which is a continuation-in-part of U.S. patent application Ser. No. 19/050,102 entitled “APPLICATION DOMAIN-BASED GENERATION AND CALIBRATION OF SYNTHETIC DATASETS USING ARTIFICIAL INTELLIGENCE MODELS” and filed Feb. 10, 2025. The content of the foregoing applications is incorporated herein by reference in its entirety.

This application is a continuation-in-part of U.S. patent application Ser. No. 19/050,102, entitled “APPLICATION DOMAIN-BASED GENERATION AND CALIBRATION OF SYNTHETIC DATASETS USING ARTIFICIAL INTELLIGENCE MODELS” and filed Feb. 10, 2025. The content of the foregoing application is incorporated herein in its entirety by reference.

This application is a continuation-in-part of U.S. patent application Ser. No. 19/319,633, filed Sep. 4, 2025, entitled “THRESHOLD-BASED ADAPTIVE ONTOLOGY AND KNOWLEDGE GRAPH MODIFICATION USING GENERATIVE ARTIFICIAL INTELLIGENCE”, which is a continuation-in-part of U.S. patent application Ser. No. 19/038,662, filed Jan. 27, 2025, entitled “SYSTEMS AND METHODS FOR DETECTING REQUIRED RULE ENGINE UPDATED USING ARTIFICIAL INTELLIGENCE MODELS”. The content of the foregoing application is incorporated herein in its entirety by reference.

This application is a continuation-in-part of U.S. patent application Ser. No. 19/038,662, filed Jan. 27, 2025, entitled “SYSTEMS AND METHODS FOR DETECTING REQUIRED RULE ENGINE UPDATED USING ARTIFICIAL INTELLIGENCE MODELS”, which is a continuation of U.S. patent application Ser. No. 18/781,985, filed Jul. 23, 2024, entitled “SYSTEMS AND METHODS FOR DETECTING REQUIRED RULE ENGINE UPDATED USING ARTIFICIAL INTELLIGENCE MODELS”, which is a continuation-in-part of U.S. patent application Ser. No. 18/535,001, filed Dec. 11, 2023, entitled “SYSTEMS AND METHODS FOR UPDATING RULE ENGINES DURING SOFTWARE DEVELOPMENT USING GENERATED PROXY MODELS WITH PREDEFINED MODEL DEPLOYMENT CRITERIA”. The content of the foregoing applications is incorporated herein in their entirety by reference.

This application is a continuation-in-part of U.S. patent application Ser. No. 19/061,982, filed Feb. 24, 2025, entitled “SYSTEMS AND METHODS FOR GENERATING ARTIFICIAL INTELLIGENCE MODELS AND/OR RULE ENGINES WITHOUT REQUIRING TRAINING DATA THAT IS SPECIFIC TO MODEL COMPONENTS AND OBJECTIVES”, which is a continuation-in-part of U.S. patent application Ser. No. 18/781,965, filed Jul. 23, 2024, entitled “SYSTEMS AND METHODS FOR DETECTING REQUIRED RULE ENGINE UPDATES USING ARTIFICIAL INTELLIGENCE MODELS”, which is a continuation-in-part of U.S. patent application Ser. No. 18/535,001, filed Dec. 11, 2023, entitled “SYSTEMS AND METHODS FOR UPDATING RULE ENGINES DURING SOFTWARE DEVELOPMENT USING GENERATED PROXY MODELS WITH PREDEFINED MODEL DEPLOYMENT CRITERIA”. The content of the foregoing applications is incorporated herein in their entirety by reference.

This application is a continuation-in-part of International Application No. PCT/US2024/051150, filed Oct. 11, 2024, entitled “SYSTEMS AND METHODS FOR DETECTING REQUIRED RULE ENGINE UPDATED USING ARTIFICIAL INTELLIGENCE MODELS”, which claims benefit priority of U.S. patent application Ser. No. 18/669,421, filed May 20, 2024, entitled “SYSTEMS AND METHODS FOR MODIFYING DECISION ENGINES DURING SOFTWARE DEVELOPMENT USING VARIABLE DEPLOYMENT CRITERIA”, U.S. patent application Ser. No. 18/535,001, filed Dec. 11, 2023, entitled “SYSTEMS AND METHODS FOR UPDATING RULE ENGINES DURING SOFTWARE DEVELOPMENT USING GENERATED PROXY MODELS WITH PREDEFINED MODEL DEPLOYMENT CRITERIA”, U.S. patent application Ser. No. 18/781,965, filed Jul. 23, 2024, entitled “SYSTEMS AND METHODS FOR DETECTING REQUIRED RULE ENGINE UPDATES USING ARTIFICIAL INTELLIGENCE MODELS”, U.S. patent application Ser. No. 18/781,977, filed Jul. 23, 2024, entitled “SYSTEMS AND METHODS FOR DETECTING REQUIRED RULE ENGINE UPDATED USING ARTIFICIAL INTELLIGENCE MODELS”, U.S. patent application Ser. No. 18/781,985, filed Jul. 23, 2024, entitled “SYSTEMS AND METHODS FOR DETECTING REQUIRED RULE ENGINE UPDATED USING ARTIFICIAL INTELLIGENCE MODELS”. The content of the foregoing applications is incorporated herein in their entirety by reference.

This application is a continuation-in-part of U.S. application Ser. No. 18/951,120, filed Nov. 18, 2024, entitled “DYNAMIC EVALUATION OF LANGUAGE MODEL PROMPTS FOR MODEL SELECTION AND OUTPUT VALIDATION AND METHODS AND SYSTEMS OF THE SAME”, which is a continuation of U.S. application Ser. No. 18/633,293, filed Apr. 11, 2024, entitled “DYNAMIC EVALUATION OF LANGUAGE MODEL PROMPTS FOR MODEL SELECTION AND OUTPUT VALIDATION AND METHODS AND SYSTEMS OF THE SAME”. The content of the foregoing applications is incorporated herein in their entirety by reference.

This application is a continuation-in-part of U.S. application Ser. No. 18/907,414, filed Oct. 4, 2024, entitled “DYNAMIC INPUT-SENSITIVE VALIDATION OF MACHINE LEARNING MODEL OUTPUTS AND METHODS AND SYSTEMS OF THE SAME”, which is a continuation of U.S. application Ser. No. 18/661,532, filed May 10, 2024, entitled “DYNAMIC INPUT-SENSITIVE VALIDATION OF MACHINE LEARNING MODEL OUTPUTS AND METHODS AND SYSTEMS OF THE SAME”, which is a continuation-in-part of U.S. application Ser. No. 18/661,519, filed May 10, 2024, entitled “DYNAMIC, RESOURCE-SENSITIVE MODEL SELECTION AND OUTPUT GENERATION AND METHODS AND SYSTEMS OF THE SAME”, which is a continuation-in-part of U.S. application Ser. No. 18/633,293, filed Apr. 11, 2024, entitled “DYNAMIC EVALUATION OF LANGUAGE MODEL PROMPTS FOR MODEL SELECTION AND OUTPUT VALIDATION AND METHODS AND SYSTEMS OF THE SAME”. The content of the foregoing applications is incorporated herein in their entirety by reference.

This application is a continuation-in-part of U.S. application Ser. No. 19/196,702, filed May 1, 2025, entitled “ANOMALY DETECTION METHOD FOR MODEL OUTPUTS”, which is a continuation of U.S. patent application Ser. No. 18/669,421, filed May 20, 2024, entitled “SYSTEMS AND METHODS FOR MODIFYING DECISION ENGINES DURING SOFTWARE DEVELOPMENT USING VARIABLE DEPLOYMENT CRITERIA”, which is a continuation-in-part of U.S. patent application Ser. No. 18/535,001, filed Dec. 11, 2023, entitled “SYSTEMS AND METHODS FOR UPDATING RULE ENGINES DURING SOFTWARE DEVELOPMENT USING GENERATED PROXY MODELS WITH PREDEFINED MODEL DEPLOYMENT CRITERIA”. The content of the foregoing applications is incorporated herein in their entirety by reference.

### BACKGROUND

Computational developments in artificial intelligence, coupled with improved, flexible mechanisms for representing complex lexical, semantic, and structural attributes of natural language in a mathematically and computationally tractable way have enabled generative artificial intelligence models to produce natural text, images, or multimedia based on prompts. Generative artificial intelligence models can learn underlying patterns and structures in training data and use them to generate new data based on the input, which often comes in the form of natural language prompts. Generative artificial intelligence models leverage architectures including variational autoencoders, generative adversarial networks, transformer networks, and/or other machine learning-based techniques to generate data based on training data. For example, generative artificial intelligence models are used to enable prompt-based user interactions (e.g., in the context of chatbots), text-to-image generators, and virtual assistants. As such, generative artificial intelligence models are increasingly deployed across diverse application domains or industries, including in software development, healthcare, writing, and product design.

Training artificial intelligence models can rely on generating predicted outputs based on a training dataset and comparing the predicted outputs with ground-truth data. Based on the difference between the two data sets, the artificial intelligence model parameters can be iteratively adjusted to improve the model's fit to the training dataset. Challenges to training artificial intelligence models can stem from insufficient training data, including omissions in particular circumstances represented therein, obsolescence, or ambiguous data.

### BRIEF DESCRIPTION OF THE DRAWINGS

FIG. 1 illustrates an example environment including a data generation platform, in accordance with one or more implementations of the disclosed technology.

FIG. 2 illustrates an example system for generating validated, domain-specific natural language outputs by using domain-specific ontology information and associated lexical data, in accordance with one or more implementations of the disclosed technology.

FIG. 3 illustrates a workflow for multi-agent, iterative generation and multi-step validation of domain-specific information, in accordance with one or more implementations of the disclosed technology.

FIG. 4 illustrates an example architecture for a domain-specific generation engine, in accordance with one or more implementations of the disclosed technology.

FIG. 5 illustrates an example architecture for an ontology validation engine, in accordance with one or more implementations of the disclosed technology.

FIG. 6 illustrates an example flowchart for a process for multi-agent generation and validation of domain-specific information based on ontological and lexical properties associated with the domain, in accordance with one or more implementations of the disclosed technology.

FIG. 7A illustrates an example of a data generation platform architecture that employs bidirectional integration between statistical inference and knowledge network generation, in accordance with one or more implementations of the disclosed technology.

FIG. 7B illustrates an example of a system architecture for generating simulated data based on real-world data, in accordance with one or more implementations of the disclosed technology.

FIG. 8A illustrates a knowledge network showing entity nodes and associated explicit relationships, in accordance with one or more implementations of the disclosed technology.

FIG. 8B illustrates an inferred entity-relationship network including modifications to the knowledge network of FIG. 8A, in accordance with one or more implementations of the disclosed technology.

FIG. 9 illustrates an example flowchart for a process for graph-driven synthetic data generation based on statistical inference of interdependencies and constraints, in accordance with one or more implementations of the disclosed technology.

FIG. 10A illustrates an example architecture for an anomaly preservation framework associated with the data generation platform, in accordance with one or more implementations of the disclosed technology.

FIG. 10B illustrates an example of a privacy preservation framework associated with the data generation platform, in accordance with one or more implementations of the disclosed technology.

FIG. 11 illustrates a layered architecture of an artificial intelligence (AI) model system that can implement the machine learning models of the data generation platform, in accordance with one or more implementations of the disclosed technology.

FIG. 12 is a block diagram of an example transformer, in accordance with one or more implementations of the disclosed technology.

FIG. 13 is a block diagram showing some of the components typically incorporated in at least some of the computer systems and other devices on which the data generation platform, in accordance with one or more implementations of the disclosed technology.

### DETAILED DESCRIPTION

As natural language generation platforms, such as generative large-language models (LLMs), consume more training data, they have exhibited significant improvements in accuracy and subject area coverage. For example, large-language models are leveraged in software engineering applications, hardware and materials selection applications, and the provision of educational and healthcare services. In order to handle the generation of textual or multimedia content in such a broad array of subject areas, conventional generative AI models rely on a corpus of training data spanning a representative portion (e.g., a region in semantic vector space) of intended domains. While the conventional approach to configuring generative AI models can be effective in producing high-level, general-purpose data relating to a variety of types of input prompts (e.g., associated with different domains), the approach relies on extensive, annotated training data that covers all domains of knowledge or expertise that are implicated within the input prompt. As such, the approach can suffer from scalability and performance issues, requiring linear or exponential increases in required training data as the number of domains covered by the model increases.

Moreover, because conventional AI models rely on training model parameters using the entirety of the provided training data, the AI models are configured to generate output data based on large-scale patterns across various domains represented within the training data. As such, even when comprehensive training datasets are available, the model parameters are determined based on patterns identified across the entire training corpus, resulting in situations where patterns within a particular region of the semantic vector space (e.g., corresponding to a particular subject-area or semantic domain) are not adequately captured to a suitable granularity. Thus, model optimization processes within conventional AI models, when training model parameters, often prioritize larger-scale natural language patterns that span multiple domains at the expense of finer-scale, domain-specific patterns. Consequently, the training methodology of conventional systems can lead to highly generalized outputs that are ill-suited to particular applications requiring specialized knowledge, terminology, jargon, or domain-specific constraints. The resulting models can generate outputs that appear linguistically coherent but lack precision, accuracy, or compliance requirements necessary for specialized use cases in high-technology fields, such as semiconductor engineering, hardware configuration, software engineering, biomedical device engineering, or other specialized fields. The limitation of conventional generative AI models can become particularly problematic in compliance-critical applications, where domain-specific accuracy can be essential for regulatory or safety requirements, such as where a particular architecture or output of the model is to satisfy a pre-defined technological standard.

As an illustrative example, a user can request that a conventional artificial intelligence model generate a schematic for a hardware architecture for a specified computing system. However, the corpus of training data used within the conventional artificial intelligence model often includes various domains where the term “architecture” is used, even within the context of computing-related applications. For example, the word “architecture” in the desired hardware-related domain can refer to a specific, precise physical arrangement of hardware components within a computational device, including the organization of central processing units (CPUs), input/output devices (I/O) streams and associated bus structures, cache hierarchies, or memory devices, as well as the physical or wireless connections between the components. However, the same word in a software engineering or data science context can indicate a more abstract reading of the term, where “architecture” can refer to an abstract, logical organization of software and hardware modules (e.g., defined by functionality instead of by device-type), including configuration information relating to data flows, design patterns, microservices, or layers within the software architecture. As such, even a single device or technology area can exhibit different sub-domains of semantic constraints or patterns, requiring varying treatment of a particular query or prompt by a user.

A conventional generative artificial intelligence system can confuse the two contexts, particularly where the contexts overlap (as in the case of “architecture”). For example, a conventional generative artificial intelligence model responding to a user requesting a schematic for a hardware architecture for a high-performance computing cluster can provide an unsuitably abstract textual output describing a logical data flow within a high-performance computing environment (e.g., in the context of software architecture), rather than the intended, physical description of an arrangement of hardware components within the high-performance computing cluster. In response, a user can manually re-format the prompt with an instruction (e.g., “No, what I meant was a hardware architecture that includes a physical arrangement of components, not just a logical flow or map!”), thereby requiring further expenditure of computational resources and time and leading to significant inefficiencies. Moreover, depending on the quality of the training data, training algorithm, and model architecture, the resulting, modified output can still exhibit imprecision or inaccuracies that require further tuning.

A conventional model can improve its treatment of domain-specific information by fine-tuning a model for each intended domain or application. For example, a conventional, pre-trained generative AI model can be retrained on training data that is specific to the intended application of the user, thereby encouraging retraining of the model parameters such that they capture domain-specific, granular patterns in natural language. However, the approach requires a significant amount of domain-specific data or information that can be impossible or expensive to obtain. Moreover, because many or all model parameters within the model may need to be varied to accurately capture domain-specific lexicon, syntax, or semantics, the training process can require significant computational resources and time prior to accepting inputs (e.g., prompts), thereby precluding applications where a user requests information relating to a domain for which the model has not already been fine-tuned. Similarly, when domain-specific information is dynamic (e.g., in the case of rapidly evolving technologies, fields, or regulatory frameworks), re-training models can be infeasible and unscalable as the models are to be retrained upon each modification or change.

To improve domain-specific generation of output data based on input prompts, some generative AI systems can leverage in-context learning to improve the applicability of the output to the particular domain. For example, a generative artificial intelligence model that leverages a decoder structure can add additional information (e.g., domain-specific information) to the context window (e.g., in addition to the prompt and/or any other relevant context, such as a conversation history) on which self-attention is performed prior to generation of the output. As an illustrative example, the generative AI model can generate an updated context window that includes examples of domain-specific outputs (e.g., as constrained by required regulatory rules) and generate the output based on the updated context window. However, technical constraints relating to the number of tokens allowed within the context window can limit the approach in terms of the number of examples that can be provided. Moreover, the approach does not enable strict enforcement of domain constraints (e.g., that are not included within the context window or that are not afforded sufficient attention within the self-attention mechanism), thereby enabling generation of outputs that are not entirely compliant with domain-specific patterns, rules, or constraints, particularly where ontological relationships are to be preserved accurately and are, therefore, to be weighted heavily in model generation. Moreover, due to variations in the treatment of the context window from model run to model run (e.g., depending on how attention is calculated for each prompt or context window), generated outputs can suffer from inconsistency across different model runs.

Retrieval-augmented generation (RAG) methods can improve some of the limitations of a context window-based approach to domain-specific natural language generation by improving the flexibility, relevance, and variety of information that can be provided to the model. For example, based on a user's prompt, a conventional RAG-based system can retrieve information, documents, or other suitable data structures from a database that is domain-specific according to the prompt. However, such systems can struggle to achieve a significant improvement in accuracy and specificity in AI model output generation. For example, the database or repository may not include sufficient domain-specific information (e.g., for new domains implicated in received user prompts), thereby reducing the scalability of the generation platform across increasing numbers of domains. Moreover, the quality of the generated data can depend on decisions associated with which documents or data structures to receive, which adds a potential source of errors in output generation. For example, two documents retrieved in response to a user prompt can include semantically or logically inconsistent information or irrelevant information, thereby leading to issues with adherence to formal logical constraints or ontological structures associated with the particular domain. Additionally, the performance of RAG-based domain-specific AI generation can degrade for highly specialized or niche domains, as the amount of documentation relevant to the particular domain can be limited. For example, while a RAG database can include significant documentation relating to hardware and software architectures for computing devices at a high level, the database may not have sufficient documentation for a domain constrained by a particular subdomain of architecture types within the larger domains (e.g., hardware microarchitecture or circuit architecture).

The conventional domain-specific generative AI methods can also fail to account for rapid changes in highly dynamic domains or fields. For example, in situations where hardware architectures change rapidly (e.g., due to advancements in memory device types or device architectures), conventional training data and/or associated RAG-based documentation can quickly become obsolete, thereby increasing the computational and temporal costs of updating databases or training data to maintain synchronization as the domain evolves. Moreover, while such conventional generative AI systems can capture domain-specific lexical features to varying degrees of success, the models can fail to capture logic-based or reasoning-based hierarchies, relationships, or definitions, leading to logical or semantic (e.g., as opposed to lexical) inconsistencies within the generated outputs. For example, while an output by a RAG-based or fine-tuned domain-specific model can include satisfactory terminology, the terminology can be used in a logically inconsistent or inaccurate manner (e.g., conflating the functionality of random access memory (RAM) or flash memory within a hardware architecture application, even if the correct lexicon or terminology is represented within the output). As such, conventional generative AI models can fail to capture complex interdependencies, logical inferences, or other domain-specific relationships between concepts, objects, or terms within a particular domain.

The systems and methods disclosed herein enable generation of domain-specific outputs (e.g., natural language-based textual data or code snippets) based on ontological and lexical data structures characterizing the domain. For example, the data generation platform can receive an input prompt that is associated with a particular domain (e.g., a hardware architecture), along with domain-specific lexical datasets and ontology maps that define the precise, terminology, relationships, and constraints (e.g., regulatory or logical requirements) within the domain. The data generation platform can provide the domain-specific lexical datasets, the ontology maps, and the input prompt to an artificial intelligence model to generate a first output in response to the user's input prompt. By providing the domain-specific information to the language model, the data generation platform enables improved generation of domain-specific outputs that remain faithful to the constraints and terminology provided with the user's input prompt, thereby improving the semantic and logical accuracy of the output.

Moreover, the data generation platform can leverage a multi-agent approach to validate (1) the compliance of the generated output with ontological, logical and/or semantic domain-specific rules, constraints, or patterns and (2) the extent to which the output is domain-specific as opposed to generalized, thereby ensuring the domain-specificity of the generated output. To illustrate, the data generation platform can validate whether the generated output complies with the rules, constraints, or patterns defined within the provided ontology map. In some implementations, the data generation platform determines whether the data generation platform complies with inferred rules, constraints, or patterns (e.g., that are derived from the provided domain-specific ontology map and/or lexical dataset). By doing so, the data generation platform can validate that the generated output is consistent with stated and/or implied requirements, constraints, or patterns associated with the domain.

In some implementations, the disclosed data generation platform iteratively improves compliance with the domain-specific ontology map and/or lexical dataset upon determining that a particular generated output is not consistent with the ontology map or lexical dataset. As an illustrative example, the data generation platform (e.g., via an ontology validation module) determines that the generated output does not follow logical requirements of the domain (e.g., includes a statement that RAM and flash memory are both types of hard drives). As such, the data generation platform can generate a modified prompt (e.g., that clarifies the ontological relationships between different types of memory) prior to generation of an updated output. In some implementations, the data generation platform iteratively updates the output until a determination that the resulting output is indeed consistent with the domain-specific ontology map and/or the lexical dataset, thereby ensuring accurate generation of domain-specific outputs.

In some aspects, the data generation platform can provide the generated output to domain evaluation model to determine whether the output is sufficiently domain-specific (e.g., sufficiently non-general) for transmission to the user. For example, the data generation platform provides the input prompt (e.g., unmodified) to a base AI model to generate an output that is unconstrained by the domain-specific ontology map and unaffected by the domain-specific lexical dataset. Subsequently, the data generation platform can compare the unconstrained output with the output influenced by the domain-specific ontology or lexical information, thereby providing an indication of the domain-specificity of the generated output. The data generation platform can re-generate the output (e.g., with a suitable modification to the input prompt) to further tailor the output to be more domain-specific (e.g., upon determining that the generated output is too similar to the unconstrained output). Additionally or alternatively, the data generation platform determines that the generated output is sufficiently domain-specific and, accordingly, transmits the output to the user in response to the input prompt.

As such, the disclosed technology enables efficient, accurate generation of domain-specific information in response to user-defined inputs (e.g., text-based prompts, images, videos, audio, or other suitable data). For example, the disclosed technology enables generation of domain-specific data without resource-intensive model training or retraining, thereby enabling rapid deployment and adaptation to changing domain standards, constraints, or rules. Moreover, by integrating a multi-agent validation approach, the technology can ensure that generated data exposed to the user is indeed compliant with requirements and, simultaneously, domain-specific enough to satisfy the user. Moreover, because changes in domain-related constraints can be reflected within the ontology and/or lexical dataset associated with the domain, complex changes in conceptual relationships or interdependencies associated with a domain can be easily incorporated to generate accurate, non-obsolete subsequent outputs.

Moreover, because domain-specific information is stored in relatively compact lexical and ontological data structures, the disclosed data generation platform is scalable and flexible, thereby enabling expansions or redefinitions in the supported domains without resource-intensive model proliferation or re-training operations.

Additionally, by leveraging ontological structures to represent constraint, relationship, hierarchical, or rule-based information, the data generation platform enables complex logical inference operations using computational, analytical rule propagation and validation techniques to ensure compliance with rules. To illustrate, the data generation platform can receive an indication of a hierarchy or relationship within the ontological structure (e.g., that an L1 cache has a lower latency than an L2 cache, and that L2 cache has a lower latency than main memory, and processors prioritize lower-latency memory access). Accordingly, the data generation platform can process the indication of the hierarchy with a reasoner module (e.g., by converting the indication of the hierarchy or relationship to a computer-readable format, such as a Web Ontology Language (e.g., OWL) or a Resource Description Framework (RDF) and providing the computer-readable data structure to a reasoner application to generate inferred relationships based on the provided relationships. For example, the data generation platform infers that, because processors prioritize lower-latency memory access, and that because the L1 cache has a lower latency than the L2 cache, which has a lower latency than the main memory, that the processor should prioritize use of the L1 cache. As such, by generating and verifying domain-specific outputs that are subject to inferred ontological relationships, the data generation platform enables improved accuracy and compliance of generated outputs.

In some aspects, the data generation platform can perform one or more operations in a parallel architecture (e.g., using graphics processing unit (GPU) acceleration or CPU parallelization protocols). For example, the data generation platform generates the constrained and unconstrained outputs in parallel and/or performs one or more validation operations in parallel. By performing validation and/or generation steps in parallel, the data generation platform can improve the efficiency (e.g., mitigate latency issues) with respect to accurate, domain-specific output generation by leveraging underlying software or hardware architectures.

Synthetic data can be deployed to validate mathematical models and to train machine learning models such as large language models (LLMs) or other generative AI (GenAI, GAI) models. Synthetic data is used in a variety of fields as a filter for information that would otherwise compromise the confidentiality of particular aspects of the data. In many sensitive applications, datasets theoretically exist but cannot be released to the general public. Further, synthetic data addresses the challenge of data scarcity, which is common when implementing modern approaches to training LLMs or other generative AI models. Data scarcity occurs when there is an insufficient amount of real-world data available for analysis, training AI models, and other operations.

However, continuously using inaccurate synthetic data to, for example, train artificial intelligence (AI) models, increases the risk of model degradation. Inaccurate synthetic data includes data that, for example, has been generated/developed with incorrect assumptions, lacks variability, or contains errors and biases that are absent from original data (e.g., actual data, copies of the actual data, anonymized data, depersonalized data, and so forth). If an AI model continuously intakes inaccurate synthetic data, the AI model's performance and accuracy can degrade due to the over-reliance on artificial data that may not capture the nuances of real-world data. Over-reliance can lead to biased or inaccurate predictions and decisions. Another challenge is obtaining cross-border approval for the use of actual data. Different countries have varying regulations and standards for data privacy and protection, and synthetic data must comply with different regulations to be used legally. Navigating the regulatory landscapes can be complex and time-consuming, potentially delaying the deployment of AI models.

Attempting to create synthetic data that accurately reflects real-world conditions while ensuring compliance with privacy regulations presents significant technical challenges. Creating such data requires addressing several limitations in conventional approaches to data generation, such as the difficulty in maintaining the statistical properties of the original data while ensuring anonymization. Unlike traditional data anonymization methods that may simply remove or mask personal identifiers, synthetic data generation creates entirely new data points that mimic the original data's characteristics and cannot be reengineered to trace back to, for example, customers or other personally identifiable information (PII) or personal information (PI). Conventional methods often struggle to balance the need for data utility with the requirement for privacy, leading to either overly generalized data that lacks detail or insufficiently anonymized data that poses privacy risks.

To address these technical challenges, multiple design approaches were evaluated. For example, evaluations and analysis included generating synthetic data to reflect the statistical properties and patterns of the original data. However, a significant challenge remained: there was no measure of how good the synthetic data was, nor was there a method to track the differences between the original and synthetic data. Without a reliable measure of the quality of synthetic data, it was challenging to ensure that the generated data captured the nuances of the original data.

As such, the inventors have developed a system for generating calibrated synthetic data using an AI model (e.g., generative model, large language model, machine-learning model) (hereinafter the “synthetic data generation platform”). The synthetic data generation platform can use a dataset, which includes actual data comprising a set of attributes and/or a set of observed values for these attributes, to identify a subset of the attributes to be anonymized and/or depersonalized within the dataset (e.g., user identifiers such as name, address, etc., passwords, and so forth). Once the subset of attributes to be anonymized and/or depersonalized is identified, the synthetic data generation platform can generate a set of synthetic values for the attributes. Synthetic values can be generated directly from the actual data, with built-in provisions to anonymize and/or depersonalize the data during the creation process. The synthetic data generation platform can ensure that the synthetic data maintains the statistical properties and patterns of the original dataset while maintaining individual privacy.

In some implementations, synthetic data generation platform can first anonymize and/or depersonalize the actual data by, for example, removing any personal information. Once the data is anonymized and/or depersonalized, synthetic values are created from the depersonalized dataset. The two-step approach ensures that the synthetic data is derived from a dataset that has already been stripped of sensitive information, thereby lowering the risk of re-identification via reengineering. Additionally or alternatively, the synthetic data generation platform can create a reusable mask for depersonalizing the observed values. The mask can be saved and subsequently applied to other data (e.g., data that is similar to the original data, the original data itself, different data, and so forth). By creating and saving a depersonalization mask, the synthetic data generation platform can consistently anonymize/depersonalize across multiple datasets.

One of the advantages of the synthetic data generated off of depersonalized/anonymized data is that the synthetic data cannot be reverse-engineered. Unlike depersonalized or anonymized data, which can potentially be re-identified when combined with other databases or sources, by first depersonalizing or anonymizing the actual data and then creating synthetic data from it, the synthetic data generation platform ensures that the synthetic data cannot be traced back to the PII of the original customers. Thus, the synthetic data generation platform alleviates significant privacy regulatory concerns, as it prevents the possibility of re-engineering the synthetic data to uncover sensitive information of the clients.

However, for situations where the underlying real-world data includes complex relationships or interdependencies, even synthetic data informed by statistical patterns can fail, particularly in situations where entities within the data and relationships thereof are dynamic. For example, where entities are added or removed, the underlying data does not include indications of how such entities behave or influence other parts of the system. Conventional approaches to synthetic data generation can generate synthetic data that appears statistically valid at the individual entity level but can fail at capturing the intricate web of interdependencies between entities in more complex systems. This limitation can become particularly pronounced in dynamic environments where the relationship structure evolves over time, as the synthetic data generation process may not account for emergent relationships or changing entity hierarchies that were not present in the original training data.

Moreover, conventionally generated synthetic data can lose temporal coherence as such systems may not consider time-resolved or time-series information. Traditional synthetic data generation approaches often treat data points as independent observations without accounting for temporal dependencies and sequential relationships. As such, conventional synthetic data generation systems can fail to preserve the natural progression of events, seasonal patterns, or causal sequences present in real-world data, even when they account for static statistical distributions satisfactorily. The loss of temporal coherence can significantly impact the utility of synthetic data for applications that rely on understanding time-based behaviors, trends, or predictive patterns.

Furthermore, conventional systems for the generation of synthetic data are often not scalable, as complex relationships across increasingly large systems can be difficult to capture and/or track. Such conventional systems require training data (e.g., the underlying real-world data) to capture all relationships, such that accuracy can be limited by model complexity. As the number of entities and their latent or explicit interconnections grow, traditional approaches can struggle to maintain computational efficiency while preserving the full spectrum of relationships. The scalability challenge can be compounded by the exponential growth in relationship complexity as system size increases, leading to oversimplified synthetic data that lacks important relationships or to computationally prohibitive generation processes that cannot handle large-scale datasets.

Even conventional systems that account for interdependencies or relationships between entities (e.g., different data sources, datasets, or associated values) often handle the relationships as distinct from statistical relationships and patterns within the data. For example, synthetic data generated based on explicitly defined relationships between components of the real-world data can fail to capture latent structural relationships between entities. As such, the separation between structural and statistical modeling in conventional approaches can result in synthetic data that preserves the structural integrity or the statistical properties of the real-world data asymmetrically and inconsistently (e.g., by missing or relaxing strong, latent relationships between entities), thereby leading to synthetic datasets that appear structurally sound but exhibit statistical anomalies or, conversely, maintain statistical fidelity while violating suitable structural constraints.

Furthermore, conventional systems that model structural relationships between values, entities, or nodes within the data to be simulated often do not represent such relationships in a sufficiently flexible manner (e.g., for more complex relationship types). For example, conventional approaches can be limited to binary connections or predefined relationship categories, failing to capture nuanced, multi-dimensional, and context-dependent relationships that exist in real-world data. The inflexibility of such systems can result in synthetic data that oversimplifies complex relationship dynamics, leading to missing more complex patterns, including non-linear or conditional dependencies, hierarchical relationships, or relationships that vary based on temporal or contextual factors.

To address these further technical challenges, the inventors have also developed systems and methods for generating synthetic data based on ontological structures, such as knowledge networks, to account for complex relationships or interdependencies within the underlying data. For example, the disclosed data generation platform leverages bidirectional integration of structural and statistical modelling to detect and enhance knowledge of relationships between entities, data structures, values, or other suitable data associated with the system. As such, the disclosed technology enables generation of more accurate synthetic data for validation and testing of computational models, such as artificial intelligence models, in situations where testing or training data is not available (e.g., due to security or privacy constraints) and where relationships between various components of the underlying data are complex and/or non-linear.

In some aspects, the data generation platform can receive a node dataset that includes information relating to the structure of the underlying data to be simulated (e.g., a set of personal identifying information (PII)). The node dataset can include one or more datasets, data objects, structures, or other suitable data (e.g., entities or nodes), as well as one or more relationships characterizing relationships between such entities, represented in the form of a knowledge network. As an illustrative example, a large distributed software system can include a network of microservices (e.g., in a containerized architecture, such as in a Kubernetes system), each representing a node in a distributed architecture. Each microservice (e.g., a type of node) can be associated with a service type, version, deployment region, and/or associated resource usage statistics. The relationships (e.g., edges) between microservices can represent API calls, data flows, dependency links and can be associated with relationship attributes, including call frequency, latency, and/or authentication requirements. By receiving the node dataset information, the data generation platform enables simulation of complex data structures and relationships thereof, thereby improving the flexibility of the data generation platform in its ability to handle different types of data, objects, and complex interdependencies.

Subsequently, the data generation platform can analyze the node dataset (e.g., the received knowledge network) to extract statistical information (e.g., statistical metrics) associated with the relationships, values, and/or other attributes of the node dataset. For example, the data generation platform can provide the node dataset representing relationships between microservices of the distributed system to a statistical inference model to generate inferred statistics (e.g., predicted values characterizing statistical metrics, such as average call latency, the distribution of service dependencies, API call volumes associated with particular microservices, and/or other suitable information). In some implementations, the inferred statistical dataset includes values that characterize relationships or interdependencies between multiple values, objects, or entities of the node dataset (e.g., within a particular node of the node dataset and/or between different nodes of the node dataset). To illustrate, the inferred statistical dataset includes a correlation coefficient that characterizes a similarity between API call latency values between two adjacent (and/or non-adjacent) microservices within the distributed system. Additionally or alternatively, the inferred statistical dataset includes an average value, variance value, and/or other suitable metrics associated with one or more attributes of particular microservices and/or relationships thereof.

In some implementations, the data generation platform can model temporal patterns associated with a time series of the node dataset, knowledge network, or components thereof. For example, the data generation platform leverages multiscale attention, hierarchical encodings, neural Hawkes processes, and/or temporal point processes to model sequences, enabling generation of temporal dependency graphs. By doing so, the data generation platform enables both static and dynamic retention of complex interrelationships and patterns, thereby improving the resilience of the data generation platform in generating synthetic data in complex and dynamic situations and environments.

The data generation platform disclosed herein can leverage the inferred statistical dataset to update, improve, and/or infer a knowledge network that represents attributes or relationships within the associated system. For example, in the context of a distributed software system, the data generation platform can identify previously unknown dependencies between microservices, detect latent communication patterns between system components, or discover implicit hierarchical relationships within data structures based on statistical correlations and usage patterns. The bidirectional enhancement between statistical analysis and knowledge network construction enables the generation of synthetic data that preserves both explicit structural relationships and implicit statistical dependencies that may not be apparent from examining either the graph structure or the associated statistical properties in isolation.

Based on the inferred entity-relationship network, the data generation platform can generate a set of constraints to impose on subsequent generation of synthetic data. For example, the data generation platform can determine, categorize, or evaluate relationships and values associated with the inferred entity-relationship network and generate a data structure that characterizes constraints to be imposed on the generation of data. In the context of a distributed software system, the data generation platform can determine that data associated with particular microservices is to be correlated within a particular threshold or tolerance based on the nature of the inferred entity-relationship network (and/or associated inferred statistical data). By generating and subsequently imposing the set of constraints, the data generation platform can ensure that synthetic data maintains structural integrity and statistical fidelity with respect to the real-world system, while preventing the generation of unrealistic or invalid data combinations that would violate the underlying system architecture and/or operational dependencies.

As such, the data generation platform can generate the simulated node dataset such that it is consistent with the set of constraints and the inferred entity-relationship network (e.g., using one or more data generation models, as in a generative model suite). As an illustrative example, the data generation platform generates synthetic data (e.g., simulated usage data associated with API calls between different microservices of the distributed system), where the associated attributes and relationships follow the determined constraints. For example, the synthetic data generated by the data generation platform is such that API calls originating from one microservice are correlated with API calls received at another microservice within a particular tolerance, as determined based on the inferred statistical dataset. By doing so, the data generation platform enables realistic testing and validation of distributed systems without exposing sensitive production data, while maintaining complex interdependencies and behavioral patterns that are valuable for accurate performance modeling and system optimization.

In some aspects, the data generation platform can transmit the synthetic data to a suitable device for training or testing (e.g., of an artificial intelligence model). For example, the data generation platform provides the simulated node dataset to development environments for load testing of distributed systems. The data generation platform can convert or transmit the synthetic data in formats compatible with the target systems, such as structured datasets for database testing, API call logs for performance analysis, or streaming data for real-time system validation, thereby enabling comprehensive testing and model training without compromising the security or privacy of actual production data.

As such, the disclosed data generation platform addresses limitations of conventional systems that fail to capture complex relationships and interdependencies by implementing a bidirectional integration approach between statistical and structural modeling. Unlike traditional methods that treat structural relationships and statistical properties as separate concerns, the disclosed platform can leverage knowledge networks to represent entity relationships, while simultaneously using statistical inference models to discover latent patterns and dependencies. The integrated approach described herein enables the system to identify previously unknown relationships between entities (e.g., microservices in a distributed system) and to generate synthetic data that preserves both explicit structural connections and implicit statistical correlations that emerge from underlying data patterns.

The data generation platform can mitigate temporal coherence limitations associated with conventional approaches as the platform can employ specialized generative models that enable decomposition of data generation based on the knowledge network structure, enabling different specialized models (e.g., as part of a model suite) to process particular portions of data while maintaining overall consistency with the knowledge network. The approach enables the platform to scale efficiently as system complexity grows by leveraging hierarchical and modular data generation. As an illustrative example, the data generation platform can use a flexible, rich, modular constraint and/or relationship embedding mechanism, enabling representation of multi-dimensional relationships within the inferred entity-relationship network. As such, the data generation platform can handle complex relationship types within the real-world data beyond binary connections by encoding relationship attributes, conditional dependencies, and contextual factors directly within the knowledge network structure. The constraint generation process can thus handle hierarchical relationships, multi-hop dependencies, and context-dependent connections, enabling the synthetic data to capture nuanced relationship dynamics that vary based on operational (and/or temporal) factors. The flexibility improves the richness and accuracy of the synthetic data, thereby enabling testing and validation of systems where manipulation or transmission of sensitive data is limited.

Moreover, to assess the accuracy and fidelity of the synthetic data, the synthetic data generation platform can generate a tracking relationship value (e.g., a tracking difference, a tracking error, a tracking differentiator, tracking overlap percentage, or the like) between the original data (e.g., actual data, anonymized data, depersonalized data, and so forth) and the synthetic data. The tracking relationship value is a quantifiable metric comparing the synthetic data against the actual data across various scopes (e.g., at a variable level, at a segment—or group of variables—level, at an overall dataset level, and so forth). For example, if a user requests Kansas City credit card data from the last 48 hours, the synthetic data generation platform can not only generate synthetic data but also output that the synthetic data is within, for example, 1% of the actual data overall. Furthermore, the synthetic data generation platform can provide specific tracking relationship values for individual characteristics, such as, for example, a 0.1% tracking error for the “age” characteristic and/or a 2% tracking error for the “income” characteristic. This level of detailed comparison ensures that the synthetic data closely mirrors the actual data, making the synthetic data commercially scalable and highly reliable for various applications.

The tracking relationship value can be calculated by comparing the observed values of the identified subset of attributes with the corresponding synthetic values. The comparison can be performed against one or more benchmarks (e.g., certain variables to compare), providing a quantifiable metric that indicates how closely the synthetic data mirrors the real-world data. The benchmarks can be determined using an associated scenario (e.g., application domain) of the dataset. For example, in a financial field, the variables gender, income, geographical location, and so forth can be included in the benchmarks. If the tracking relationship value exceeds a certain threshold (e.g., specified by the user, specified by a guideline, dynamically generated), the synthetic data generation platform can regenerate the synthetic values using, for example, different parameters or weights. The threshold can be a threshold value, a threshold condition, a range of threshold values, and so forth.

By comparing the synthetic values with the observed values against established benchmarks, the synthetic data generation platform can quantify how closely the synthetic data mirrors the real-world data. Additionally, regenerating synthetic values if the tracking relationship value exceeds a certain threshold mitigates the risk of over-reliance on synthetic data. Furthermore, the synthetic data generation platform can ensure compliance with varying guidelines by providing a quantifiable method for assessing and validating synthetic data, thus simplifying the process of obtaining cross-border approval and accelerating the deployment of models trained on synthetic data.

While the current description provides examples related to LLMs, one of skill in the art would understand that the disclosed techniques can apply to other forms of machine learning or algorithms, including unsupervised, semi-supervised, supervised, and/or reinforcement learning techniques. For example, the disclosed intent-based data generation platform can evaluate model outputs from support vector machine (SVM), k-nearest neighbor (KNN), decision-making, linear regression, random forest, naïve Bayes, or logistic regression algorithms, and/or other suitable computational models.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Overview of the Domain-Specific Data Generation Platform

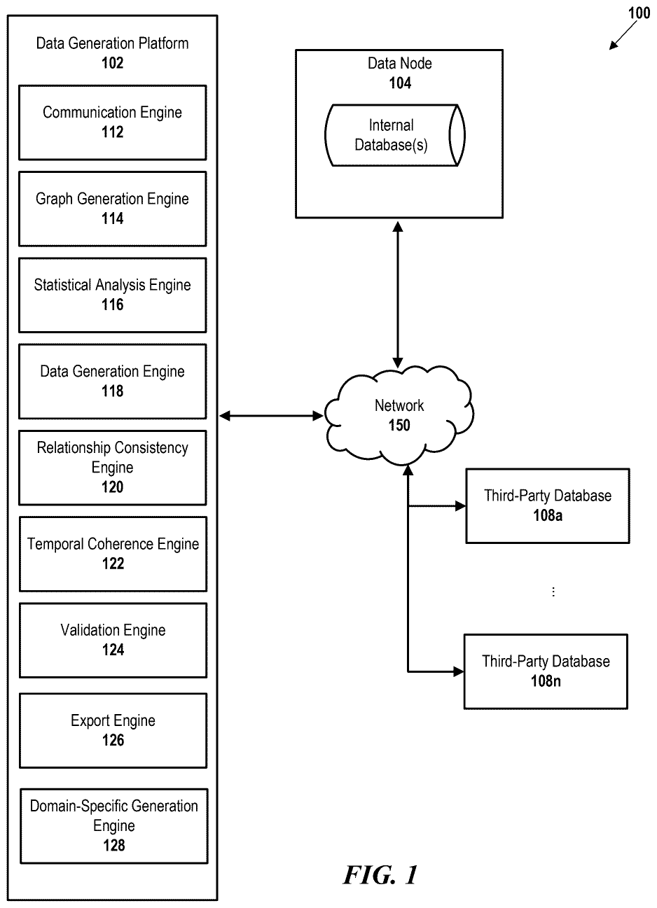

FIG. 1 illustrates an example environment 100 including a data generation platform 102 that enables generation of domain-specific data in response to user inputs based on ontological and lexical data structures defining terminologies, relationships, interdependencies, hierarchies, logical structures, and/or other suitable domain-specific information. For example, the data generation platform disclosed herein enables generation of complex financial services-specific report generation based on information relating to financial terminology, regulatory terms, and definitions of required regulatory disclosures, as well as an ontology data structure defining a document structure, mandatory, sections, and/or compliance rules associated with the financial services-related domain. Based on the information, the data generation platform can generate reports that include required regulatory information, follow prescribed formats, and precisely and accurately use financial terminology appropriately.

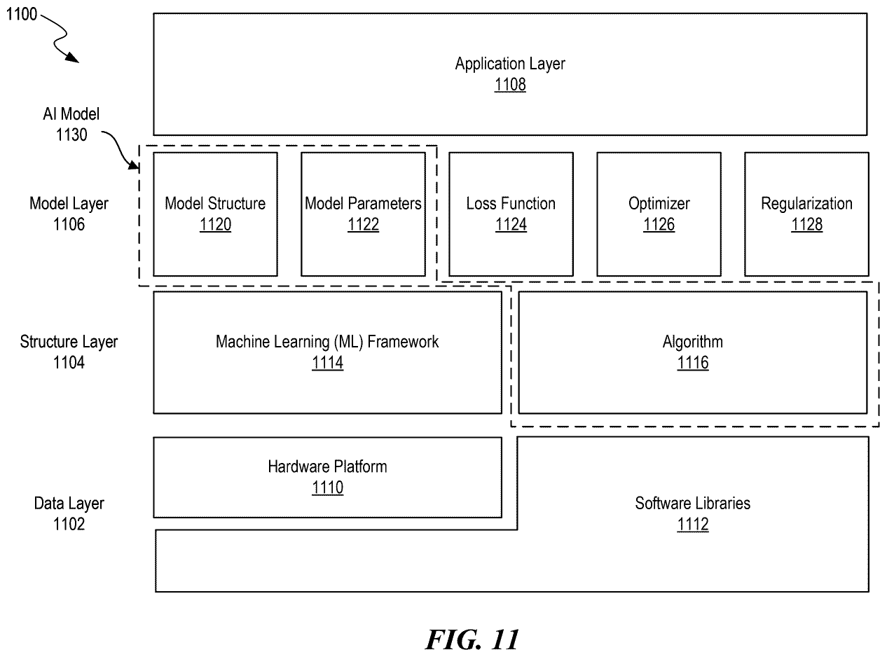

For example, the environment 100 includes the data generation platform 102, which is capable of communicating with (e.g., transmitting or receiving data to or from) a data node 104 and/or third-party databases 104a-104n via a network 150. The data generation platform 102 can include hardware, software, or a combination of both and can reside on a physical server or a virtual server running on a physical computing system. For example, the data generation platform 102 is configured on a user device (e.g., a laptop computer, smartphone, desktop computer, electronic tablet, or another suitable user device). Furthermore, the data generation platform 102 can reside on a server or node and/or can interface with third-party databases 108a-108n directly or indirectly. In some implementations, the data generation platform 102 includes, processes, or generates suitable hardware or software components as described in relation to FIGS. 11-13 below.

The data generation platform 102 can include one or more components, including a communication engine 112, a graph generation engine 114, a statistical analysis engine 116, a data generation engine 118, a relationship consistency engine 120, a temporal coherence engine 122, a validation engine 124, an export engine 126, and/or a domain-specific generation engine 128. In various embodiments, the one or more components can execute one or more operations associated with the disclosed technology.

The data node 104 can store various data, including one or more machine learning models (e.g., LLMs, models associated with the statistical modeling or generative artificial intelligence suites, node maps (e.g., real-world data associated with decentralized networks, ontology or knowledge networks, inferred entity-relationship networks), embeddings or data structures associated with regulatory constraints, terminology, statistical relationships, logical relationships, structural relationships, or semantic relationships, and/or other suitable data. For example, the data node 104 includes one or more internal databases (e.g., capable of storing machine learning model parameters, knowledge network data, real-world data, training data, or other suitable data). In some implementations, the data node 104 stores metadata associated with hierarchical information, data lineage, and/or provenance tracking that provides information relating to the structural and statistical properties preserved during the synthetic data generation process (e.g., the domain-specific ontology map, the inferred entity-relationship network, a set of constraints associated with regulatory or technical standards, or representation(s) thereof).

The data generation platform 102 can receive inputs (e.g., textual user inputs (e.g., prompts), node datasets, or other suitable data) from one or more devices, servers, or systems. For example, the data generation platform 102 can receive data or transmit data using the communication engine 112, which can include software components, hardware components, or a combination of both. In some implementations, the communication engine 112 includes or communicates with a data ingestion layer capable of performing pre-processing tasks, such as data format conversion or transformation. In some aspects, the communication engine 112 includes or interfaces with a network card (e.g., a wireless network card or a wired network card) that is associated with software to drive the card, thereby enabling communication with the network 150. In some implementations, the communication engine 112 also receives data from and/or communicates data with the data node 104, or another computing device associated with the network 150. The communication engine can interface with other components of the data generation platform 102, including the graph generation engine 114, the statistical analysis engine 116, the data generation engine 118, the relationship consistency engine 120, the temporal coherence engine 122, the validation engine 124, the export engine 126, and/or the domain-specific generation engine 128.

In order to accept user requests for domain-specific information or other suitable inputs, the data generation platform 102 can receive a first input that includes a prompt or other user input associated with a particular domain. For example, the data generation platform 102 obtains an input that includes an input prompt that is associated with a domain. In some implementations, the data generation platform receives or obtains a domain-specific lexical or key-value dataset, as well as a domain-specific ontology map.

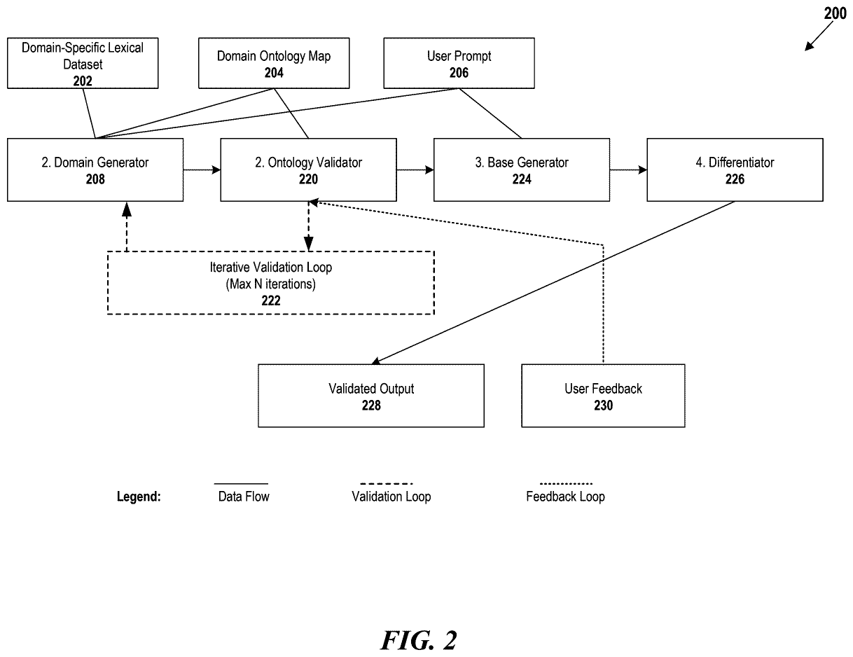

FIG. 2 illustrates an example system 200 for generating validated, domain-specific natural language outputs by using domain-specific ontology information and associated lexical data, in accordance with one or more implementations of the disclosed technology. For example, the example system 200 (e.g., the data generation platform 102) can include components including a domain generator 208, an ontology validator 220, a base generator 224, and/or a differentiator 226. The data generation platform 102 can receive (e.g., at the domain generator 208) an input that includes the input prompt (e.g., user prompt 206), as well as a domain-specific lexical dataset 202 and/or a domain ontology map 204.

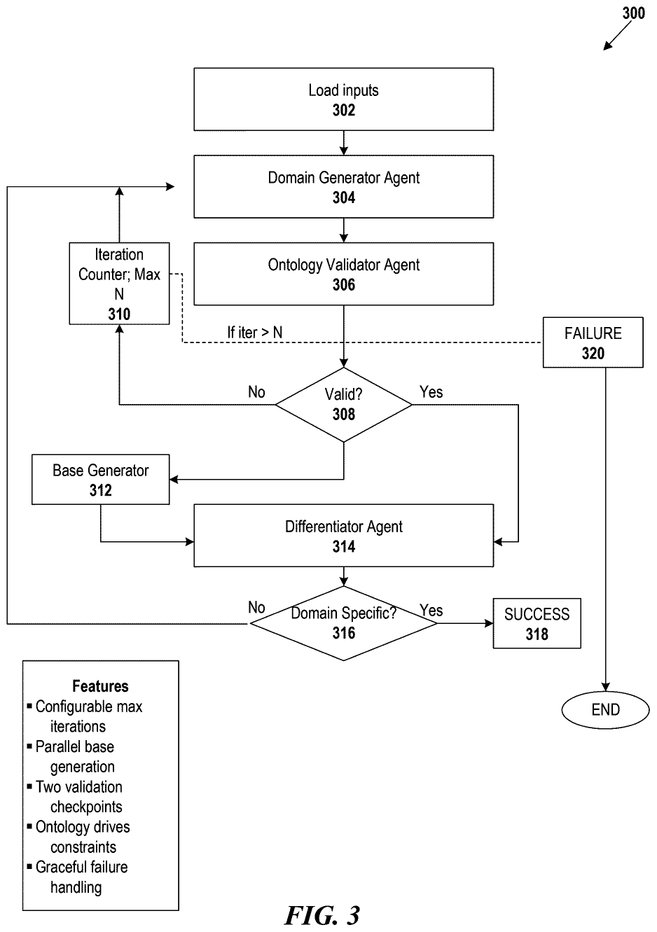

FIG. 3 illustrates a workflow 300 for multi-agent, iterative generation and multi-step validation of domain-specific information, in accordance with one or more implementations of the disclosed technology. To illustrate, at 302, the data generation platform 102 can receive inputs that enable generation of domain-specific outputs (e.g., that are consistent with patterns, requirements, or other characteristics of information specific to a particular domain). For example, the data generation platform receives an input including a user prompt 206, a domain-specific lexical dataset 202, and/or a domain ontology map 204 of FIG. 2.

An input prompt (e.g., input, or the user prompt 206) can include a natural language instruction, query, request, or dataset associated with initiation of generation of content by an artificial intelligence model. For example, the input prompt includes a request for generation of domain-specific content (e.g., in a particular format), as well as relevant information. An input prompt can originate from one or more user devices (e.g., within an associated data transformation pipeline or network) and can include a question or a statement in natural language (e.g., in a vector, string, or character array structure), such as, “Can you generate a report for the current fiscal year relating to transactions between Bank A and Bank B in Region A, based on the attached documents?”. In some implementations, the input includes one or more data structures in non-textual or non-natural language format (e.g., an image, video, or multimedia incorporating data of various formats, such as within filed attached to a textual input prompt). For example, the input includes documents, numerical data structures (e.g., comma-separated value (CSV) files, spreadsheet files, or other suitable data), image files, or combinations thereof. Additionally or alternatively, an input includes voice data (e.g., an audio file of voice instructions). The input can reference or include particular domain-related concepts, terminology, or constraints, such as within a user prompt or in the form of a domain-specific lexical dataset or ontology map, as described below.

The input can request domain-specific information (e.g., a report or an analysis that is consistent with domain-specific requirements, constraints, or patterns). As an illustrative example, a domain includes a specialized field of knowledge, expertise, or application area that encompasses specific terminology, constraints, rules, and/or conceptual relationships. A domain can include a particular subject matter area that is characterized by unique lexical patterns, semantic structures, logical hierarchies, regulatory requirements, policies, or constraints that distinguish it from other fields of knowledge. For example, a domain includes regulatory frameworks, compliance requirements, and/or technical standards that govern the generation and/or validation of content within the specialized area.

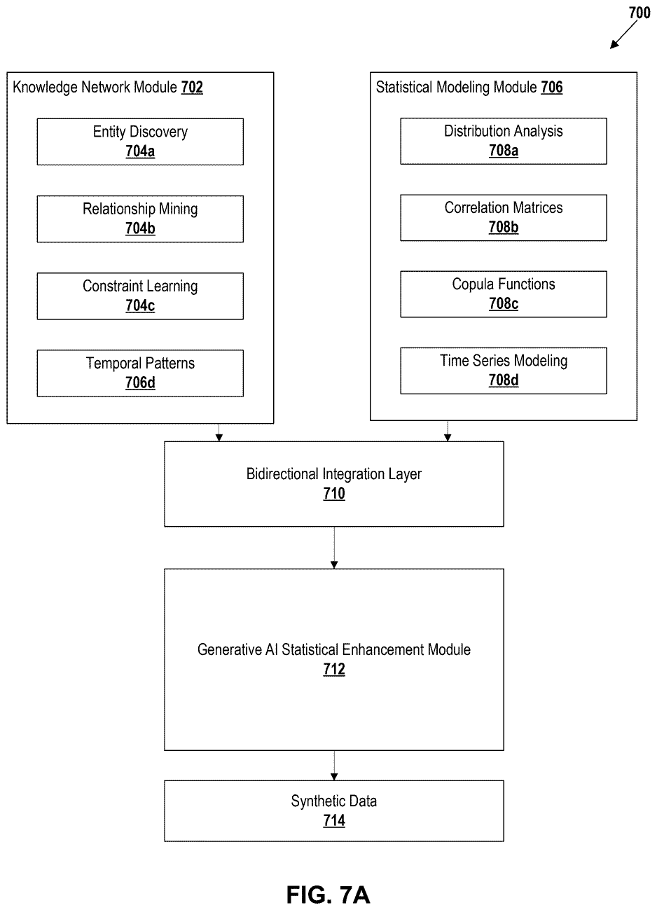

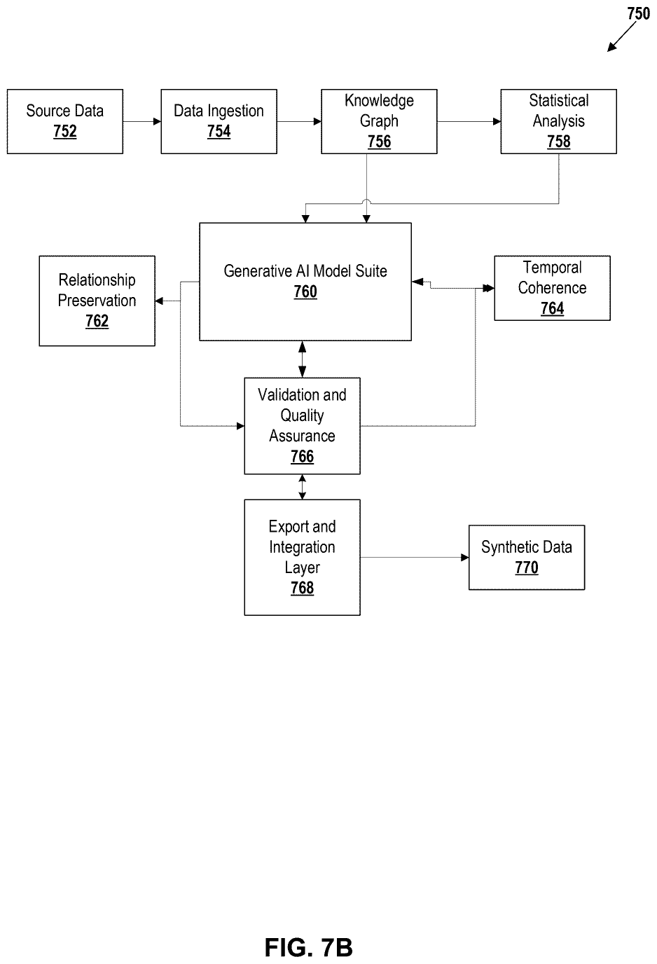

In some implementations, the input includes a data structure representing synthetic data (e.g., a simulated dataset), as described with respect to FIGS. 7-10B. For example, the simulated dataset represents information relating to a given system, set of nodes, or data transformation pipeline that retains structural, semantic, and/or statistical relationships, patterns, or attributes as compared to real-world data. To illustrate, the simulated dataset can include simulated financial transaction data, including relationships between financial institutions or other entities, simulated financial transactions, and/or other synthetic data or data flows. In some implementations, the simulated dataset does not retain structural, semantic, and/or statistical relationships associated with real-world data and is provided to the data generation platform to validate and/or refine the synthetic data accordingly.

In some implementations, a domain is represented as a subset or region within a knowledge vector space. For example, a domain is defined by a range or parametrized n-dimensional region within a semantic vector space that represents natural language using mathematical data structures or frameworks. The knowledge vector space can include high-dimensional embeddings where semantically related concepts are positioned closer together than relatively less related concepts. Domain boundaries can be established through clustering algorithms, distance metrics, or parameterized n-dimensional planar boundary definitions that identify coherent regions of related terminologies or concepts.

In some implementations, the domain is defined by one or more keywords or key tokens (e.g., in natural language). For example, a domain includes industry-based or technology-based descriptor data structures, such as text strings or tags including “high-tech devices,” “legal writing,” “financial services,” or other suitable descriptors. In some implementations, one domain can overlap with or reside within other domains (e.g., conceptually or mathematically within the knowledge vector space). For example, the domain of “mobile devices” is a sub-domain of “high-tech devices.”

A domain-specific lexical dataset (e.g., the domain-specific lexical dataset 202) can include a description of terminologies, acronyms, definitions, usage patterns, or other similar information (e.g., information characterizing lexical properties of a particular domain). The domain-specific lexical dataset can include a key-value dataset (e.g., in a gazetteer or markup-language format, such as a Yet Another Markup Language (YAML) file or a JavaScript Object Notation (JSON) file), a nested structure dataset (e.g., representing objects within objects or arrays of objects), and/or a combination thereof. As an illustrative example, the domain-specific lexical dataset includes key-value pairs, where each key represents a flag (e.g., a textual flag) that includes a particular term or concept, and where the corresponding value includes the corresponding natural language description or definition of the term or concept. Additionally or alternatively, the domain-specific lexical dataset includes complex information in any suitable structured or unstructured data format characterizing terminologies (e.g., and associated definitions), syntax, lexicon, abbreviations, or other suitable information associated with a particular domain.

As an illustrative example, the domain-specific lexical dataset (e.g., in a financial services-based domain) includes financial terminology (e.g., where a key is a financial term and the value is a natural language description of the financial term), regulatory terms (e.g., where the keys are the terms and the values are the associated requirements/constraints/regulations), and/or required disclosures (e.g., a list of required disclosures). As an illustrative example, in a legal documentation domain, the domain-specific lexical dataset includes jurisdiction-specific legal terms and standard clauses. In a healthcare-related domain, the domain-specific lexical dataset can include medical terminology, International Classification of Diseases (ICD) codes, and/or clinical abbreviations.

By receiving and/or characterizing domains with respect to terminology or lexicon, the data generation platform 102 enables accurate, precise definition or use of domain-specific information or concepts. For example, the domain-specific lexical dataset enables the platform to clarify potentially ambiguous or conflicting meanings of common terms that span multiple domains. To illustrate, the domain-specific lexical dataset can clarify that, in the context of United States patent law, the word “comprise” may have a particular “open-ended” meaning, while the word “consists of” may have a “closed meaning” within the domain, while in another context the words may have identical definitions. By obtaining (e.g., generating and/or receiving such information), the data generation platform 102 can improve the precision and accuracy of terms as generated in the output in response to the input or input prompt.

A domain-specific ontology map can include an ontology map (e.g., a knowledge map, node map, or a node dataset, including an inferred entity-relationship network as described with respect to FIGS. 7-10B below) that is specific to or descriptive of entities (e.g., concepts, objects, nodes, organizations, users, etc.) and relationships, constraints, or patterns thereof, associated with one or more particular domains or subdomains. For example, a domain-specific ontology map includes a node-set associated with a domain and a node-relationship set between one or more nodes of the node set (e.g., as described in relation to FIGS. 7-10B below). The node set (e.g., a node dataset) can include information relating to entities (e.g., within a distributed system) and relationships between the entities. For example, the node dataset includes an entity dataset (e.g., describing attributes associated with particular nodes or entities of a set of nodes), as well as a relationship dataset (e.g., including a representation of relationships between various nodes of the set of nodes). In some implementations, the ontology map (e.g., node map) is used to generate synthetic data (e.g., as described with respect to FIGS. 7-10A) to be validated. For example, the data generation platform provides the domain-specific ontology map and real-world data to a data generation model to generate synthetic data based on statistical, semantic, and/or structural patterns within the real-world data. In some implementations, the ontology map includes a mapping of relationships between financial entities and associated transactions, ontological relationships, and/or associated constraints, regulations, or guardrails.

The ontology map (e.g., a node map) can include a set of nodes, each associated with one or more objects. For example, each node includes one or more components, such as a unique identifier, a set of labels, attributes, properties, or references, and may serve as a representation of an individual entity, element, or concept within a network, system, or data structure. Each node can further encapsulate pointers or connections to other nodes (e.g., including labels that define relationships between nodes), thereby establishing relationships between nodes that represent interdependencies and structure within the network of nodes. To illustrate, a particular node can represent a particular user's account within an account management software application, with objects (e.g., associated with the particular node) representing attributes, such as usernames, user identifiers, email addresses, account statuses, profile components (e.g., a user photo), account values (e.g., bank account balances), and/or other suitable information. Additionally or alternatively, the node map represents one or more attributes associated with a particular object as standalone nodes (e.g., each with corresponding objects associated with the attributes), with attributes defined using relationship data structures (e.g., associated with one or more of node relationships 404a-404e).

An object (e.g., associated with a node) can include any data structure or computational entity encapsulating a set of data (e.g., attributes, labels, values, methods, and/or behaviors). For example, particular nodes can include objects such as a permission set, a user role, a policy, a requirement, a password policy, a data retention policy, a session longevity policy, a set of compliance requirements (e.g., including objects that represent particular jurisdictions, fields, user rights, requirements, etc.), or other suitable data structures. Nodes and associated objects can represent portions, components, features, inputs, or outputs of machine learning models or other artificial intelligence models (e.g., agentic models). For example, a node can include a specialized machine learning model in a system of machine learning models, where the node is configured to accept particular inputs or generate particular outputs (e.g., as defined by associated node relationships). In some implementations, a particular node represents an instance of a class (e.g., in the context of object-oriented programming), with associated fields (e.g., attributes) and behaviors (e.g., methods) encapsulated within the node, and hierarchies associated with edges (e.g., one or more node relationships 404a-404e) within the node map. For example, policies, requirements, and constraints imposed within the software development pipeline or in the associated target deployment locations can be represented as specialized classes within the node map. Relationships between policies, requirements, and constraints and other nodes (e.g., entity nodes, such as user account/user role/session-related nodes) can dictate how and when such rules apply within the node graph.

A node relationship can include any data structure or logical construct defining, representing, or characterizing an association, dependency, hierarchy, or interaction between two or more nodes of the node map. For example, a node relationship specifies the nature, directionality, cardinality, and conditions under which nodes are linked (e.g., parent-child, peer-to-peer, inheritance, composition, aggregation, association, or operational dependencies). For example, a node relationship includes an indication of a relationship between machine learning models of a network of machine learning models, such as an indication of an output of a first machine learning model (e.g., corresponding to a first node) being provided to a second machine learning model (e.g., corresponding to a second node) as an input. Additionally or alternatively, a node relationship represents a particular model component (e.g., a model weight) of a machine learning model (e.g., corresponding to a relationship between particular neurons of a neural network).

As an illustrative example, in the context of a user account management software pipeline, node relationships represent links such as ownership (e.g., indicated by a “owns” relationship label) between a user account node and a data resource node, user roles associated with user accounts (e.g., indicated by a “has role” relationship label), an authorization connecting a user account node to a permission policy node (e.g., an “is authorized by” label), or a compliance indicator associated with a particular user account node with respect to a compliance regulation node (e.g., an “is subject to” relationship label). The relationships can articulate how entities within the system interact, inherit properties, and are governed by policies or requirements.

In the context of object-oriented programming, node relationships can formalize common class or object associations, including inheritance (e.g., a node representing an Administrative User can have an “inherits from” relationship pointed at a node representing a “User” object), composition (e.g., a “Session” object associated with a particular node can have a “composes” relationship pointed at a node representing credential and/or device objects), dependencies, and/or implementation of interfaces. As such, the relationships represented within the node graph can provide a systematic encoding of software architecture patterns within the node map, supporting modularity, clarity, and dynamic updates to the graph reconfiguration platform's operational logic. A node map can be represented using various underlying data structures. For example, node maps are implemented using graph-oriented data structures, such as adjacency lists or adjacency matrices, effectively capturing complex relationships and connectivity between nodes. Additionally or alternatively, node maps are serialized into formats such as JSON, XML, or YAML, facilitating interoperability, machine readability, and ease of transmission in distributed systems and APIs. A node map can be represented using a graphical representation (e.g., a picture of a sketch by a software engineer or an associated digitized version) to facilitate human review or display on a user interface.

Within the node map (e.g., the ontology map), each node can be uniquely identified by a node identifier and/or index (e.g., a string, label, numeric value, and/or other unique reference). Node relationships can be represented as explicit relationship data structures, including references to relevant connecting nodes and labels associated with the particular relationship. For example, node relationships can include references to node identifiers (e.g., parent node identifiers and/or child node identifiers) associated with a parent-child relationship between the respective nodes. In some implementations, node relationships themselves include node relationship identifiers, facilitating identification, modification, and evaluation of node relationships. By structuring node relationships in this manner, the node map can serve as a flexible and extensible representation of real-world and abstracted software interactions, enabling robust modeling, automated evaluation, and adaptive modification within sophisticated code development pipelines.

The domain-specific ontology map can be in a computational logic ontology language format (e.g., specifying a rule set). For example, an ontology language rule set includes machine-readable and processable logical expressions (e.g., written in formal languages, such as OWL (Web Ontology Language) or SWRL (Semantic Web Rule language) that enable automated reasoning and inference based on complex or large-scale logical relationships or entity structures. For example, the rule sets can define conditional statements, logical implications, and/or inference patterns that enable reasoner applications to automatically derive new knowledge from existing domain facts. For example, rules can specify that if certain conditions are met within a domain context, specific conclusions or actions should follow. The computational nature of the rules enables systematic validation of generated content against formal logical constraints, ensuring that outputs maintain consistency with established domain principles and relationships through automated deductive reasoning processes, even if the inferred rules are latent (e.g., not explicitly obtained or provided to the data generation platform).

For example, the domain-specific ontology map includes an indication of structural rules, semantic rules, interdomain relationship rules, and/or compliance rules associated with the domain. Structural rules can include definitions of required document sections (e.g., in a desired output report), mandatory fields, and/or prescribed formatting requirements within domain-specific outputs. Additionally or alternatively, structural rules include information relating to hierarchies or structures associated with different concepts or entities associated with the domain. For example, structural rules can include an indication of an order of prescribed regulatory information to be included within a particular type of document or output. Additionally or alternatively, structural rules include an indication of relationships between different banks, financial institutions, bank accounts, regions, and/or institutions associated with financial services (e.g., as inferred within an inferred entity-relationship graph, as described below).

Semantic rules can include information relating to proper terminology usage, concept definitions, and/or contextual meaning constraints that ensure accurate domain-specific language generation. For example, semantic rules can include definitions and relationships between different concepts or terms within the domain, such as definitions of “qualified institutional buyers” as well as a link or reference to associated qualification criteria (e.g., credit score criteria) and/or which models or entities are capable of determining associated qualification criteria.

Compliance rules can include compliance criteria, regulatory requirements, industry standards, and/or legal constraints associated with a particular domain. For example, in a financial services-related domain, the ontology map includes structural rules that require specific sections within investment reports and associated information to be disclosed. For example, compliance rules, as represented within the domain-specific ontology map, can include rules to ensure compliance with the Securities Exchange Commission disclosure requirements, Sarbanes-Oxley documentation standards, and/or Basel III capital adequacy reporting formats.

Inter-domain relationship rules (e.g., domain rules) can include indications of relationships between different domains. For example, the domain-specific ontology map includes a listing and/or tree-based hierarchical structure of related domains. For example, the domain-specific ontology map includes an indication of relationships between a domain corresponding to United States Law and the domain corresponding to financial services (e.g., including portions of the United States Code or Federal Rules that regulate banking or financial services). Additionally or alternatively, the domain-specific ontology map includes information relating to sub-domains associated with the domain (e.g., a “Retail Banking” domain, a “Corporate Client Banking” domain, etc. within a financial services-related domain).

In some implementations, the compliance rules can include information relating to compliance requirements, regulatory requirements, formatting requirements (e.g., for reports), and/or other suitable information. For example, compliance requirements or rules specify mandatory disclosure statements, required data elements, prescribed document structures, and standardized terminology that must be included in generated outputs to satisfy regulatory frameworks. Rules can include timing requirements for regulatory filings, mandatory risk warnings, and/or disclaimers associated with particular types of content. In some implementations, the compliance rules include specifications of clinical workflows, documentation requirements, and/or relationships between clinical data types (e.g., in a healthcare context). In a legal context, the compliance rules within the domain-specific ontology map can capture legal relationships (e.g., business association structures), clause dependencies, jurisdictional variations (e.g., court-dependent local rules).

In some implementations, the domain-specific ontology map includes logical or ontological constraints associated with a particular domain, including object properties. For example, the domain-specific ontology map captures logical relationships between entities through object properties that define how concepts interact within the domain. In some aspects, object properties specify transitive relationships, functional dependencies, cardinality restrictions, or other suitable data that govern entity interactions or relationships. For example, in a financial services-related domain, the domain-specific ontology map captures object properties such as “has Account” relationships between customers and bank accounts (e.g., indicating that a particular customer has an account within a particular bank). The object properties can enable the data generation platform to understand that if a customer has multiple accounts at different institutions (e.g., within a particular region), particular regulatory reporting requirements can apply to the different institutions within the region.

In some implementations, the domain-specific ontology map can include validation criteria associated with the domain. The validation criteria can include indications of conditions, thresholds, and/or requirements for determining whether generated outputs conform to domain-specific standards or expectations. For example, validation criteria includes data quality metric definitions and/or any relevant threshold values, consistency checking protocols (e.g., described in natural language or in a code snippet/pseudocode/algorithm format), accuracy thresholds, and/or conformance rules that ensure generated content meets the technical and regulatory requirements of the particular domain (as otherwise specified within the domain-specific ontology map). For example, validation criteria includes qualitative requirements (e.g., numerical thresholds, statistical bounds, and/or percentage requirements), and/or qualitative assessments (e.g., semantic coherence, logical consistency, and/or stylistic appropriateness). As an illustrative example, in a financial services domain, validation criteria specifies that generated investment reports must include mandatory risk disclosures, maintain consistency between numerical data and textual summaries, comply with particular formatting standards for regulatory filings, and ensure that all financial calculations fall within acceptable variance ranges from established benchmarks or historical data patterns.

In some implementations, the domain-specific ontology map can include hierarchy information, class hierarchies (e.g., conceptual hierarchical attributes), and/or cardinality data associated with the domain. For example, hierarchy information includes taxonomic definitions of structures or parent-child relationships between domain concepts, thereby enabling the data generation platform to process conceptual inheritance and specialization patterns. To illustrate, the hierarchy information includes class hierarchies that organize entities, concepts, or terms into categorical structures with shared attributes and behaviors, while cardinality data can specify numerical constraints on relationships between entities. To illustrate, in a financial services domain, hierarchy information establishes that “Investment Products” include subcategories such as “Equities,” “Fixed Income,” and “Derivatives,” with cardinality constraints specifying that a portfolio manager can oversea multiple portfolios, but each portfolio can have only one primary manager.

In some implementations, the domain-specific ontology map can include information relating to reasoning rules associated with the domain (e.g., a complex logical expression dataset or rule set written in a computational logical ontology language, or ontological constraints). For example, reasoning rules can define logical inference patterns, conditional statements, and/or deductive reasoning pathways that enable automated derivation of new knowledge from existing domain concepts, relationships, facts, or relationships. For example, the rules are expressed in formal logic languages, such as SWRL (Semantic Web Rule Language) or OWL (Web Ontology Language) to enable machine-readable processing and automated reasoning. To illustrate, in a financial services domain, reasoning rules can specify that if a client's net worth exceeds a particular threshold value and the investment experience is classified as “sophisticated,” the client can qualify as an “accredited investor” for particular investment opportunities, thereby enabling the data generation platform to infer eligibility using a computer-driven process (e.g., using a computational reasoner model) without manual classification, thereby enabling complex reasoning tasks based on hundreds or thousands of inferences or entity relationships that are intractable to process manually or mentally.

In some implementations, the domain-specific ontology map includes a cardinality constraint dataset, a range constraint dataset, or a complex logical expression dataset, or a computational logic ontology language rule set and generate inferred rules thereof. For example, a cardinality constraint dataset can include specifications defining minimum or maximum occurrence limits for relationships between domain entities. A range constraint dataset can include definitions specifying valid target entities or values that can be associated with particular entities or metrics, or participate in particular domain relationships. A complex logical expression dataset can include formal logical statements that define conditional rules and/or inference patterns within the domain.

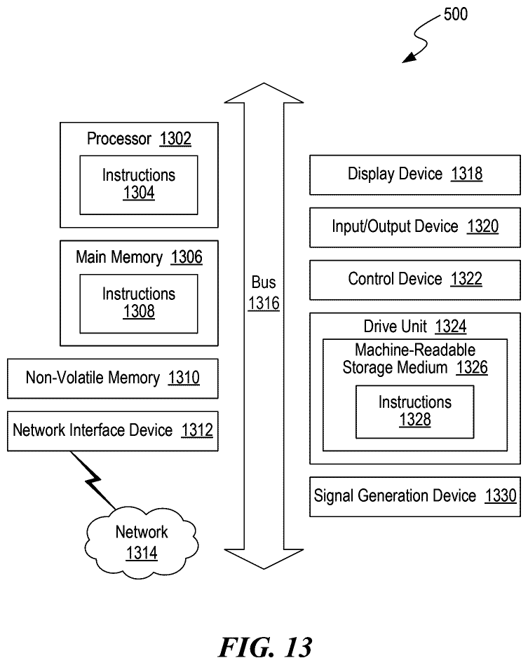

The input (e.g., the user prompt 206, the domain ontology map 204, and/or the domain-specific lexical dataset 202 of FIG. 2) can be used to generate outputs using artificial intelligence models, such as large-language models (e.g., via the data generation engine 118 of FIG. 1). For example, an artificial intelligence model includes a computational system that processes input data through learned parameters to generate predictions, classifications, or content based on patterns identified during training. For example, an artificial intelligence model includes neural network architectures, such as transformers, convolutional neural networks, or recurrent neural networks (e.g., as described in FIG. 13) that have been trained on large datasets to understand and generate natural language or other data types. In some implementations, the artificial intelligence model includes large-language models (LLMs) that leverage attention mechanisms and deep learning architectures to process textual inputs and generate contextually appropriate outputs. The data generation platform can include a domain-sensitive AI model (e.g., corresponding to the domain generator 208 of FIG. 2 or the domain generator agent 304 of FIG. 3) that includes or leverages an artificial intelligence model, such as a base large-language model. By leveraging a domain-specific model (e.g., a base AI model that leverages domain-specific information, such as lexical datasets or ontology maps), the data generation platform can generate domain-specific outputs that comply with relevant domain-specific standards, requirements or expectations, while precluding resource-intensive re-training or finetuning of the underlying AI model or parameters thereof.

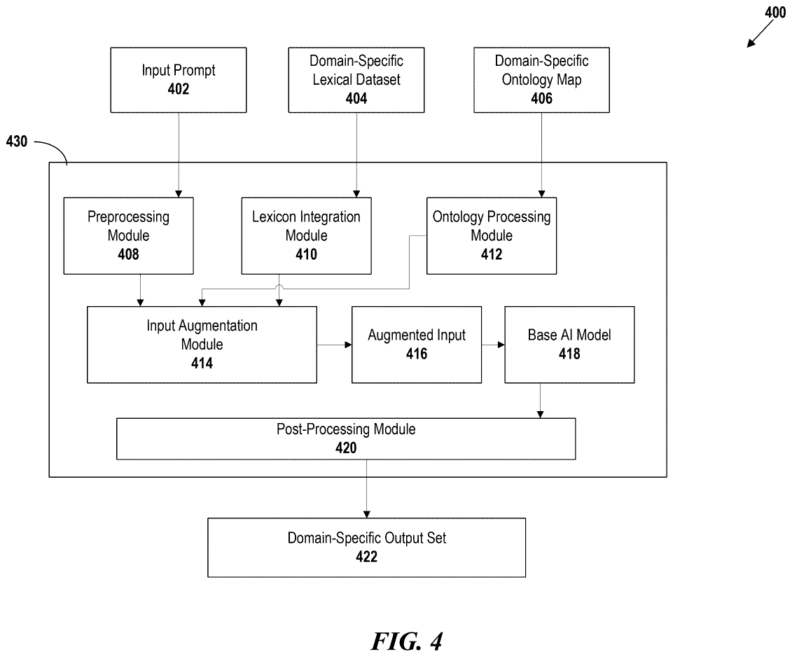

FIG. 4 illustrates an example architecture 400 for a domain-specific generation engine 430, in accordance with one or more implementations of the disclosed technology. The domain-specific generation engine 430 is an example of a domain-sensitive AI model, which can include an artificial intelligence model or any protocol or algorithm that can receive an input and generate a domain-specific output. For example, the domain-specific generation engine 430 corresponds to the domain-sensitive AI model and includes various components, including a preprocessing module 408, a lexicon integration module 410, an ontology processing module 412, an input augmentation module 414, a base AI model 418, and/or a post-processing module 420. For example, the domain-specific generation engine 430 (e.g., a domain-sensitive AI model) receives, as input, the input prompt 402, the domain-specific lexical dataset 404, and/or the domain-specific ontology map 406.

The data generation platform 102 can provide inputs to a domain generator agent 304 (e.g., of FIG. 3). For example, the domain-specific generation engine 430 (e.g., a domain-sensitive AI model) receives an input including a version of the input prompt (e.g., the input prompt 402), a domain-specific lexical dataset 404, and/or a domain-specific ontology map 406 and generates, based on the input, a domain-specific output set 422.

To illustrate, the domain-specific generation engine 430 leverages a preprocessing module 408 (e.g., a large-language model or the base AI model) to perform a prompt analysis, classify an associated domain for the prompt, and/or extract a relevant context from the prompt. In some implementations, the domain-specific generation engine 430 decomposes text or components of the input prompt 402 into analyzable components using natural language or image/video/audio processing techniques.

The domain-specific generation engine 430 can receive the domain-specific lexical dataset 404 at a lexicon integration module 410. For example, the lexicon integration module 410 maps terms associated with the domain-specific lexical dataset 404 (e.g., an associated key-value dataset), expands acronyms based on the lexical dataset, injects definitions to be integrated into a modified input prompt, and/or resolves synonyms according to domain-specific rules defined within the lexical dataset.

The ontology processing module 412 of the domain-specific generation engine 430 can receive the domain-specific ontology map 406 at the ontology processing module 412. For example, the ontology processing module 412 extracts rules, constraints, relationships, and/or structure templates associated with the domain-specific ontology map 406. By doing so, the ontology processing module 412 enables generation of an output that is consistent with associated rules or constraints imposed within the domain-specific ontology map 406.

In some implementations, the data generation platform 102 updates the domain-specific ontology map 406 prior to input into the domain-sensitive AI model. For example, the data generation platform 102 can obtain a preliminary domain-specific ontology map (e.g., stored on an ontology map database that includes ontology maps for different domains). The data generation platform 102 can obtain or detect a domain-related update (or an updated thereof). For example, the data generation platform 102 receives an indication of a modification in an ontological constraint, a validation criterion, a conceptual hierarchical attribute, a reasoning rule set, or any other modification or change within elements of the domain-specific ontology map (e.g., as described above). The data generation platform 102 can provide the representation of the domain-related update and the preliminary domain-specific ontology map to the base AI model (e.g., a base language model) to generate an updated domain-specific ontology map (e.g., to be input into the domain-specific generation engine 430, e.g., to serve as the domain-specific ontology map 406). As an illustrative example, when new SEC regulations modify disclosure requirements for particular financial institutions, the data generation platform 102 can update the ontology map to include revised compliance rules and mandatory reporting elements, as well as indications of the particular financial institutions for which the changes apply. By doing so, the data generation platform 102 enables dynamic adaptation to evolving regulatory frameworks without requiring complete model retraining or complete ontology reconstruction/generation, thereby improving the responsiveness of the data generation platform to changing regulatory or conceptual/logical relationships associated with particular domains.

The base AI model 418 can include a foundational artificial intelligence model that provides general-purpose (e.g., domain non-specific) natural language processing capabilities and/or data processing capabilities without domain-specific specialization or constraints. For example, the base AI model 418 includes a pre-trained transformer-based language model that has learned broad patterns via training across diverse text corpora, thereby enabling generation of linguistically coherent outputs across multiple subject areas. In some implementations, the base AI model 418 includes large-language models including GPT-type architectures or other generative models that serve as an underlying computational engine for text-generation tasks.

In some implementations, the ontology processing module 412 enables inferences or processing of the domain-specific ontology map to generate, update, or refine rules, concepts, or constraints associated with the particular domain. For example, the data generation platform 102 obtains a representation of a domain-specific ontology that includes a class hierarchy dataset, an object property dataset, a cardinality constraint dataset, a range constraint dataset, a complex logical expression dataset, or a computational logic ontology language rule set (e.g., as described above). The data generation platform 102 can provide the representation of the domain-specific ontology to a computational reasoner model to generate an inferred ontological rule set (e.g., associated with the ontology processing module 412) for the representation of the domain-specific ontology and generate the domain-specific ontology map based on the inferred ontological rule set. As an illustrative example, the ontology processing module 412 infers that investment portfolios that include high-risk securities require enhanced disclosure statements based on existing regulatory hierarchy rules and risk classification constraints (which can be complex and practically impossible to infer manually due to the scale of the complexity of the constraints or rules). The ontology processing module 412 can generate a representation of the inference (e.g., in OWL or SWRL, or another computer-readable format) and generate the ontology map to include the inference. By doing so, the data generation platform enables automated derivation of complex domain rules without manual specification, ensuring comprehensive coverage of implicit domain requirements and logical consistency across generated outputs.

The input augmentation module 414 can receive the pre-processed input prompt from preprocessing module 408, the processed domain-specific lexical dataset 404 from the lexicon integration module 410, and an up-to-date, accurate ontology map from the ontology processing module 412 to generate an augmented input 416 that enables domain-specific output generation. For example, the data generation platform 102 can input the input prompt (or a version thereof), the domain-specific lexical dataset, and/or the domain-specific ontology map into a domain-sensitive language model (e.g., the domain-specific generation engine 430) to generate a first output set that includes natural language data that is responsive to the input prompt (or version thereof) and is associated with the domain. As an illustrative example, when generating investment advisory reports, the input augmentation module 414 combines a user's request for portfolio analysis with financial terminology definitions and regulatory compliance constraints to create enriched prompts that guide accurate report generation. Based on the augmented prompts, the data generation platform 102 can generate an output shaped by the provided constraints and lexicon, thereby enabling domain-specific generation of outputs in response to inputs associated with particular domains.

For example, the data generation platform 102 provides an augmented input 416 that captures information from the domain-specific lexical dataset 404 and the domain-specific ontology map 406, as well as the input prompt 402, to the base AI model 418 to generate an output set. In some implementations, the output set includes the domain-specific output set 422. Additionally or alternatively, the output set generated by the base AI model 418 is post-processed through the post-processing module 420 (e.g., to comply with any required or desired formatting requirements).

An output set can include generated content that includes natural language text, structured data, and/or multimedia elements that are generated by an artificial intelligence model (e.g., in response to user inputs and/or domain-specific constraints). For example, the output set includes natural language data that is associated with the determined domain and is responsive to a user input (e.g., the input prompt 402). In some implementations, the output set includes domain-specific reports, technical documentation, code snippets, and/or analytical summaries that incorporate specialized terminology and adhere to domain-specific formatting requirements or regulatory/compliance standards. To illustrate, the output set can include investment advisory reports containing SEC-compliant disclosures, risk assessments with regulatory warnings, or portfolio analyses formatted according to fiduciary standards. In some implementations, the output set includes a validation indicator that specifies whether input synthetic data (e.g., a simulated dataset) complies with associated constraints or regulations and/or sufficiently reflects the real-world data used to generate the data. For example, the output set includes an indication of whether the simulated dataset is consistent with the domain-specific ontology map. The validation indicator (e.g., a report) can use one or more lexical attributes or elements as specified in the domain-specific key-value dataset.

Additionally or alternatively, the output set includes a modified simulated dataset. As an illustrative example, the data generation platform accepts the simulated dataset as input and determines that the simulated dataset does not reflect statistical, semantic, and/or structural properties associated with the domain (e.g., as specified within the domain-specific ontology map) or any suitable constraints. Accordingly, the data generation platform can generate a modified simulated dataset that conforms to the ontology map. In some implementations, the data generation platform (e.g., concurrently or otherwise) generates a report indicating modifications or changes made to the simulated dataset in response to the determination that the input simulated dataset was non-compliant.

In some implementations, the augmented input 416 used to generate the output set (e.g., via the base AI model 418) includes a domain-specific generation template. For example, the data generation platform 102 inputs at least one of the domain-specific ontology map or the domain-specific lexical dataset (e.g., a key-value dataset) into the base generation model to generate a generation template for output generation based on the input prompt or version thereof. The generation template can include domain-specific structural information, validation criteria, natural language constraint rules, or example datasets that guide the AI model's output generation process. For example, in a financial services domain, the generation template includes mandatory SEC disclosure sections, required risk-warning language, standardized formatting markers for investment recommendations, and/or example compliance statements that can be incorporated into advisory reports or can guide formatting. By doing so, the data generation platform 102 can follow prescribed domain structures and include required regulatory elements without relying on the base model's general training to recall specialized compliance requirements.

As an illustrative example, the domain-specific structural information can include formatting requirements, document organization patterns, prescribed section arrangements, or other suitable information (e.g., represented as natural language text within the augmented prompt) that defines how content should be structured within a particular domain. In some implementations, the domain-specific structural information includes natural language text describing the ontological map and/or structures thereof, including natural language representations of logical reasoning or hierarchical information of the ontology map. The domain-specific validation criteria included within the generation template can include quality thresholds, accuracy requirements, or compliance standards that generated outputs must satisfy to be considered acceptable for the domain. Domain-specific constraint rules can include logical restrictions, regulatory limitations, and/or semantic boundaries that govern what content can be generated and how domain concepts can be combined, be expressed, or relate to each other. A domain-specific natural language example dataset can include sample outputs, reference documents, or template content that demonstrates proper terminology usage, formatting conventions, or compliance patterns within the domain.

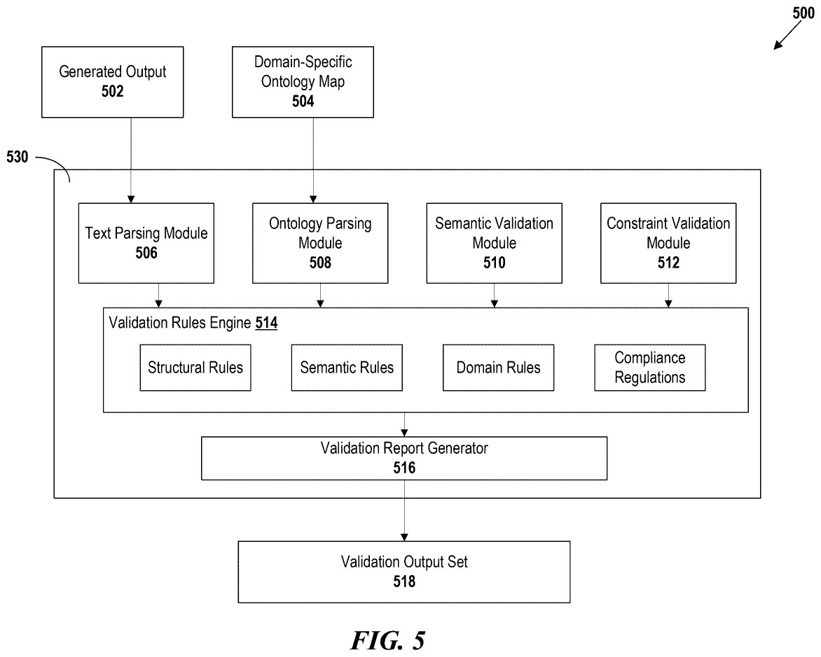

FIG. 5 illustrates an example architecture 500 for an ontology validation engine 530, in accordance with one or more implementations of the disclosed technology. For example, the ontology validation engine 530 (e.g., an ontology validation model) includes components such as a text parsing module 506, an ontology parsing module 508, a semantic validation module 510, a constraint validation module 512, a validation rules engine 514, and/or a validation report generator 516.

At 306 of FIG. 3, the data generation platform 102 (e.g., via the validation engine 124 of FIG. 1, the ontology validator agent 306 of FIG. 2, or the ontology validator 220 of FIG. 2), can generate a first validation output set based on the domain-specific ontology map and the first output set. For example, the data generation platform 102 inputs the domain-specific ontology map 504 and the generated output 502 (e.g., a domain-specific output set 422 generated by the domain-specific generation engine 430) into an ontology validation model (e.g., the ontology validation engine 530 or the ontology validator agent 306) to generate a first validation output set associated with the first output set. The first validation output set can include an indication of whether the first output set (e.g., the domain-specific output set 422) is consistent with rules associated with the domain-specific ontology map (e.g., an associated rule set). The rule set can include structural rules, semantic rules, domain rules, and/or compliance rules derived from the domain-specific ontology map. As an illustrative example, the data generation platform 102 can generate a validation output set 518 (e.g., a validation report generated by the validation report generator 516) that characterizes compliance violations, logical inconsistencies, or missing required elements within the generated output relative to the domain-specific ontological constraints and/or regulatory or compliance requirements. By doing so, the data generation platform enables systematic verification of domain-specific accuracy and compliance without relying on inherent limitations of context window-based approaches or inconsistent retrieval quality issues associated with conventional RAG systems. By validating the output prior to transmission to the user, the data generation platform can prevent the delivery of non-compliant or logically inconsistent content that results in regulatory violations or can require resource-intensive regeneration or manual corrections.

To illustrate, the text parsing module 506 can extract entities and/or otherwise text the generated output 502 (e.g., the text parsing module 506 of the ontology validation engine 530 can decompose the generated text (e.g., the generated output 502) into analyzable components using natural language processing techniques (e.g., a vector- or token-encoder). The ontology parsing module 508 can parse and/or load the domain ontology (e.g., the domain-specific ontology map 504), thereby extracting rules, constraints and/or relationships. In some implementations, the data generation platform 102 can, via the semantic validation module 510 of the ontology validation engine 530, verify that entities and relationships in the generated text conform to the ontological map or model. The constraint validation module 512 can check or ensure compliance with cardinality requirements, mandatory elements, and/or structural rules (e.g., associated with the domain-specific ontology map 504). The data generation platform 102 can pass information, results, evaluations, or outputs from the text parsing module 506, the ontology parsing module 508, the semantic validation module 510, and the constraint validation module 512 to the validation rules engine 514 for an analysis of the structural rules, semantic rules, domain rules, and/or compliance regulations associated with the domain. For example, the validation rules engine 514 applies complex validation logic to evaluate the generated output 502, including business rules and domain-specific requirements. Based on validation via the validation rules engine 514, the data generation platform 102 can leverage the validation report generator 516 to generate a validation report or a validation output set 518.

A validation output set (e.g., a validation report, such as the validation output set 518) can include an assessment of compliance and/or accuracy of generated content against domain-specific ontological constraints, regulatory requirements, and/or lexical requirements. In some implementations, the validation output set and/or the validation report includes data of textual or non-textual formats (e.g., video reports, audio, multimedia, etc.). To illustrate, the data generation platform 102, via the validation report generator 516, can generate a validation output set or report that includes detailed validation reports, including pass/fail decisions, violation details, and correction suggestions that identify specific areas where generated content fails to meet domain standards. In some implementations, the validation output set includes structured data indicating which ontological rules were violated, the severity of compliance issues, and/or recommend modifications to achieve conformance with domain-specific constraints, requirements, patterns, or expectations. As an illustrative example, the validation output set includes reports identifying missing SEC-required disclosures, incorrect risk classification terminology, and/or improperly formatted regulatory statements within investment advisory documents. The validation output set can specify locations of compliance violations within the generated output, reference specific regulatory requirements that were not met, and/or provide suggested prompt corrections or language corrections to ensure adherence to fiduciary standards and/or securities regulations.

In some implementations, upon determining that the output from the domain-sensitive AI model is non-compliant, can iteratively improve the input prompt to generate increasingly valid outputs. To illustrate, at 308 of FIG. 3, the data generation platform 102 can determine (e.g., based on the validation output set) whether the generated output set is valid according to ontological or lexical requirements (e.g., as specified within the ontology map or the lexical dataset). Based on determining that the generated output is not valid, the data generation platform 102 can iterate (e.g., via 310 of FIG. 3 or 222 of FIG. 2) and re-generate an output using the domain generator agent 304 (e.g., using an improved prompt generated in response to the validation report, and including indications of required corrections/sections/modifications). For example, the data generation platform 102 treats the non-compliant output set as a preliminary output set (e.g., where the original input prompt is treated as a preliminary input prompt) and regenerates an output iteratively by generating a modified input prompt (e.g., a version of the input prompt) for re-generation of an output set. The data generation platform 102 can then re-evaluate the regenerated output set at 306 of FIG. 3 and re-iterate if the output set is still invalid. In some implementations, the data generation platform 102 can accept user feedback 230 of FIG. 2 as feedback relating to iterations (e.g., at 222) or relating to ontology validation (e.g., at validator 220).

To illustrate, the data generation platform 102 can iteratively input the input prompt, the domain-specific lexical dataset, and the domain-specific ontology map into the domain-sensitive language model to generate a preliminary output set comprising preliminary natural language data responsive to the input prompt (e.g., via the iteration validation loop 222 of FIG. 2). The data generation platform 102 can input the domain-specific ontology map and the preliminary output set into the ontology validation model to generate a preliminary validation output set associated with the preliminary output set. The preliminary validation output set can indicate that the preliminary output set is inconsistent with the rule set derived from the domain-specific ontology map. In response to determining that the preliminary validation output set indicates that the preliminary output set is inconsistent with the rule set, the data generation platform 102 can generate, using at least one of the base language model or the domain-sensitive language model, the version of the input prompt that includes a modified version of the input prompt. As an illustrative example, when generating an investment advisory report that initially lacks required SEC disclosure statements, the data generation platform 102 can modify the input prompt to explicitly request inclusion of mandatory risk warnings or fiduciary disclosures. By doing so, the data generation platform 102 enables iterative refinement of generated content to achieve domain compliance without requiring manual intervention or extensive prompt engineering by users. Upon generation of an updated output and re-processing through the ontology validation model, the data generation platform 102 can determine an updated validation output set and re-iterate (e.g., re-generate a new prompt and regenerate an output) if the output is still inconsistent.

In some implementations, the data generation platform 102 can incorporate iteration limits on the iterative regeneration process. For example, the data generation platform 102 obtains a latest version of a set of previous input versions of the input prompt. Each version of the set of previous versions is input into the domain-sensitive language model to generate a corresponding preliminary output set that is used to generate a subsequent version of the set of previous versions. The data generation platform 102 can determine an iteration count with a threshold iteration count that represents a predetermined number of allowed iterations. In response to determining that the iteration count is equal to the threshold iteration count, the data generation platform 102 can determine that the version of the input prompt corresponds to the latest version of the set of previous input versions. As an illustrative example, when attempting to generate a financial compliance report that repeatedly fails validation due to conflicting regulatory requirements, the data generation platform 102 can limit the number of iterations to a particular number (e.g., 5, 10, 100, 1000, 5000, etc.) prior to proceeding with the best available output or triggering a warning to the user. As such, the data generation platform 102 prevents infinite loops and excessive computational resource consumption while ensuring system responsiveness and predictable processing times for users.

In some implementations, the data generation platform 102 determines to validate the output set upon determining that the validation output set indicates that the output set is consistent with the ontological or lexical rules or constraints associated with the domain. As an illustrative example, the data generation platform 102 determines a validated output set (e.g., by validating the first output set) in response to determining that the first validation output set indicates that the first output set is consistent with the rule set.

In response to validating that the generated output set complies with any ontology map- or lexical dataset-defined requirements, constraints, or patterns, the data generation platform 102 can input the original, unmodified input prompt into a base generator (e.g., the base generator 312 of FIG. 3) to generate an input that is unconstrained by the domain-specific ontology map and/or lexical dataset. For example, the data generation platform 102 can provide the input prompt 402 directly to the base AI model 418 of FIG. 4, without applying the domain-specific lexical dataset 404 or the domain-specific ontology map 406, thereby limiting the influence of domain-specific information on generation of a corresponding output. By doing so, the data generation platform 102 enables generation of unconstrained text using only the original user prompt, without access to domain-specific resources, in order to generate a baseline for comparison to ensure that the domain-specific output incorporates specialized knowledge rather than generic content.

For example, the data generation platform 102 inputs the input prompt into a base language model to determine an unconstrained output set comprising natural language data responsive to the input prompt. In some implementations, the data generation platform 102 generates the unconstrained output set in response to generating the validated output set. Additionally or alternatively, the data generation platform 102 generates the unconstrained output in an operation parallel to generating the first output set or the validated output set (e.g., using a parallelization-capable architecture, such as parallel CPU or GPU-based processing). By doing so, the data generation platform 102 enables time- and resource-efficient generation of outputs in response to user prompts and limits the temporal requirements associated with validating the domain-specificity of the generated outputs.

In some implementations, the unconstrained output set is unconstrained only by the particular domain-specific information provided to the data generation platform 102 (e.g., the ontology map and/or the lexical dataset). To illustrate, in some implementations, the unconstrained output set is constrained by other constraints, regulatory requirements, or guardrails (e.g., that are domain specific or are not domain specific).

The data generation platform 102 can provide the generated output (e.g., the validated output set 518 of FIG. 5) and the unconstrained output set (e.g., as generated by the base generator 312 of FIG. 3) to a differentiator agent 314 (e.g., the differentiator 226 of FIG. 2 or a domain validation model) of FIG. 3 to determine whether the generated output set is sufficiently domain-specific when compared to the base model's output. For example, the data generation platform 102 (e.g., via the validation engine 124 of FIG. 1) provides the validated output set and the unconstrained output set to a domain evaluation model to generate a domain-specificity indicator that indicates whether the validated output set is specific to the domain based on a comparison between the validated output set and the unconstrained output set. As an illustrative example, the data generation platform 102 generates a domain-specificity indicator that indicates a quantitative (e.g., via a cosine difference metric) or qualitative semantic difference between the unconstrained output (e.g., uninfluenced by the domain-specific information) and the constrained output (e.g., generated leveraging the domain-specific ontology map and/or the lexical dataset). By doing so, the data generation platform 102 can generate an indication of whether the domain-sensitive AI model generates a sufficiently domain-specific result as compared to a generalized AI model trained on generalized data (e.g., across a non-specialized corpora of data). As such, the domain-specificity indicator provides an indication of the quality and specialization of the domain-specific output.

For example, the data generation platform determines that the output is not sufficiently domain-specific based on the domain-specificity indicator. For example, the data generation platform generates an output corresponding to a modified simulated dataset and an associated modification report describing changes made to the input simulated set) is not sufficiently domain-specific. The data generation platform can determine that the report does not include a sufficient number of domain-related terms as included within the domain-specific key-value/lexical dataset based on a comparison with the base model-generated output. As such, the data generation platform can determine to re-generate the report using the missing domain-specific terms to improve the description of the modifications to the synthetic dataset that were made (e.g., indicating how the modified synthetic data complies with the domain-specific ontology map).

The domain-specificity indicator can include a quantitative or qualitative measure that indicates whether generated content exhibits domain expertise or domain-specific information as compared to outputs based on generic models (e.g., generic outputs). For example, the data generation platform 102 can generate the domain-specificity indicator based on a comparison of the presence, absence, or degree of domain-specific characteristics associated with the constrained and unconstrained datasets respectively. The data generation platform 102 can determine, using the domain-specific ontology map, a domain-specific characteristic set that characterizes natural language datasets associated with the domain. The domain-specific characteristic set can include at least one of a domain-specific structural characteristic, a domain-specific semantic characteristic, or a domain-specific lexical characteristic. The data generation platform 102 can determine a base characteristic metric value set for the unconstrained output set. Each base characteristic metric value of the base characteristic metric value set can indicate a particular degree of compliance of the unconstrained output set with a particular domain-specific characteristic of the domain-specific characteristic set. The data generation platform 102 can determine a characteristic metric value of the characteristic metric value set that indicates a particular degree of compliance of the validated output set (e.g., as influenced by the domain-specific information, such as the ontology map or lexical dataset) with a particular domain-specific characteristic of the domain-specific characteristic set. The data generation platform 102 can compare the base characteristic metric value set with the characteristic metric value set. In response to comparing the base characteristic metric value set with the characteristic metric value set, the data generation platform 102 can generate the domain-specificity indicator including an indication that the validated output set is specific to the domain.

As an illustrative example, the data generation platform 102 can compare an unconstrained output that generically discusses “investment strategies” (e.g., as generated by a base AI model) with a domain-constrained output that specifically references “SEC Rule 506(c) compliance for accredited investor solicitation” and includes mandatory risk disclosures. The data generation platform 102 can quantify the degree to which regulatory specificity and technical precision is achieved based on determining a metric that characterizes a particular aspect (e.g., a particular attribute or characteristic) that is specific to compliance with the domain (e.g., based on the ontology map for the particular domain). By doing so, the data generation platform ensures that generated content demonstrates genuine domain expertise rather than superficial terminology usage.

For example, the data generation platform 102 can generate the domain-specificity indicator based on the degree to which the unconstrained output and the domain-specific output differ with respect to compliance with one or more domain-specific structural characteristics, domain-specific semantic characteristics, and/or domain-specific lexical characteristics (e.g., as defined or described within the domain-specific ontology map or the domain-specific lexical dataset). For example, the domain-specific structural characteristic can include formatting patterns, document organization requirements, prescribed section requirements, or hierarchical information unique to a particular domain. The domain-specific semantic characteristic can include conceptual relationships, meaning constraints, or contextual usage patterns that define how terms and concepts interact within a particular domain. The domain-specific lexical characteristic can include specialized terminology, technical jargon, acronyms, or domain-specific language patterns that distinguish expert content from general text. For example, a characteristic metric value includes a numerical score or measurement that quantifies how well a particular dataset exhibits a particular domain-specific feature or requirement. In some implementations, the data generation platform 102 determines the domain-specific structural, lexical, or semantic characteristics by processing the domain-specific ontology map using a reasoner application and/or a large-language model (e.g., to determine characteristics specific to a particular domain but not specific to other domains or to a generalized domain).

For example, based on the characteristic metric value set (e.g., corresponding to the generated domain-specific output set) and the base characteristic metric value set (e.g., corresponding to the unconstrained output set), the data generation platform 102 can determine a difference metric value between the two characteristic metric value sets to generate a difference metric value. The data generation platform 102 can determine whether the difference metric value exceeds a threshold difference metric value to determine whether the domain-specific and unconstrained outputs are sufficiently distinct so as to conclude that the domain-specific output is sufficiently specialized (e.g., to a pre-determined degree). For example, the data generation platform 102 determines a difference metric value characterizing a difference between the characteristic metric value set and the base characteristic metric value set and determines that the difference metric value exceeds a threshold difference metric value. To illustrate, the data generation platform 102 can determine, for a particular domain-specific characteristic, a difference between the respective characteristic metric values for the unconstrained and domain-specific outputs respectively. The data generation platform 102 can sum or determine an average of the difference values across the different characteristics to determine a difference metric value and compare the difference metric value to a threshold value.

In some implementations, the data generation platform 102 determines the threshold value based on a preference received from a user (e.g., based on a desired domain-specificity level, e.g., as determined by a slider on a graphical user interface). By doing so, the data generation platform 102 enables user tunability as to the specialization level of the outputs generated.

In some implementations, the data generation platform 102 enables iteration (e.g., regeneration of the generated output) upon determination that the generated output is not sufficiently domain-specific (e.g., as shown in FIG. 3 with the arrow from 316 to 304. Upon determining that the data generation platform 102 is sufficiently domain-specific (e.g., that the difference metric value is greater than the threshold difference metric value), the data generation platform 102 determines that the domain-specific output generation is a success (e.g., at 318 of FIG. 3, confirming the validated output 228 in FIG. 2) and transmits the validated output set to a user device associated with the domain. In response to determining that the validated output set is specific to the domain, the data generation platform 102 can transmit the validated output set to a user device associated with the domain. As an illustrative example, the data generation platform 102 can route validated financial compliance reports to regulatory filing systems and/or associated users for review, filing, and/or submission of documents to SEC databases. In some implementations, the data generation platform 102 enables transmission of validated trading algorithm parameters generated via the data generation platform 102 to high-frequency trading platforms for immediate execution. For example, the data generation platform 102 can generate and validate algorithmic trading rules that area automatically transmitted to quantitative trading systems for real-time computational processing and market execution, thereby ensuring that generated trading logic adheres to regulatory constraints and risk management protocols before deployment. For example, the validated output transmitted to the user device can include executable code, configuration parameters, or structured data formats that integrate seamlessly with downstream financial processing systems. By doing so, the data generation platform 102 enables automated deployment of domain-compliant content to devices or systems, while preventing the transmission of non-compliant or insufficiently specialized outputs that compromise regulatory adherence or system performance.

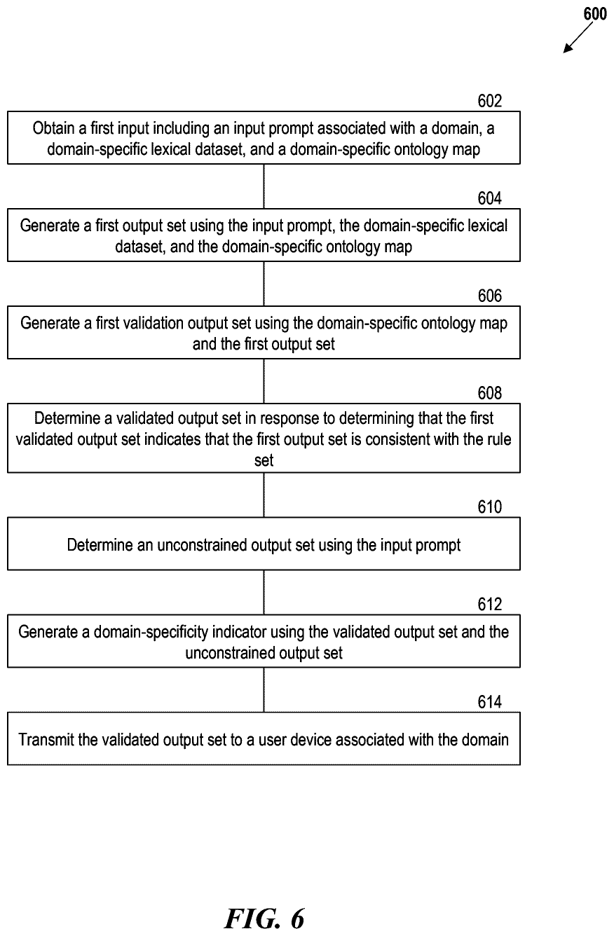

FIG. 6 illustrates an example flowchart 600 for a process for multi-agent generation and validation of domain-specific information based on ontological and lexical properties associated with the domain, in accordance with one or more implementations of the disclosed technology.

At 602, the data generation platform can obtain a first input comprising an input prompt associated with a domain, a domain-specific lexical dataset, and a domain-specific ontology map. For example, the data generation platform obtains a first input comprising (1) an input prompt associated with a domain, (2) a domain-specific lexical dataset, and (3) a domain-specific ontology map. The domain can specify a subset of a knowledge vector space. The domain-specific lexical dataset can include at least one of semantic or lexical information associated with the domain. The domain-specific ontology map can include, in a logical format, a node set associated with the domain and a node relationship set between one or more nodes of the node set.

In some implementations, the data generation platform dynamically updates domain-specific ontology maps based on domain-related changes. For example, the data generation platform obtains a preliminary domain-specific ontology map. The data generation platform can obtain a representation of a domain-related update. The domain-related update can include a modification in at least one of an ontological constraint, a validation criterion, a conceptual hierarchy attribute, or a reasoning rule set. The data generation platform can provide the representation of the domain-related update and the preliminary domain-specific ontology map to the base language model to generate an updated domain-specific ontology map including the domain-specific ontology map.

In some implementations, the data generation platform generates domain-specific ontology maps through computational reasoning from user-provided ontological representations. For example, the data generation platform obtains, via a graphical user interface of the user device, a representation of a domain-specific ontology including at least one of: a class hierarchy dataset, an object property dataset, a cardinality constraint dataset, a range constraint dataset, a complex logical expression dataset, or computational logic ontology language rule set. The data generation platform can provide the representation of the domain-specific ontology to a computational reasoner model to generate an inferred ontological rule set associated with the representation of the domain-specific ontology. The data generation platform can generate the domain-specific ontology map based on the inferred ontological rule set.

In some implementations, the input can include a validation request for synthetic data (e.g., simulated data) associated with a data transformation pipeline (e.g., as described with respect to FIGS. 7-10B). For example, the data generation platform obtains a simulated dataset associated with a data transformation pipeline including simulated node data for the one or more nodes of the node set. The simulated dataset can be generated using the domain-specific ontology map. The data generation platform can generate the input prompt including a request to validate the simulated dataset against the domain-specific ontology map. The data generation platform can generate the first input including the simulated dataset, the input prompt, the domain-specific lexical dataset (e.g., key-value dataset), and the domain-specific ontology map.

At 604, the data generation platform can generate a first output set using the input prompt, the domain-specific lexical dataset, and the domain-specific ontology map. For example, the data generation platform inputs the input prompt, the domain-specific lexical dataset, and the domain-specific ontology map into a domain-sensitive artificial intelligence (AI) model to generate a first output set including a first data set responsive to the input prompt and associated with the domain.

In some implementations, the data generation platform generates domain-specific outputs using generation templates that incorporate domain constraints into augmented prompts. For example, the data generation platform inputs at least one of the domain-specific ontology map or the domain-specific key-value dataset into the base language model to generate a generation template for output generation based on the version of the input prompt. The generation template can include at least one of: (1) domain-specific structural information, (2) domain-specific validation criteria, (3) domain-specific natural language constraint rules, or (4) a domain-specific example natural language dataset. The data generation platform can generate an augmented input prompt including a representation of the generation template. The data generation platform can input the augmented input prompt into the base language model to generate the first output set.

At 606, the data generation platform can generate a first validation output set using the domain-specific ontology map and the first output set. For example, the data generation platform inputs the domain-specific ontology map and the first output set into an ontology validation model to generate a first validation output set associated with the first output set. The first validation output set can indicate whether the first output set is consistent with a logical rule set derived from the domain-specific ontology map.

In some implementations, the data generation platform iteratively refines input prompts through validation feedback to achieve domain compliance. For example, the data generation platform inputs the input prompt, the domain-specific key-value dataset, and the domain-specific ontology map into the domain-sensitive language model to generate a preliminary output set including preliminary natural language data responsive to the input prompt. The data generation platform can input the domain-specific ontology map and the preliminary output set into the ontology validation model to generate a preliminary validation output set associated with the preliminary output set. The preliminary validation output set can indicate that the preliminary output set is inconsistent with the rule set derived from the domain-specific ontology map. In response to determining that the preliminary validation output set indicates that the preliminary output set is inconsistent with the rule set, the data generation platform can generate, using at least one of the base language model or the domain-sensitive language model, the version of the input prompt including a modified version of the input prompt.

In some implementations, the data generation platform limits iterative prompt refinement through iteration counting to prevent excessive iterations and associated computational resource usage. For example, the data generation platform obtains a latest version of a set of previous input versions of the input prompt. Each version of the set of previous versions can be input into the domain-sensitive language model to generate a corresponding preliminary output set that is used to generate a subsequent version of the set of previous versions. The data generation platform can determine an iteration count representing a number of iterations associated with the set of previous input versions. The data generation platform can compare the iteration count with a threshold iteration count representing a predetermined number of allowed iterations. In response to determining that the iteration count is equal to and/or exceeds the threshold iteration count, the data generation platform can determine that the version of the input prompt corresponds to the latest version of the set of previous input versions.

In some implementations, the data generation platform uses the original input prompt without modification as the version of the input prompt. For example, the version of the input prompt includes the input prompt.

At 608, the data generation platform can determine a validated output set in response to determining that the first validation output set indicates that the first output set is consistent with the rule set. For example, in response to determining that the first validation output set indicates that the first output set is consistent with the rule set, the data generation platform determines a validated output set including the first output set.

At 610, the data generation platform can determine an unconstrained output set using the input prompt. For example, in response to generating the validated output set, the data generation platform inputs the input prompt into a base AI model to determine an unconstrained output set including natural language data responsive to the input prompt.

At 612, the data generation platform can generate a domain-specificity indicator using the validated output set and the unconstrained output set. For example, the data generation platform provides the validated output set and the unconstrained output set to a domain evaluation model to generate a domain-specificity indicator indicating whether the validated output set is specific to the domain based on a comparison between the validated output set and the unconstrained output set.

In some implementations, the data generation platform generates domain-specificity indicators by comparing characteristic compliance metrics between domain-constrained and unconstrained outputs. For example, the data generation platform determines, using the domain-specific ontology map, a domain-specific characteristic set characterizing natural language datasets associated with the domain. The domain-specific characteristic set can include at least one of a domain-specific structural characteristic, a domain-specific semantic characteristic, or a domain-specific lexical characteristic. The data generation platform can determine a base characteristic metric value set for the unconstrained output set. Each base characteristic metric value of the base characteristic metric value set can indicate a particular degree of compliance of the unconstrained output set with a particular domain-specific characteristic of the domain-specific characteristic set. The data generation platform can determine a characteristic metric value set for the validated output set. Each characteristic metric value of the characteristic metric value set can indicate a particular degree of compliance of the validated output set with a particular domain-specific characteristic of the domain-specific characteristic set. The data generation platform can compare the base characteristic metric value set with the characteristic metric value set. In response to comparing the base characteristic metric value set with the characteristic metric value set, the data generation platform can generate the domain-specificity indicator including an indication that the validated output set is specific to the domain.

In some implementations, the data generation platform quantifies domain-specificity by measuring differences between characteristic metric values and comparing against predefined thresholds. For example, the data generation platform determines a difference metric value characterizing a difference between the characteristic metric value set and the base characteristic metric value set. The data generation platform can determine that the difference metric value exceeds a threshold difference metric value.

At 614, the data generation platform can transmit the validated output set to a user device associated with the domain. For example, in response to determining that the validated output set is specific to the domain, the data generation platform transmits the validated output set to a user device associated with the domain.

### Process for Generating Simulated Data Based on Node Datasets

The data generation platform (e.g., the data generation platform of FIG. 1) disclosed herein enables generation of synthetic data that retains structural, statistical, and semantic relationships within the underlying real-world data. For example, the data generation platform enables inference of statistical attributes of and relationships between various nodes of a financial transaction network (e.g., high-frequency trading entities, prime brokers, and/or trading desks of a trading network). Based on determination of explicit structural constraints within the data of the transaction network, as well as the inferred statistical attributes and relationships, the data generation platform can generate accurate synthetic data, informed by patent and latent relationships between entities, that enables validation and training of related artificial intelligence models (e.g., credit scoring, risk-assessment, and algorithmic trading models) in compliance with data protection regulations.

In some implementations, the data generation platform enables generation of synthetic data based on an inferred entity-relationship network capturing structural, statistical, and semantic attributes, in accordance with one or more implementations of the disclosed technology.

As an illustrative example, the data generation platform 102 can receive, via the communication engine 112, a node dataset that includes information relating to entities (e.g., within a distributed system) and relationships between the entities. For example, the node dataset includes an entity dataset (e.g., describing attributes associated with particular nodes or entities of a set of nodes), as well as a relationship dataset (e.g., including a representation of relationships between various nodes of the set of nodes).

A node dataset can include information characterizing a distributed network (e.g., real-world data). The node dataset can include structured data (e.g., in the form of a knowledge network) and/or unstructured data. For example, a node dataset includes an entity dataset and a relationship dataset. The entity dataset can include a representation of a set of nodes and associated node values. For example, a node represents a distinct entity within the system being modeled (e.g., a financial trade network or a distributed microservices network). A node can include a computational or logical unit within a system that includes particular attributes and can participate in relationships with other nodes. In the context of a microservices distributed system, a node can, for example, include a containerized microservice with attributes such as a service identifier, a container version, a deployment region, CPU usage, memory consumption, API endpoint configurations, and/or associated resource usage statistics. Additionally or alternatively, a node includes a trading entity (e.g., a prime broker, a customer, a hedge fund, and/or associated devices), associated with attributes such as an entity identifier, asset classes handled, daily trading volumes, risk limits, regulatory status, counterparty relationships, and/or information associated with particular transactions.

The relationship dataset can include a representation of one or more relationships within the received data. For example, a relationship includes a connection or association between two or more nodes that define, characterize, or describe how entities interact, depend on, or influence one another within the system. The relationships can be associated with attributes, semantic labels, or other characterizing data. For example, a relationship includes rules or descriptions (e.g., logs) of API calls between particular microservices, including attributes such as call frequency, response latency, data payload size, authentication methods, and/or error rates. Additionally or alternatively, a relationship includes data characterizing transaction flows between trading entities (e.g., prime brokers, hedge funds, customers, and/or associated devices), including attributes such as transaction frequency, settlement times, transaction volumes, counterparty risk scores, and/or regulatory compliance status.

In some implementations, the node dataset includes a knowledge network (e.g., representing the real-world data). A knowledge network can include a structured representation (e.g., a tabulated data structure, map, graph, vector, or another suitable structure) of entities, relationships, and associated attributes that captures the semantic meaning and/or interconnections within a domain or network. The knowledge network can provide a framework for organizing and understanding complex data relationships through nodes representing entities and edges representing relationships between the entities. For example, the knowledge network can include nodes representing individual microservices and edges representing API dependencies, data flows, and service interactions, with attributes capturing operational metrics and configurational details. Additionally or alternatively, a knowledge network includes nodes that represent trading entities (e.g., prime brokers, hedge funds, and trading desks), with edges representing the relationships, including transaction relationships, communication channels, regulatory dependencies, and/or other suitable relationships. For example, an edge of the knowledge network represents and/or are associated with attributes, such as trading volumes, risk metrics, and/or compliance requirements.

In some implementations, the data generation platform 102 includes the graph generation engine 114. The graph generation engine 114 can perform tasks relating to generation of and/or tuning of knowledge networks (e.g., node maps or ontological maps), including entity identifiers and relationships between associated entities. The graph generation engine 114 can include hardware components, software components, or a combination of both. For example, the data generation platform 102 can use the graph generation engine 114 to construct knowledge networks that represent structural relationships within received node datasets, such as dependencies between microservices in distributed systems or connections between financial entities in trading networks. In some implementations, the knowledge network represents explicit relationships (e.g., as defined or described within the real-world data or node dataset). Additionally or alternatively, the graph generation engine 114 (e.g., using the statistical analysis engine 116 and/or the relationship consistency engine 120) can determine latent relationships based on statistical trends, patterns, or attributes of the underlying data. For example, the graph generation engine 114 enhances existing knowledge networks by incorporating statistical information, thereby enabling identification of previously unknown dependencies or latent communication patterns between system components. The graph generation engine 114 can communicate with or interface with other components of the data generation platform 102, including the communication engine 112, the statistical analysis engine 116, the data generation engine 118, the relationship consistency engine 120, the temporal coherence engine 122, the validation engine 124, the export engine 126, and/or the domain-specific generation engine 128.

FIG. 7A illustrates an example of a data generation platform architecture 700 that employs bidirectional integration between statistical inference and knowledge network generation, in accordance with one or more implementations of the disclosed technology. For example, the data generation platform architecture 700 includes a knowledge network module 702, a statistical modeling module 706, a bidirectional integration layer 710, and/or a generative AI statistical enhancement module 712. Using the data generation platform architecture 700, the data generation platform 102 can generate synthetic data 714 that is consistent with real-world data (e.g., associated with an input node dataset, as described above).

FIG. 7B illustrates an example of a system architecture 750 for generating simulated data based on real-world data, in accordance with one or more implementations of the disclosed technology. For example, the data generation platform 102 can receive source data 752 (e.g., corresponding to a node dataset). The data generation platform 102 can perform data ingestion 754 (e.g., by pre-processing the data and/or structuring any unstructured data within the node dataset). Based on the pre-processed data, the data generation platform 102 can generate a knowledge graph (e.g., generate an entity-relationship network using the knowledge network module 702 of FIG. 7A) that is consistent with defined or implied relationships within the dataset.

As an illustrative example, the graph generation engine 114 of FIG. 1 is associated with the knowledge network module 702 and can carry out associated operations. The knowledge network module 702 can perform operations including entity discovery 704a, relationship mining 704b, constraint learning 704c, and/or can generate temporal patterns 706d.

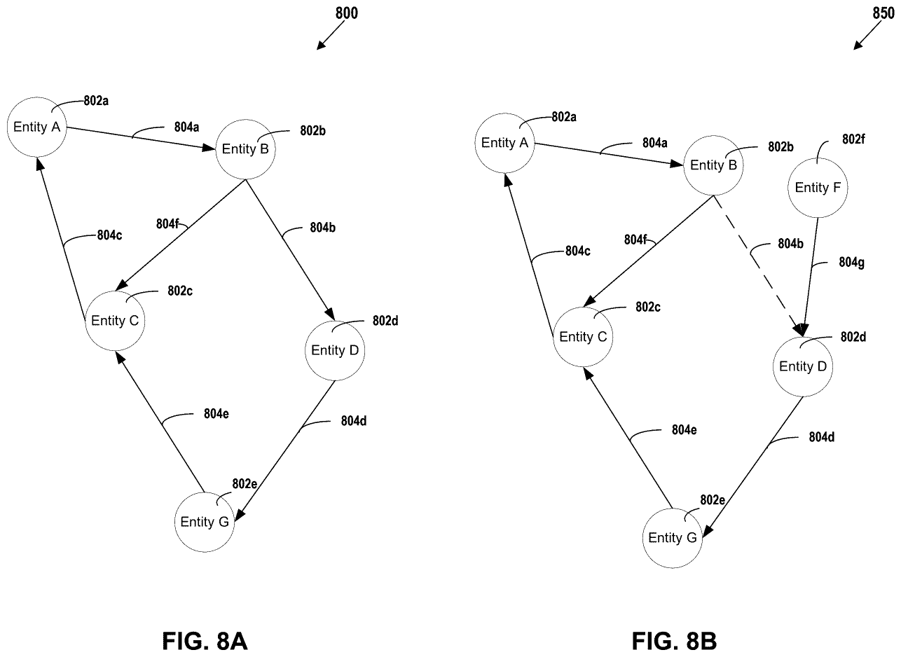

FIG. 8A illustrates a knowledge network 800 showing entity nodes and associated explicit relationships, in accordance with one or more implementations of the disclosed technology. To illustrate, the knowledge network 800 includes nodes 802a-802e, each representing a particular entity. The knowledge network 800 can include representations of relationships 804a-804e.

In some implementations, the graph generation engine 114 generates a knowledge network based on explicit relationships and attributes (e.g., entities) represented within the associated input node dataset (e.g., the real-world data). For example, the graph generation engine 114 can discover different entities and/or restructure unstructured data associated with the input node dataset to determine entity types associated with entities of the node dataset. The entity types include categories of objects within the data (e.g., microservice types and/or financial entity types, such as customer, products, and/or transactions). For example, the entity type can include an indication that a particular node is a customer, transaction, product or location. Additionally or alternatively, the entity represented within the knowledge network can include identity-based, transactional, categorical, locational, temporal, sensitive, and/or derived attributes. Attributes associated with customer-type entities can include identifiers, names, ages, and other suitable attributes. Attributes associated with transaction-type entities can include identifiers, dates, amounts, or other suitable attributes. Attributes associated with location-type entities can include identifiers, addresses, regions, or other suitable attributes. Attributes associated with product-type entities can include identifiers, names, categories, and other suitable attributes. In some implementations the knowledge networks (e.g., including associated entities or entity attributes) can be updated based on statistical or temporal inferences, as described below.

In some implementations, the knowledge network includes edges (e.g., the relationships 804a-804e) that represent connections between entities with associated constraints and cardinalities. For example, the knowledge network module 702 can execute relationship mining 704b operations to generate structured data representing relationships within the real-world data (e.g., the node dataset). In some implementations, the relationships can include identifiers of nodes associated with the endpoints of the relationship. For example, the relationship 804b can be associated with a node identifier for the node 802b (e.g., a source endpoint) and the node 802d (e.g., a target endpoint). The relationship can be associated with one or more types (e.g., and associated labels). Relationship types can include association, temporal, hierarchical, dependency, and/or causal relationships.

Moreover, referring to FIG. 1, the data generation platform 102 can include the statistical analysis engine 116. The statistical analysis engine 116 enables extraction and analysis of statistical information, metrics, and patterns from node datasets and knowledge networks. The statistical analysis engine 116 can include software components, hardware components, or a combination of both. For example, the statistical analysis engine 116 analyzes relationships, values, and attributes of node datasets (e.g., datasets associated with microservice usage within a distributed network or transactions within a financial network). Based on the analysis, the statistical analysis engine 116 can infer statistics, such as correlation coefficients, distribution parameters, variance values, and other statistical metrics that characterize interdependencies between entities or nodes. In some implementations, the statistical analysis engine 116 includes or interfaces with specialized processing units (e.g., graphics processing units or tensor processing units) that are associated with software to drive the units, thereby enabling efficient, parallel statistical computation and pattern recognition. The statistical analysis engine 116 can perform univariate analysis, multivariate correlation analysis, conditional dependency analysis, outlier detection, and time-series statistical analysis (e.g., independently or in conjunction with the temporal coherence engine 122). The statistical analysis engine 116 can communicate with or interface with other components of the data generation platform 102, including the communication engine 112, the graph generation engine 114, the data generation engine 118, the relationship consistency engine 120, the temporal coherence engine 122, the validation engine 124, and/or the export engine 126.

The statistical analysis engine 116 enables performance of statistical analysis 758 of FIG. 7B (e.g., based on statistical distribution modeling). As an illustrative example, the statistical analysis engine 116 can drive the statistical modeling module 706 (e.g., including one or more statistical inference models) of the data generation platform architecture 700. The statistical modeling module 706 can perform operations including distribution analysis 708a, generation of correlation matrices 708b, generation and evaluation of copula functions 708c, and/or time-series modeling 708d. For example, the data generation platform 102 provides the node dataset to a statistical inference model (e.g., associated with the statistical modeling module 706) to generate an inferred statistical dataset for the node dataset, including one or more copulae characterizing the dependence between random variables within the node dataset. Additionally or alternatively, the data generation platform 102 provides a knowledge network representing the node dataset to the statistical inference model to generate the inferred statistical dataset. The statistical modeling model associated with the module can include one or more artificial intelligence models, as described with respect to FIG. 4.

To illustrate, inferred statistical dataset can include statistical metrics and associated values, where the statistical metrics are associated with nodes of the node dataset and/or associated relationships. For example, the data generation platform 102 performs a correlation analysis, including identifying statistical correlations between API call latencies of different microservices in a distributed system or determining correlation coefficients between trading volumes of interconnected financial entities. Additionally or alternatively, the data generation platform 102 performs causal discovery, including applying Granger causality tests to identify temporal dependencies between microservice performance metrics or discovering causal relationships between trading decisions of different entities within a distributed financial network. Additionally or alternatively, the data generation platform 102 performs cluster detection, including identifying groups of microservices with similar resource usage patterns or detecting trading communities within financial networks based on transaction behaviors. Additionally or alternatively, the data generation platform 102 detects and determines anomaly patterns, including identifying unusual API call flows between microservices that indicate system issues, or detecting atypical trading patterns that represent market opportunities or risk indicators.

For example, statistical metrics that are monitored include univariate metrics, such as mean, variance, and distribution parameters for individual node attributes; multivariate metrics, such as correlation coefficients and covariance matrices between different entities; conditional dependency metrics capturing how values of one attribute affect distributions of others; outlier characteristic metrics identifying anomalous patterns and their frequencies; and time-series patterns that capture seasonal variations, trends, cyclical patterns, autocorrelation measures, temporal cross-correlation measures, and other suitable temporal dependencies. For example, statistical metrics include average API call latencies, distribution of service dependencies, correlation patterns between resource usage across different microservices, and/or temporal patterns in system load. Additionally or alternatively, statistical metrics include transaction volume distributions, correlation coefficients between trading entities, risk correlation patterns, volatility measures, and/or temporal trading frequency patterns capturing market dynamics and behavioral relationships.

Based on the inferred statistical dataset generated at the statistical inference model, the data generation platform can generate, update, and/or tune a knowledge network representing the real-world data (e.g., using a generative AI model suite 760 of FIG. 7B). For example, using the knowledge network module 702 and the bidirectional integration layer 710, the data generation platform 102 generates an inferred entity-relationship network that includes inferred node identifiers and node relationships based on the structural, semantic, and statistical properties of the node dataset (e.g., as described within the inferred statistical dataset). In some implementations, the statistical analysis engine 116 uses the generative AI statistical enhancement module 712 and/or the generative AI model suite 760 to generate the inferred entity-relationship network (and/or tune the knowledge network).

FIG. 8B illustrates an inferred entity-relationship network 850 including modifications to the knowledge network of FIG. 8A, in accordance with one or more implementations of the disclosed technology. For example, the inferred entity-relationship network includes modified or generated relationships, constraints, and/or other information based on statistical or relationship-based analysis of the real-world data (e.g., the received node dataset). For example, the inferred entity-relationship network 850 includes an additional relationship 804g and an additional node (e.g., the node 802f) as compared to the knowledge network 800 of FIG. 8A (e.g., based on an inference of a correlation between the node 802f and the node 802d that was not included in the original node dataset and/or knowledge network). In some implementations, the inferred entity-relationship network does not include a relationship (e.g., the relationship 804b) or a node of the original knowledge network (e.g., if an explicit correlation is not statistically significant), thereby enabling the system to detect and adapt changes in relationships or communications between different entities.

In some implementations, the knowledge network (inferred or original) can incorporate constraints, such as domain-specific constraints and/or validation rules. For example, the inferred entity-relationship network includes regulatory compliance constraints ensuring that synthetic financial data adheres to Basel III capital requirements, MiFID II transaction reporting standards, or anti-money laundering detection rules. Additionally or alternatively, the inferred entity-relationship network includes architectural constraints (e.g., associated with a distributed microservice system) that includes service dependency hierarchies, API versioning compatibility rules, resource allocation limits, and/or security access control policies. In some implementations, the inferred entity-relationship network incorporates business logic constraints (e.g., referential integrity requirements between customers and transaction entities, temporal ordering constraints for sequential market events, cardinality restrictions that limit the number of relationships between specific entity types, and statistical boundary conditions that ensure that synthetic data maintains realistic value ranges and distribution properties consistent with the underlying real-world system.

In some implementations, the data generation platform 102 includes the relationship consistency engine 120 (e.g., a relationship preservation framework to enable relationship preservation 762 of FIG. 7B). The relationship consistency engine 120 enables preservation and validation of complex inter-entity relationships prior to, during, and/or after synthetic data generation, enabling the preservation of direct and indirect dependencies. The relationship consistency engine 120 can include software components, hardware components, or a combination of both. For example, the relationship consistency engine 120 employs constraint satisfaction algorithms, relationship-aware sampling techniques, and post-generation validation to ensure that synthetic data adheres to structural integrity requirements and business logic constraints. In some implementations, the relationship consistency engine 120 interfaces with or includes specialized processing units (e.g., graph processing units or parallel computing clusters) that are associated with software to drive the units, thereby enabling efficient relationship validation and constraint checking. In some implementations, the relationship consistency engine 120 generates relationship embeddings, performs topological analysis of entity dependencies, and implements corrective feedback loops (e.g., via the validation engine 124) to address relationship violations during or following the generation process. The relationship consistency engine 120 can communicate with or interface with other components of the data generation platform 102, including the communication engine 112, the graph generation engine 114, the statistical analysis engine 116, the data generation engine 118, the temporal coherence engine 122, the validation engine 124, the export engine 126, and/or the domain-specific generation engine 128.

As an illustrative example, the data generation platform 102 can generate a set of constraints (e.g., based on the statistical dataset inferred from the real-world data and/or using the knowledge network module 702 to perform constraint learning 704c) for generation of simulated data using the inferred entity-relationship network and/or the inferred statistical dataset. The set of constraints can include indications of relationships (e.g., within the inferred entity-relationship network) to be constrained or set and/or can include other policies to guide or limit the generation of synthetic data, thereby improving its real-world applicability. For example, the set of constraints includes structural integrity constraints that preserve valid entity relationships and hierarchical dependencies. Additionally or alternatively, the set of constraints can include statistical fidelity constraints that maintain correlation patterns and distribution properties observed in the original data. In some aspects, the set of constraints includes temporal coherence constraints that ensure sequencing of events and causal relationships analogous to those in real-world data (e.g., the received node dataset). Additionally or alternatively, the set of constraints includes regulatory compliance constraints that enforce industry-specific rules (e.g., capital adequacy ratios or data protection requirements) and/or cardinality constraints (e.g., limiting the number of permissible relationships between entity types. In some implementations, the inferred entity-relationship network includes the set of constraints. Additionally or alternatively, the data generation platform 102 generates the set of constraints based on or independently of the inferred entity-relationship network. To illustrate, the bidirectional integration layer 710 can control the degree to which the inferred entity-relationship network is influenced by statistical inferences (e.g., by the statistical modeling module 706).

In some implementations, the data generation platform 102 can generate the set of constraints including hierarchical and/or priority-based handling. For example, the data generation platform 102 organizes constraints into multiple priority levels. For example, Level 1 critical constraints can include referential integrity requirements that are not to be violated during synthetic data generation. Level 2 important constraints can include business logic rules that define valid data states. Level 3 preferential constraints can include statistical relationship constraints that maintain data realism. Level 4 optimization constraints can include performance and distribution constraints. The data generation platform 102 can dynamically adjust constraint prioritization based on computational resource availability, regulatory requirements, or specific use-case demands, thereby enabling that higher-priority constraints are satisfied while lower-priority constraints are applied when system resources permit. For example, critical constraints can include regulatory capital limits and settlement requirements, while preferential constraints can include maintaining historical trading volume correlations and market microstructure patterns. As an illustrative example, the data generation platform 102 determines a priority threshold level based on a computational resource usage level associated with the data generation platform 102. For example, the priority threshold level is relatively high (e.g, a given constraint requires a relatively high priority for inclusion within the set of constraints and/or for incorporation within the simulated node dataset or generated synthetic data) when the computational resource usage of the system is relatively high. Additionally or alternatively, the data generation platform 102 determines a relatively low priority threshold level (e.g., where any constraints of any priority level can be incorporated within the simulated node dataset or generated synthetic data) when the computational resource usage is relatively low. For example, the priority threshold level is proportional to a resource usage metric value associated with the computing system.

In some implementations, the data generation platform 102 uses relationship-preserving sampling to generate indications of constraints (e.g., statistical constraints). For example, the data generation platform 102 (e.g., via the statistical modeling module 706 and/or the bidirectional integration layer 710) employs Gibbs sampling with constraints to iteratively sample values while respecting entity relationships. The data generation platform 102 can use a Metropolis-Hastings algorithm with relationship potential functions to accept or reject samples based on relationship consistency. The data generation platform 102 can use variational inference techniques to approximate complex joint distributions while maintaining interdependencies between nodes (e.g., entities). The relationship-preserving sampling can generate constraint indicators that specify acceptable value ranges for correlated attributes, maintain conditional probability distributions between related entities, preserve temporal ordering requirements for sequential data, and enable synthetic data generation that adheres to explicit relationships defined in the original knowledge network and implicit statistical dependencies discovered through the bidirectional integration process between structural relationships within the knowledge network and the statistically-inferred relationships associated with the underlying real-world data.

In some implementations, the data generation platform 102 generates the constraints including embeddings of relationships. For example, the data generation platform 102 creates learned vector representations of relationships using graph neural network embeddings that capture complex relationship patterns (e.g., multi-hop relationships), relationship type embeddings that encode different semantic categories of connections between entities, contextual relationship embeddings (e.g., that adapt based on specific entities being connected and their attributes) and temporal relationship embeddings (e.g., that capture time-varying relationship dynamics over time). To illustrate, the data generation platform 102 can ensure temporal coherence 764 (e.g., shown in FIG. 7B) based on generating the temporal relationship embeddings using a temporal coherence engine. The associated relationship and temporal relationship embeddings can be incorporated into the constraint generation process to enable generation of synthetic data that preserves complex and/or nuanced relationships that are difficult to express through traditional rule-based constraints, thereby enabling the system to maintain subtle interdependencies (e.g., hierarchical trading relationships in financial networks or complex service dependencies in distributed microservices architectures) during generation of synthetic data for validation (e.g., validation and quality assurance 766 of FIG. 7B) or testing. The relationships generated or tuned using the relationship transfer learning can be incorporated within the inferred entity-relationship network and/or the set of constraints.

In some implementations, the data generation platform 102 (e.g., through constraint learning 704c of the knowledge network module 702 of FIG. 7A) can execute relationship transfer learning to improve the accuracy and applicability of learned relationships (e.g., and associated constraints). For example, the data generation platform 102 performs cross-domain relationship mapping to transfer relationship patterns between similar domains (e.g., applying trading network structures learned from equity markets to derivative markets). Additionally or alternatively, the data generation platform 102 performs few-shot relationship learning to quickly adapt to new relationship types from minimal training examples. The data generation platform 102 can leverage relationship interpolation to generate intermediate relationship states that bridge different entity types or temporal periods. Additionally or alternatively, the data generation platform 102 performs relationship extrapolation to extend known relationship patterns to new contexts or previously unseen entity combinations. The relationship transfer learning process can leverage pre-trained relationship embeddings from large-scale knowledge networks and adapt relationship constraints based on domain-specific characteristics, thereby enabling the data generation platform 102 to generate synthetic data that maintains relationship fidelity, even with limited training data or novel entity configurations in complex distributed systems. The relationships generated or tuned using the relationship transfer learning can be incorporated within the inferred entity-relationship network and/or the set of constraints.

In some implementations, the data generation platform 102 (e.g., via the statistical analysis engine 116, graph generation engine 114, data generation engine 118, or the relationship consistency engine 120) can perform operations described herein in a parallel architecture to improve the performance of the data generation platform. For example, the data generation platform 102 enables independent subgraph generation (e.g., via the graph generation engine 114) to enable parallelization of generation of disconnected components of the inferred entity-relationship network. Additionally or alternatively, the data generation platform 102 can generate multiple relationship options in parallel prior to selecting one to include within the inferred entity-relationship network and/or set of constraints (e.g., via a speculative relationship generation engine). By doing so, the data generation platform 102 enables dynamic testing of various network topologies in a scalable manner. In some implementations, the data generation platform 102 enables graphics processing unit-accelerated constraint checking via parallelization schemes to improve the performance of constraint generation and validation. Additionally or alternatively, the data generation platform 102 enables distributed relationship validation (e.g., by scaling validation across multiple nodes), thereby reducing the computational burden of validating each node independently.

In some implementations, the data generation platform 102 enables caching and memorization to improve the latency and performance of generation of synthetic data. For example, in some implementations, the data generation platform 102 leverages a relationship pattern cache to store successful relationship generation patterns, thereby enabling retrieval when similar relationships arise in subsequently received real-world data. In some implementations, the data generation platform 102 can leverage a constraint resolution cache to store solutions to common constraint problems (e.g., solutions to multi-variate or multi-entity constraints that otherwise require iterative methods for generating consistent attribute values within the inferred entity-relationship network or resulting simulated node dataset). In some implementations, the data generation platform 102 includes a validation result cache to store validation results for repeated patterns to reduce the computational burden associated with validation tasks (e.g., with respect to the validation engine 124). In some implementations, the data generation platform 102 includes a relationship embedding cache, enabling pre-computation and storage of relationship embeddings.

Referring to FIG. 1, in some implementations, the data generation platform 102 includes the data generation engine 118. The data generation engine 118 enables generation of synthetic data (e.g., a simulated node dataset using the export and integration layer 768 of FIG. 7B) that maintains statistical properties, structural relationships, and/or temporal patterns of original datasets while ensuring privacy and anonymization. The data generation engine 118 can include software components, hardware components, or a combination of both. For example, the data generation engine 118 employs multiple specialized generative models, such as generative adversarial networks (GANs), variational autoencoders (VAEs), diffusion models, and transformer-based models, coordinate through a unified framework to generate high-fidelity synthetic data. In some implementations, the data generation engine 118 includes or interfaces with machine learning accelerators (e.g., graphics processing units, tensor processing units, or neural processing units) that are associated with software to drive the units, thereby enabling efficient synthetic data generation. In some implementations, the data generation engine 118 generates synthetic data based on constraints derived from inferred entity-relationship networks, ensuring that the generated data maintains both explicit structural relationships and implicit statistical dependencies. The data generation engine 118 can communicate with or interface with other components of the data generation platform 102, including the communication engine 112, the graph generation engine 114, the statistical analysis engine 116, the relationship consistency engine 120, the temporal coherence engine 122, the validation engine 124, and/or the export engine 126.

For example, the data generation engine 118 generates a simulated node dataset (e.g., the synthetic data 770 of FIG. 7B) that can reflect and/or include synthetic entities, synthetic relationships, synthetic relationships, and/or synthetic temporal sequences. For example, synthetic entities include artificially generated data objects representing distinct elements within the system (e.g., nodes) while maintaining statistical and structural properties of real-world entities. Synthetic entities can include simulated trading desks, hedge funds, prime brokers, or individual traders with realistic attributes (e.g., trading volumes, risk tolerances, and regulatory classifications). Additionally or alternatively, synthetic entities can include containerized services, API endpoints, or computing resources with appropriate resource utilization patterns, latency characteristics, and dependency requirements that mirror production environments without exposing sensitive operational data.

Synthetic relationships (e.g., inferred relationships) can include artificially generated connections between entities that preserve the structural integrity, statistical correlations, and semantic meaning (e.g., as found in real-world data associated with the received node dataset). For example, the relationships can include transaction flows between trading entities (e.g., with realistic volumes and frequencies), counterparty risk exposures, hierarchical reporting structures between trading desks and parent institutions, or market correlation patterns between different asset classes. In some implementations, the data generation platform 102 generates synthetic relationships within the simulated node dataset that include API call dependencies between simulated services, simulated data flow patterns, authentication requirements, service-level agreements, and resource-allocation relationships that maintain the complex interdependencies of the original system while enabling testing without operational leakage or risk.

In some implementations, the data generation platform 102 includes the temporal coherence engine 122. The temporal coherence engine 122 enables preservation of time-based patterns, sequential relationships, and causal dependencies in synthetic data generation, enabling preservation of the logical progression of events and the maintenance of temporal integrity. The temporal coherence engine 122 can include software components, hardware components, or a combination of both. For example, the temporal coherence engine 122 employs multiscale attention mechanisms, hierarchical encodings, neural Hawkes processes, and temporal point processes to model sequences and generate temporal dependency graphs that capture static and dynamic interrelationships. In some aspects, the temporal coherence engine 122 includes or interfaces with time-series processing units or recurrent neural network accelerators that are associated with software to drive the units, thereby enabling efficient temporal pattern analysis and sequence modelling (e.g., in a parallelizable manner). In some implementations, the temporal coherence engine 122 preserves seasonal patterns, cyclical behaviors, and causal sequences while maintaining static and dynamic statistical distributions, thereby enabling synthetic data to reflect realistic time-based behaviors essential for applications requiring temporal fidelity. The temporal coherence engine 122 can communicate with or interface with other components of the data generation platform 102, including the communication engine 112, the graph generation engine 114, the statistical analysis engine 116, the data generation engine 118, the relationship consistency engine 120, the validation engine 124, the export engine 126, and/or the domain-specific generation engine 128.

As such, the data generation platform 102 can generate the synthetic data (e.g., the simulated node dataset) including and/or adhering to synthetic temporal sequences. Synthetic temporal sequences can include artificially generated time-series data that preserves chronological patterns, seasonal variations, and causal relationships present in the real-world temporal data (e.g., as associated with the received node dataset). For example, the sequences include trading activity patterns showing realistic market open/close effects, seasonal volatility cycles, reaction sequences to market events, settlement timelines for different transaction types, or regulatory reporting schedules (e.g., with appropriate temporal dependencies). The synthetic temporal sequences can include traffic pattern variations throughout the day within a distributed microservices platform, service deployment and scaling events, scheduled maintenance windows, cascading failure patterns, and/or recovery sequences that maintain the temporal coherence necessary for realistic system testing and optimization.

For example, the temporal coherence engine 122 enables generation of temporal dependency graphs (e.g., using dynamic graph neural networks, causal discovery, dependency strength evaluations, and edge classification (e.g., classification of a particular relationship as being temporal, causal, or correlated in nature). The temporal coherence engine 122 can include domain-specific modules. For example, in the context of a complex financial entity network, the temporal coherence engine includes a transaction sequencer (e.g., enabling sequence analysis of different transactions, subject to settlement dependencies and regulatory constraints), a market-event correlator (e.g., correlating market events with cross-asset cascades or volatility spillover), a regulatory sequencer (e.g., enabling encoding of reporting deadlines and/or compliance patterns), and/or an anomaly preserver (e.g., enabling preservation of fraud patterns and/or market shocks). In some implementations, the data generation platform 102, via the temporal coherence engine 122, evaluates the temporal fidelity of generated synthetic data and/or associated inferred entity-relationship networks or temporal dependency graphs based on autocorrelation similarity, event timing accuracy, a causal preservation score, and/or a sequence likelihood. In some implementations, the data generation platform 102 enables adaptive temporal resolution (e.g., changing the time-step value associated with a time-series dynamically), temporal indexing, parallel processing, and/or graphics processing unit acceleration.

As an illustrative example, the data generation platform 102 incorporates time-series data associated with the node dataset to enhance temporal modeling capabilities. Each data point of the time-series data can be associated with a particular timestamp, enabling the system to capture temporal dependencies and sequential relationships. The data generation platform 102 can provide the time-series data along with other components (e.g., the node dataset, inferred entity-relationship network, set of constraints, or inferred statistical dataset) to a temporal coherence model to generate a temporal dependency graph that identifies temporal dependency constraints, sequence progression constraints, or time-based correlations. For example, the temporal dependency graph can capture the sequential nature of market events, such as how order placements during market volatility periods influence subsequent trading patterns across interconnected trading desks. The temporal coherence model enables the data generation platform 102 to generate synthetic datasets that preserve realistic time-dependent behaviors and causal relationships, thereby improving the accuracy of synthetic data for training machine learning models in algorithmic trading systems or risk assessment applications.

Synthetic anomalies can include artificially generated edge cases, outliers, or unusual patterns that maintain the statistical and contextual characteristics of anomalies found in real-world data. For example, an anomaly includes unusual trading patterns indicative of market manipulation, liquidity gaps during stress events, flash crash scenarios, compliance violations, or fraud indicators with appropriate statistical rarity and contextual relationships. In some implementations, synthetic anomalies include simulated service degradation patterns, resource exhaustion scenarios, unusual traffic spikes, security breach indicators, or cascading failure conditions that enable testing of detection and mitigation systems without introducing actual vulnerabilities or disruption to the real-world system.

In some implementations, the data generation platform 102 includes an anomaly preservation framework to enable generation of synthetic anomalies. For example, the data generation platform 102 detects anomalies at multiple levels (e.g., based on statistics, pattern recognition, and/or the associated domain). In some implementations, the data generation platform 102 classifies detected anomalies by value (e.g., with respect to alpha generation, market intelligence, risk indicators, and/or strategic signals). In some implementations, the data generation platform 102 enables preservation of particular temporal relationships (e.g., based on a financial impact score, strategic value score, and/or relationship preservation rules).

In some implementations, the data generation platform 102 can perform multi-dimensional bias mitigation for the synthetic data (e.g., the simulated node dataset) and associated inferred entity-relationship network and/or constraints. For example, the data generation platform 102 enables mitigation of direct discrimination bias, indirect/proxy discrimination bias, historical bias, representation bias, aggregation bias, and/or confirmation bias.

The data generation platform 102 can receive bias-related input data, including financial transactions, associated demographics, credit histories, and/or market data. The data generation platform 102 can utilize the statistical modeling module 706 to conduct demographic parity testing and/or conditional statistical tests to generate distribution divergence metrics, thereby enabling an intersectional analysis of various factors associated with bias. The data generation platform 102 can leverage a causal analysis module to perform counterfactual reasoning, explore path-specific effects, conduct a mediation analysis, and/or detect confounding factors. In some implementations, the data generation platform 102 includes a fairness module that leverages adversarial debiasing networks, fair representation learning, bias amplification detection, and/or model interpretability analyses. By doing so, the data generation platform 102 can perform multi-metric aggregation to determine a confidence score associated with bias detection within a particular dataset (e.g., received and/or generated). In some implementations, the data generation platform 102 detects a particular type of bias and assigns a severity level to the detected biases. Additionally or alternatively, the data generation platform 102 can provide the bias-related information to a regulatory compliance verification module to determine whether the generated synthetic data (e.g., the associated simulated node dataset) complies with regulatory requirements. Based on the determination, the data generation platform 102 can generate a bias detection report to enable mitigation of bias within the data generation platform 102.

The data generation platform 102 (e.g., via the data generation engine 118) can generate the simulated node dataset (e.g., suitable synthetic data) in a relationship-aware manner (e.g., by performing a relationship topology analysis, by leveraging contextual generation windows, or by leveraging the relationship-preserving sampling discussed above).

To illustrate, the data generation platform 102 can perform a relationship topology analysis to generate simulated data associated with strongly connected components together. The data generation platform 102 can determine, within the inferred entity-relationship network, at least two inferred nodes of the set of inferred nodes that are associated with a first inferred relationship of the set of inferred node relationships. In response, the data generation platform 102 can determine a topological sort of portions of the inferred entity-relationship network to determine an order in which to generate the simulated node dataset (e.g., the synthetic data). For example, a topological sort includes an ordering of nodes in a directed graph such that, for every directed edge from node A to node B, node A appears before node B in the ordering. As an illustrative example, the data generation platform 102 processes prime brokers (e.g., with no dependencies), then hedge funds (e.g., which depend on prime brokers), and finally individual trading desks (e.g., which depend on both prime brokers and hedge funds). Additionally or alternatively, the platform can process core services first, followed by dependent middleware services, and finally user-facing applications that rely on both core and middleware components. The approach enables the generation of dependent entities in a manner that maintains the accuracy and business logic of network relationships, while enabling efficient parallelization of generation of synthetic data. In some implementations, the data generation platform 102 can detect and resolve circular dependencies through relationship relaxation (e.g., by removing or relaxing a particular constraint).

In some implementations, the data generation platform 102 generates the simulated dataset while maintaining a sliding context window. By doing so, the data generation platform 102 (e.g., via the data generation engine 118) can preserve local relationship contexts and dependencies while limiting the burden on computational resources. Contextual generation windows can define bounded regions (e.g., within the inferred entity-relationship network) where entities and associated relationships are generated together as cohesive units, thereby ensuring that the synthetic data maintains contextual integrity of interrelated components. To enable harmonization between portions of the simulated dataset that are generated asynchronously, the context can include backward context (e.g., previously generated entities that constrain current generation), forward context (e.g., placeholder constraints for entities yet to be generated), lateral context (e.g., information relating to peer entities at the same hierarchical level) and/or temporal context (e.g., associated with time-based relationships and sequences). For example, a context generation window can include a prime broker and its directly connected hedge funds, ensuring that synthetic trading volumes, risk exposures, and transaction patterns between the entities remain consistent with the observed relationships in the original data. The data generation platform 102 can dynamically adjust the size and scope of the contextual windows based on the density of relationships, computational resources, and specific requirements of the target application, thereby enabling generation of synthetic data that preserves local relationship fidelity and global network coherence.

In some aspects, different components of the simulated node dataset (e.g., the synthetic data) are generated using a variety of specialized generative models. For example, the data generation engine 118 includes models, such as graph neural networks, variational autoencoders, transformer-based models, generative adversarial networks, and/or diffusion models. Each specialized generative model of the model suite can be associated with a particular model specialization that enables targeted generation of specific data types or patterns within the simulated node dataset. To illustrate, graph neural networks can specialize in generating entity relationships and network structures, preserving hierarchical dependencies and complex interconnections between nodes such as trading relationships in financial networks or service dependencies in distributed systems. Variational autoencoders can focus on generating statistical distributions and maintaining probabilistic relationships between attributes associated with nodes or relationships, ensuring that synthetic data preserves the underlying statistical properties (e.g., associated with transaction volumes, risk metrics, or resource utilization patterns). Transformer-based models can specialize in sequence data generation (e.g., to create temporal patterns and time-series information that capture market dynamics, trading frequencies, or system performance metrics over time). Generative adversarial networks can include high-fidelity instance generation, including realistic generation of synthetic entities with complex attribute combinations mirroring real-world trading desks, financial instruments, or system components. Diffusion models can specialize in numerical data generation, enabling generation of continuous-valued attributes (e.g., transaction amounts, latency measurements, or risk scores), while maintaining appropriate distributions and correlations. The data generation platform 102 can generate portions of the simulated node dataset where each portion is processed by the corresponding specialized model to generate model outputs that are subsequently integrated into the comprehensive simulated node dataset.

In some implementations, the data generation platform 102 includes the validation engine 124. The validation engine 124 can enable verification of synthetic data quality (e.g., to determine whether the generated data meets specified criteria for statistical fidelity, structural integrity, privacy preservation, and/or regulatory compliance). The validation engine 124 can include software components, hardware components, or a combination of both. For example, the validation engine 124 performs structural validation through graph isomorphism testing, cardinality verification, referential integrity checking, and/or constraint satisfaction verification processes. For example, the validation engine 124 can perform statistical validation testing (e.g., by comparing distributions and correlations), as well as semantic validation (e.g., via business rule verification or contextual coherence testing). In some aspects, the validation engine 124 includes or interfaces with validation accelerators or distributed computing resources that are associated with software to drive the units, thereby enabling efficient, large-scale validation and quality assurance processes. In some implementations, the validation engine 124 generates validation reports, calculates quality metrics, performs privacy leakage analyses, and provides feedback to other engines for iterative improvement of synthetic data generation (e.g., via a feedback mechanism). The validation engine 124 can communicate with or interface with other components of the data generation platform 102, including the communication engine 112, the graph generation engine 114, the statistical analysis engine 116, the data generation engine 118, the relationship consistency engine 120, the temporal coherence engine 122, the export engine 126, and/or the domain-specific generation engine 128.

For example, the data generation platform 102 can determine, using the validation engine 124, a validation status for components or aspects of the synthetic data (e.g., the simulated node dataset). The validation engine 124 can input the simulated node dataset into a validation model to generate a validation report for the simulated node dataset. The validation report can include an indication of at least one of a structural validation status, a statistical validation status, or a semantic validation status.

The structural validation status can include an indication of whether the simulated node dataset is consistent with the inferred entity-relationship network and the set of constraints. For example, the structural validation status includes an indication of whether synthetic trading relationships maintain proper hierarchical dependencies (e.g., between prime brokers and hedge funds, as defined in the inferred entity-relationship network). To illustrate, the validation engine 124 performs graph isomorphism testing to verify that the relationship structure matches the original (e.g., real-world) data. The validation engine 124 can perform cardinality verification to ensure that relationship multiplicities are preserved. Additionally or alternatively, the validation engine 124 performs referential integrity checking to validate foreign key relationships. The validation engine 124 can perform constraint satisfaction verification to determine whether the simulated node dataset satisfies defined constraints (e.g., within the set of constraints).

The statistical validation status can include an indication of whether the simulated node dataset is consistent with the inferred statistical dataset. To illustrate, the statistical validation status can include an indication of whether synthetic transaction volumes preserve correlation patterns and distribution properties observed in the original, real-world data. For example, the data generation platform 102 (e.g., via the validation engine 124) can perform joint distribution testing to validate the existence of relationship-dependent distributions (e.g., as consistent with the real-world data). The data generation platform 102 can compare correlation matrices (e.g., via the correlation matrices 708b operation of the statistical modeling module 706) to determine that the correlation matrices (e.g., between different attributes of the inferred entity-relationship network or resulting simulated node dataset) are similar to the correlation matrices observed in the real-world data (e.g., in the received node dataset). Additionally or alternatively, the data generation platform 102 can verify conditional probability relationships (e.g., using Bayes' theorem). The data generation platform 102 can perform mutual information analysis (e.g., to validate information content between related entities.

The semantic validation status can include an indication of whether the simulated node dataset is consistent with rule-based constraints. To illustrate, the semantic validation status includes an indication of whether the generated synthetic data (e.g., the simulated node dataset) adheres to business logic constraints, such as regulatory capital requirements or trading limit restrictions (e.g., in a domain-specific manner). For example, the data generation platform 102 performs temporal consistency checking (e.g., to validate time-based relationship logic). The data generation platform 102 can verify transitive relationships (e.g., to ensure that indirect relationships are preserved). Additionally or alternatively, the data generation platform 102 performs contextual coherence testing (e.g., to validate that generated relationships make semantic sense).

Based on the validation report, the data generation platform 102 can input the simulated node dataset into a data generation model to generate an updated simulated node dataset (e.g., that is consistent with the inferred entity-relationship network and is based on the simulated node dataset and the validation report). For example, the data generation platform 102, via the validation engine 124, employs one or more feedback loops to improve the accuracy of generated synthetic data.

In some implementations, the data generation platform 102 implements a multi-level feedback architecture. For example, data generation platform 102 implements micro-feedback mechanisms that enable entity-level corrections with fast response times (e.g., along the order of 1 ms), enabling real-time adjustments to individual synthetic trading entities or microservices. The data generation platform 102 can implement meso-feedback mechanisms for batch-level adjustments (e.g., with response times of approximately 100 ms), enabling corrections to groups of related financial instrument or service clusters, for example. The data generation platform 102 can implement macro-feedback mechanisms for system-wide tuning (e.g., with response times of approximately 1 s), thereby enabling holistic adjustments to market-wide or system-wide patterns. In some implementations, the data generation platform 102 implements meta-feedback mechanisms (e.g., that optimize the feedback process itself) by dynamically adjusting correction parameters (e.g., based on historical effectiveness).

In some implementations, the data generation platform 102 implements adaptive correction strategies. For example, the data generation platform 102 implements gradient-based correction strategies that use relationship violation gradients to incrementally adjust synthetic data parameters toward target statistical distributions. In some implementations, the data generation platform 102 uses reinforcement learning correction strategies (e.g., that use reward signals based on statistical fidelity and relationship preservation) to guide synthetic data generation, thereby improving the synthetic data's accuracy and compliance with associated requirements. The data generation platform 102 can implement evolutionary correction strategies that generate multiple candidate synthetic datasets and select those with superior preservation of inferred relationships (e.g., “critical”-level financial relationships/constraints or service dependencies). In some implementations, the data generation platform 102 performs Bayesian optimization correction strategies that build probabilistic models associated with generation parameters (e.g., associated with the inferred entity-relationship network), thereby enabling efficient exploration of the parameter space for improved generation of simulated data.

In some implementations, the data generation platform 102 implements feedback propagation mechanisms. For example, the data generation platform 102 implements backward propagation mechanisms that adjust upstream generation parameters (e.g., associated with various generation models of the generation model suite) based on current quality assessments. The data generation platform 102 can implement forward-propagation correction mechanisms that proactively adjust future synthetic data generation, thereby enabling anticipatory corrections to the generation pipeline. The data generation platform 102 can implement lateral propagation mechanisms for feedback (e.g., to improve generation of synthetic data, such as the simulated node dataset) by coordinating adjustments across peer entities (e.g., by spreading corrections to other entities at the same hierarchical level within the inferred entity-relationship network). The data generation platform 102 can implement temporal propagation mechanisms (e.g., by adjusting time-based dependencies to maintain consistency across time-based relationships, thereby preserving seasonal patterns in market activity).

In some implementations, the data generation platform 102 includes the export engine 126. The export engine export engine 126 enables conversion, formatting, and transmission of synthetic data to target systems, applications, or devices in formats compatible with their requirements and use cases. The export engine 126 can include software components, hardware components, or a combination of both. For example, the export engine 126 converts synthetic data into structured datasets for database testing, API call logs for performance analysis, streaming data for real-time system validation, or specialized formats for machine learning model training and artificial intelligence applications. In some aspects, the export engine 126 includes or interfaces with data transformation units or network interface controllers that are associated with software to drive the units, thereby enabling efficient data format conversion and secure transmission capabilities. The export engine 126 can communicate with or interface with other components of the data generation platform 102, including the communication engine 112, the graph generation engine 114, the statistical analysis engine 116, the data generation engine 116, the statistical analysis engine 118, the relationship consistency engine 120, the temporal coherence engine 122, the validation engine 124, and/or the domain-specific generation engine 128

The data generation platform 102 (and/or components thereof) can communicate (e.g., via the network 150 and the communication engine 112) with one or more third-party databases 108a-108n. The third-party databases 108a-108n can store various types of data that can be utilized by the data generation platform 102 for synthetic data generation, including reference datasets, validation benchmarks, regulatory compliance templates or information, industry-specific data schemas, and/or historical pattern libraries. In some implementations, the third-party databases 108a-108n include cloud-based storage systems, distributed databases, data warehouses, and/or specialized repositories that include domain-specific information relevant to the synthetic data generation process. The third-party databases 108a-108n can provide supplementary data sources that enhance the knowledge network construction, statistical modeling, and constraint generation processes performed by the data generation platform 102. In some aspects, the third-party databases 108a-108n include secure data repositories that require authentication and authorization protocols to access sensitive or proprietary datasets (e.g., associated with financial transactions and as regulated by suitable regulatory entities). The communication between the data generation platform 102 and the third-party databases 108a-108n can be facilitated through standardized APIs, secure data transfer protocols, or federated query mechanisms that enable seamless integration while maintaining data security and privacy requirements. The third-party databases 108a-108n can communicate with or interface with various components of the environment 100, including the communication engine 112, the graph generation engine 114, the statistical analysis engine 116, the data generation engine 118, the relationship consistency engine 120, the temporal coherence engine 122, the validation engine 124, the export engine 126, and/or the domain-specific generation engine.

For example, the data generation platform 102 transmits the simulated node dataset (e.g., synthetic data) to a device, server, node, other entity for validation, testing, or evaluation of machine learning models associated with the system. As an illustrative example, the data generation platform 102 provides synthetic financial trading data to regulatory compliance systems for stress-testing of risk management models. Additionally or alternatively, the data generation platform 102 transmits synthetic microservices performance data to development environments for load-testing and capacity planning (e.g., without exposing proprietary data associated with the real system). In some implementations, the data generation platform 102 formats the synthetic data (e.g., the simulated node dataset) according to target system requirements (e.g., by converting knowledge network representations into relational database schemas, transforming temporal sequences into time-series formats for analytical tools, or packaging synthetic datasets with associated metadata).

Engines, subsystems, or other components of the data generation platform 102 are illustrative. As such, operations, subcomponents, or other aspects of particular subsystems (e.g., engines) of the data generation platform 102 can be distributed, varied, or modified across other engines. In some implementations, particular engines can be deprecated, added, or removed. For example, operations associated with generation of the knowledge network can be performed at the statistical analysis engine 116, the relationship consistency engine 120, the temporal coherence engine 122, the validation engine 124 (e.g., or any suitable engine) instead of or in addition to the graph generation engine 114.

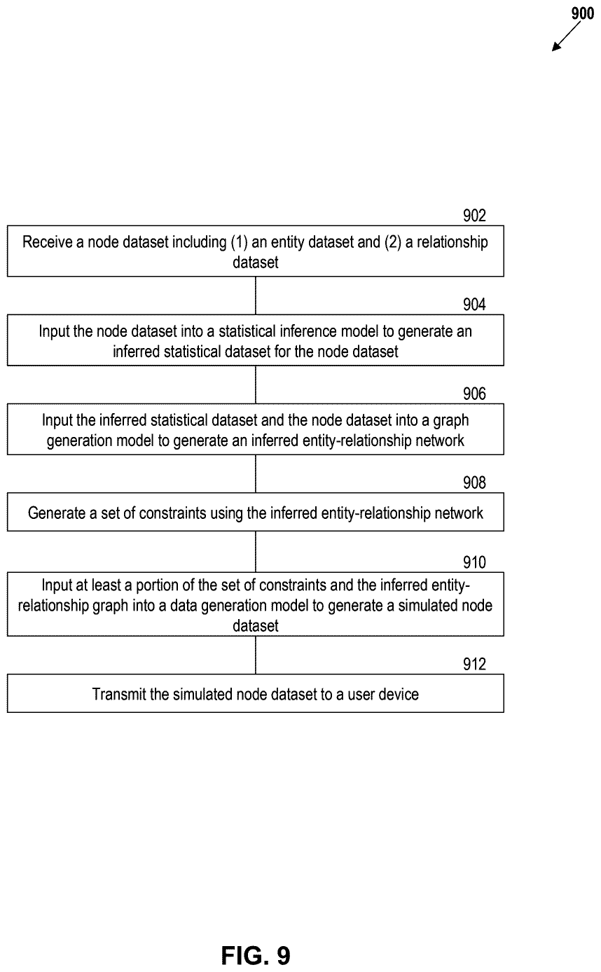

FIG. 9 illustrates an example flowchart for a process 900 for graph-driven synthetic data generation based on statistical inference of interdependencies and constraints, in accordance with one or more implementations of the disclosed technology. For example, the data generation platform 102 receives a financial trading network dataset including prime brokers and trading desks and their associated transaction relationships. The data generation platform can apply statistical inference to discover latent trading patterns and correlations, thereby enhancing the knowledge network with derived statistical metric values. By doing so, the data generation platform 102 enables generation of synthetic trading data that preserves network topology and statistical properties (e.g., for subsequent testing and/or validation of adjacent machine learning models) without exposing sensitive data.

At 902, the data generation platform 102 can receive a node dataset representing entities and associated relationships. For example, the data generation platform 102 receives a node dataset comprising (1) an entity dataset and (2) a relationship dataset. The entity dataset can include a representation of a set of nodes and associated node values. The relationship dataset can include a representation of relationships between at least two nodes of the set of nodes. As an illustrative example, the data generation platform 102 receives a node dataset representing a financial trading network corresponding to trading entities (e.g., prime brokers, hedge funds, and trading desks and associated computing devices). Relationships can represent transaction flows, dependency links, and/or communication patterns between the entities. By doing so, the data generation platform 102 enables the system to capture complex interdependencies within financial networks and/or other complex, distributed systems (e.g., a distributed system of microservices), thereby improving the accuracy and realism of synthetic data generation for regulatory compliance testing, risk assessments, or other suitable validation/training operations (e.g., for associated artificial intelligence models).

At 904, the data generation platform 102 can input the node dataset into a statistical inference model to generate an inferred statistical dataset (e.g., capturing statistical patterns, trends, or relationships within the node dataset). For example, the data generation platform 102 inputs the node dataset into a statistical inference model to generate an inferred statistical dataset for the node dataset. The inferred statistical dataset can include (1) a set of statistical metrics and (2) a set of statistical metric values associated with the set of statistical metrics. Each statistical metric of the set of statistical metrics can be associated with one or more nodes of the set of nodes or one or more relationships of the relationship dataset. As an illustrative example, the data generation platform 102 analyzes transaction volumes, latency patterns, and/or dependency strengths (e.g., between trading entities or microservices of a distributed network) to generate statistical metrics such as correlation coefficients between API call frequencies, average transaction processing times, and variance measures (e.g., for trading volumes across different market conditions). The statistical inference capabilities of the data generation platform 102 enable identification of previously unknown dependencies and latent communication patterns that are not explicitly defined in the original network structure (e.g., the original microservices log data or trading network data), thereby improving the accuracy of synthetic data generation for complex distributed systems.

In some implementations, the data generation platform 102 generates one or more statistical metric value associated with statistical measures of the received node dataset (e.g., the received financial transaction data). For example, the data generation platform 102 determines a statistical metric, of the set of statistical metrics, between at least two values of the associated node values of the set of nodes. The statistical metric can include at least one of a univariate metric, a multivariate metric, a conditional dependency metric, an outlier characteristic metric, or a time-series statistical metric. The data generation platform 102 can provide the node dataset to the statistical inference model to generate at least one statistical value corresponding to the determined statistical metric. The data generation platform 102 can generate the inferred statistical dataset including the at least one statistical value associated with the statistical metric. As an illustrative example, the data generation platform 102 (e.g., through the statistical analysis engine 116) analyzes transaction volumes between trading entities to determine correlation coefficients, variance measures, and/or outlier patterns in trading behavior across different market conditions. By incorporating multiple types of statistical metrics, the data generation platform 102 enables more accurate detection and preservation of complex trading patterns and relationships, thereby improving the fidelity and reliability of synthetic financial data generation while maintaining privacy requirements and avoiding the use of personal or proprietary data (e.g., as regulated by relevant regulatory organizations).

At 906, the data generation platform 102 can input the inferred statistical dataset and the node dataset into a graph generation model to generate an inferred entity-relationship network (e.g., representing ontological structures, such as trading network patterns). For example, the data generation platform 102 inputs the inferred statistical dataset and the node dataset into a graph generation model to generate an inferred entity-relationship network including (1) a set of inferred node identifiers corresponding to a set of inferred nodes and (2) a set of inferred node relationships. The inferred entity-relationship network can include an indication of structural, semantic, and statistical properties of the node dataset. The indication of the structural, semantic, and statistical properties can be consistent with the inferred statistical dataset. Each relationship of the set of inferred node relationships can indicate a particular relationship label between at least two particular nodes of the set of inferred nodes. As an illustrative example, the data generation platform 102 generates an inferred entity-relationship network for a financial trading network that captures explicit relationships (e.g., direct trading partnerships or communications between prime brokers and hedge funds) and latent statistical dependencies (e.g., correlated trading volumes during market volatility events), thereby enabling the system to represent complex multi-dimensional trading behaviors that emerge from statistical analysis of transaction patterns. By leveraging a bidirectional integration layer between generated knowledge networks and statistical inferences, the data generation platform 102 enables enhanced, accurate modelling of real-world systems (e.g., financial system dynamics and/or dynamics within a distributed mesh of microservices).

At 908, the data generation platform 102 can generate a set of constraints based on the inferred entity-relationship network. For example, the data generation platform 102 generates, using the inferred entity-relationship network, a set of constraints for generation of simulated data. As an illustrative example, the data generation platform 102 generates constraints that ensure that synthetic trading data maintains realistic transaction volume ratios (e.g., between prime brokers and associated hedge funds). For example, the data generation platform 102 preserves the temporal ordering of market events and can enforce regulatory requirements across generated trading entities. In some implementations, the data generation platform 102 generates a range of acceptable values for given attributes or factors associated with the node dataset, such as minimum and maximum transaction volumes, correlation thresholds between related entities, temporal dependencies that are maintained between sequential events, and structural integrity requirements, thereby ensuring referential consistency between interconnected nodes within the synthetic data generation process, even when associated constraints are latent.

In some implementations, the data generation platform 102 uses relationship sampling algorithms to determine constraining relationships to be reflected in the synthetic data generated. For example, the data generation platform 102 determines a relationship sampling algorithm comprising at least one of: a Gibbs sampling algorithm, a Metropolis-Hastings algorithm, or a Variational Inference algorithm. The data generation platform 102 can apply the relationship sampling algorithm to the received node dataset to determine a relationship constraint set associated with the set of inferred node relationships. The data generation platform 102 can generate the set of constraints including the relationship constraint set. As an illustrative example, the data generation platform 102 applies Gibbs sampling to iteratively sample trading relationships between financial entities, ensuring that synthetic transaction flows maintain realistic dependency structures (e.g., between prime brokers, hedge funds, and trading desks), while preserving context-specific (e.g., market-specific) correlation patterns observed in the original trading network. By doing so, the data generation platform 102 can generate synthetic data that maintains complex interdependencies necessary for training and validation of models (e.g., that enable stress testing and risk assessment modeling) in distributed systems (e.g., financial trading networks and/or distributed meshes of microservices).

In some implementations, the data generation platform 102 embeds the relationship using an embedding model to generate the relationship-based constraint. For example, the data generation platform 102 inputs the received node dataset into a constraint generation model to generate a relationship embedding set with respect to the received node dataset. Each relationship embedding of the relationship embedding set can characterize a corresponding inferred node relationship of the set of inferred node relationships. The relationship embedding set can include at least one of (1) a graph neural network embedding, (2) a relationship-type embedding, (3) a contextual-relationship embedding, and (4) a temporal relationship embedding. The data generation platform 102 can generate the relationship constraint set including the relationship embedding set. As an illustrative example, the data generation platform 102 generates graph neural network embeddings that capture hierarchical relationships between trading desks and parent institutions, relationship-type embeddings that distinguish between different transaction or relationship categories (e.g., equity trades, derivatives, repo agreements, etc.), and temporal embeddings that encode time-dependent trading patterns during market openings and closing periods. The embedding-based constraint generation enables preservation of nuanced relationship semantics that are computationally difficult to represent through traditional rule-based approaches, thereby improving the technical accuracy of synthetic data generation for complex financial network modeling applications.

At 910, the data generation platform 102 can input at least a portion of the set of constraints and the inferred entity-relationship network into a data generation model to generate a simulated node dataset. For example, the data generation platform 102 inputs at least a portion of the set of constraints and the inferred entity-relationship network into a data generation model to generate a simulated node dataset consistent with the set of constraints and the inferred entity-relationship network. As an illustrative example, the data generation platform 102 generates synthetic trading data (e.g., for a high-frequency trading network) where the simulated dataset maintains the hierarchical structure of entity relationships, as well as statistical properties (e.g., associated with transaction volumes, latencies, and market correlations observed in the original trading network). The constraint-guided generation process enables creation of technically accurate synthetic datasets that preserve complex financial system dynamics while ensuring regulatory compliance, thereby enabling stress-testing without exposing sensitive or proprietary trading information.

In some implementations, the data generation platform 102 leverages a specialized model to generate the synthetic data. For example, the data generation platform 102 determines a specialized generative model set associated with the data generation model. Each specialized generative model of the specialized generative model set can be associated with a particular model specialization of a model specialization set. The data generation platform 102 can generate, based on: (1) the inferred entity-relationship network, (2) the set of constraints, and (3) the model specialization set, a portion set. Each portion of the portion set can correspond to a particular portion of the inferred entity-relationship network or a particular portion of the set of constraints. Each portion of the portion set can be associated with a corresponding model specialization of the model specialization set. The data generation platform 102 can provide each portion of the portion set to a corresponding specialized generative model of the specialized generative model set that is associated with a corresponding model specialization of the model specialization set to generate a model output set. The data generation platform 102 can generate the simulated node dataset including the model output set. As an illustrative example, the data generation platform 102 employs specialized graph neural networks for modelling hierarchical trading relationships, variational autoencoders for generating transaction volume distributions, and/or transformer models for preserving temporal trading frequencies within a high-frequency trading environment. The modular specialization enables parallel processing of different aspects of the real-world data, while maintaining consistency across the entire synthetic dataset, thereby reducing computational complexity and improving scalability for large-scale financial network simulation applications.

In some implementations, the data generation platform 102 can integrate temporal data to generate constraints that reflect temporal patterns within the real-world data. For example, the data generation platform 102 determines time-series data associated with the node dataset. Each data point of the time-series data can be associated with a particular timestamp of a set of timestamps. The data generation platform 102 can provide the time-series data and at least two of the node dataset, the inferred entity-relationship network, the set of constraints, or the inferred statistical dataset to a temporal coherence model to generate a temporal dependency graph consistent with the time-series data. The temporal dependency graph can identify at least one of a temporal dependency constraint, a sequence progression constraint, or a time-based correlation. The data generation platform 102 can provide the inferred entity-relationship network, the temporal dependency graph, and the set of constraints to the data generation model to generate the simulated node dataset consistent with the set of constraints, the inferred entity-relationship network, and the temporal dependency graph. As an illustrative example, the data generation platform 102 analyzes time-series trading data from a high-frequency trading network to generate temporal dependency graphs capturing sequential market events, such as order placement patterns (e.g., during market volatility periods) and the cascading effects of large block trades across interconnected trading desks. The temporal coherence modeling enables the platform to generate synthetic datasets that preserve realistic time-dependent trading behaviors and causal relationships, thereby improving the technical accuracy of synthetic data for training machine learning models to be used in algorithmic trading systems, risk assessment applications, or other suitable models.

In some implementations, the data generation platform 102 generates the simulated node dataset in a manner that preserves the distribution of anomalies in the underlying real-world dataset (e.g., the node dataset). For example, the data generation platform 102 can leverage an anomaly preservation framework to preserve temporal anomalies associated with the correct temporal context.

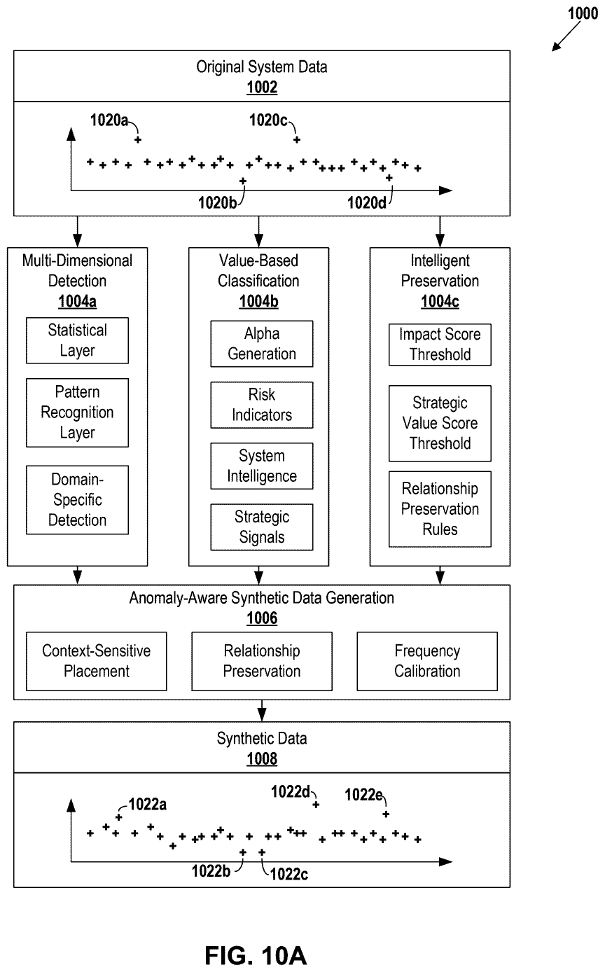

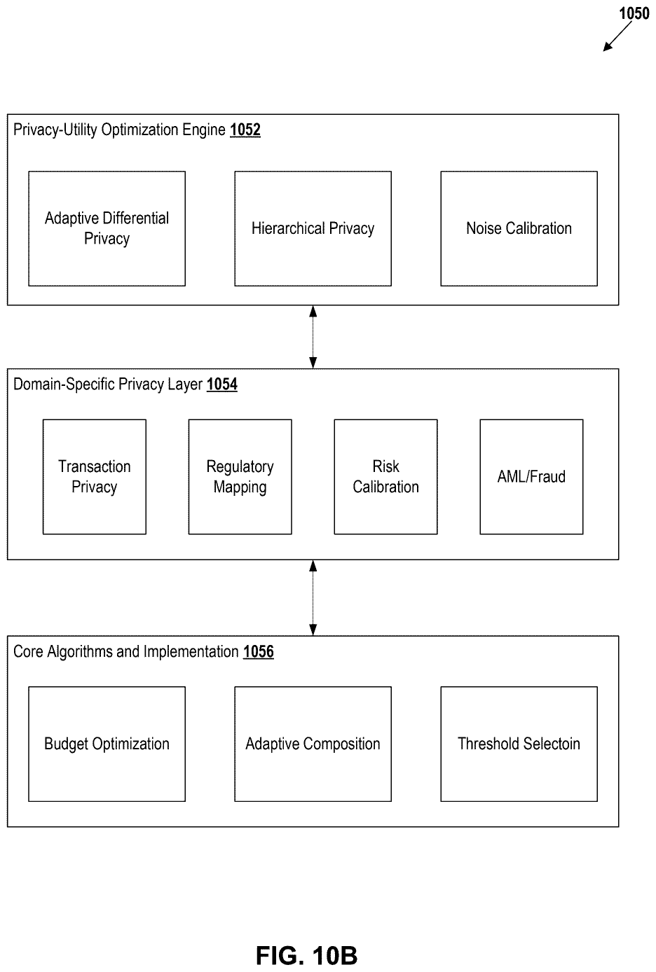

FIG. 10A illustrates an example architecture for an anomaly preservation framework 1000 associated with the data generation platform, in accordance with one or more implementations of the disclosed technology. For example, the data generation platform 102, via the anomaly preservation platform, receives a real-world dataset (e.g., the node dataset) corresponding to the original system data 1002. The original system data 1002 can include financial market data, including temporal anomalies (e.g., anomalies 1020a-1020d). To illustrate, anomalies can include arbitrage opportunities, liquidity anomalies, break correlation anomalies, and/or risk event anomalies associated with financial market timeseries data.

In some implementations, the anomaly preservation framework 1000 enables the data generation platform 102 to perform multi-dimensional detection at a module 1004a. For example, the module 1004a enables recognition of statistical information (e.g., at a statistical layer), patterns (e.g., at a pattern recognition layer), or domain-specific information (e.g., at a domain-specific detection layer) within the original system data 1002. For example, the data generation platform detects statistical, pattern-based, and/or domain-specific anomalies within the original system data 1002.

In some implementations, the anomaly preservation framework 1000 enables value-based classification of the real-world data represented within the original system data 1002 using a module 1004b. For example, the data generation platform can generate and/or measure alphas associated with a financial market (e.g., representing an excess return on investment in relation to a benchmark). The data generation platform can generate risk indicators (e.g., associated with a particular market or market structure), leverage system intelligence, and detect strategic signals associated with the financial market data. By generating or recording such information relating to the real-world data, the data generation platform enables characterization of anomalies within the real-world data that can be subsequently simulated within the generated simulated data (e.g., synthetic financial data), thereby enabling testing and validation of anomaly-related system performance.

In some implementations, the anomaly preservation framework 1000 enables intelligent preservation of aspects of the real-world data within the generated simulated data (e.g., using a module 1004c). For example, the data generation platform can, using module 1004c, determine that a financial impact score is greater than or equal to a particular threshold value, determine that a strategic value score is greater than or equal to another particular threshold value, and/or determine relationships between variables or data points within the data for preservation within the simulated data (e.g., the simulated node dataset). As an illustrative example, the data generation platform determines the economic significance value of a particular anomaly (e.g., a loss magnitude or a measure of the market disruption) and determine to preserve anomalies that are greater than a threshold economic significance value. Additionally or alternatively, the data generation platform can measure the relevance of a particular anomaly (e.g., one or more of anomalies 1020a-1020d) to a particular strategic objective (e.g., risk management, regulatory compliance, and/or model robustness) and generate a strategic object relevance metric accordingly. The data generation platform can compare the strategic object relevance metric to a particular threshold metric to determine whether to preserve the anomaly. Based on satisfaction of one or more thresholds, the data generation platform (e.g., via the module 1004c of the anomaly preservation framework 1000) can generate relationship preservation rules that preserve relationships and associated anomalies within generated synthetic data that is based on the real-world system data (e.g., the node dataset or original financial market data). In some implementations, the data generation platform represents the relationship preservation rules, including associated anomaly information (e.g., the multi-dimensional detection, value-based classification, or intelligent preservation data), within an inferred entity-relationship network (e.g., an inferred node map, as described above). Additionally or alternatively, the data generation platform represents the anomaly-related information within the set of constraints derived from the entity-relationship network.

The anomaly preservation framework 1000 enables the data generation platform to execute anomaly-aware synthetic data generation at the module 1006 of FIG. 10A. For example, the data generation platform generates the simulated node dataset (e.g., the simulated financial data) based on the real-world data by placing simulated anomalies, based on the anomaly-related information (and/or associated relationship preservation rules or constraints), within the simulated dataset in a context-sensitive manner. In some implementations, the generated simulated dataset is consistent with relationship preservation rules and, therefore, preserves statistical, pattern-based, and anomaly-related information derived from the real-world dataset. The data generation platform can calibrate the frequency of associated anomalies based on the multi-dimensional detection (e.g., from the module 1004a), the value-based classification (e.g., from the module 1004b) and/or the intelligent preservation (e.g., from the module 1004c). For example, the data generation platform determines a temporal frequency associated with a particular anomaly type (e.g., arbitrage opportunity-related anomaly, a liquidity anomaly, a break correlation-related anomaly, and/or a risk event-related anomaly) and generates, within the simulated dataset, anomalies according to the determined temporal frequencies.

To illustrate, the generated synthetic data 1008 of FIG. 10A includes anomalies 1022a-1022e that reflect the statistical information, patterns, domain-specific information, alphas, risk indicators, system intelligence, strategic signals, relationship preservation rules, context-information, and anomaly frequencies of the original system data 1002. For example, 1022a and 1022e reflects arbitrage opportunity-related anomalies temporally separated in a manner that reflects the average anomaly frequency for arbitrage opportunities within the real-world, original system data 1002 (e.g., original financial market data).

FIG. 10B illustrates an example of a privacy preservation framework 1050 associated with the data generation platform, in accordance with one or more implementations of the disclosed technology. In some implementations, the data generation platform leverages adaptive privacy controls to protect exposure of real-world data (e.g., the node dataset) to unauthorized computing systems. As an illustrative example, the data generation platform leverages a privacy-utility optimization engine 1052, a financial services privacy layer 1054, and/or a core algorithms and implementation module 1056.

To illustrate, the privacy-utility optimization engine 1052 leverages a differential privacy framework to enable the release of statistical information relating to a dataset while protecting the privacy of individual subjects of data. To illustrate, the data generation platform injects calibrated noise into statistical computations such that the utility of the statistic is preserved, while limiting what can be inferred about any individual in the dataset. A change to a particular entry in the generated simulated dataset only creates a small change in the probability distribution of the outputs of statistical measures. In some implementations, the data generation platform dynamically determines a differential privacy parameter value (e.g., a privacy budget represented by E) dynamically to control the amount of noise injected into the simulated dataset by data type, time, or dataset feature. For example, the data generation platform 102 assigns a differential privacy parameter value based on the an event type within the dataset, as well as the desired privacy level. The data generation platform 102 can assign a relatively high sensitivity (e.g., associated with a relatively low E value) to large trade events to improve the privacy and security for discrete events, while using a relatively high E value for aggregated daily volume data that does not require high levels of privacy.

In some implementations, the privacy-utility optimization engine 1052 enables the data generation platform 102 to perform a sensitivity analysis to validate and/or configure the differential privacy parameter value. For example, the data generation platform 102 perturbs the simulated data (e.g., by removing a particular data entry or other data element) and determines a resulting change in the statistical properties of the simulated dataset to determine a sensitivity value for the particular dataset and/or data element of the dataset. In some implementations, the data generation platform 102 adjusts the differential privacy parameter value (e.g., the privacy budget) in response to determining the sensitivity value for the dataset. The data generation platform 102 can implement temporal decay functions to assign a lower privacy budget value (e.g., a lower E value) to recent or real-time data, as such data can be more sensitive. As such, the data generation platform 102 can adjust the privacy budget according to the sensitivity and/or temporal features associated with the dataset.

In some implementations, the privacy-utility optimization engine 1052 determines privacy or exposure mitigation features in a hierarchical manner. For example, the data generation platform 102 determines privacy controls particular to various levels (e.g., at a global level, an entity level, or an attribute level). The corresponding level-specific controls can include privacy budgets (e.g., E values) particular to each level, each entity, and/or each attribute. In some implementation, the privacy preservation framework 1050 enables cascading guarantees (e.g., enabling privacy guarantees at higher levels, such as globally, to cascade down to lower levels, such as to the attribute or entity). For example, the data generation platform 102 exerts a constraint such that a sum of privacy losses at lower levels does not exceed the upper-level budget. In some implementations, the data generation platform enables granular optimization of privacy controls associated with data elements at different levels (e.g., at each hierarchical level) based on data sensitivity, utility, and age. In some implementations, the granular optimization is dynamically performed.

In some implementations, the privacy-utility optimization engine 1052 enables noise calibration for generation of the simulated dataset. For example, the data generation platform 102 enables dynamic adjustment of noise magnitude within the simulated dataset based on the context (e.g., data sensitivity, temporal relevance, or anomaly presence). For example, recent, high-impact trades associated with the real-world dataset receive more noise, while less sensitive historical data receives less noise. By doing so, the privacy-utility optimization engine enables context-aware scaling of privacy controls applied to the various elements or levels within the simulated dataset. In some implementations, the privacy preservation framework 1050, through the privacy-utility optimization engine 1052, applies asymmetric distributions to model real-world data characteristics or to minimize distortions in particular directions of the simulated data. For example, in financial data, negative outliers can be more critical, significant, or consequential than positive outliers. As such, a skewed noise distribution enables preservation and/or configuration of statistical tail behavior within the simulated dataset. In some implementations, the privacy-utility optimization engine enables calibration of noise within the dataset to minimize utility loss metrics for defined analytical tasks (e.g., anomaly detection, risk modeling, etc.). For example, the data generation platform 102 performs task-aware calibration of noise or adaptive epsilon allocation (e.g., of privacy budgets) based on the context of a particular task associated with the simulated data. In some implementations, the data generation platform 102, through the privacy-utility optimization engine 1052, imposes domain constraints that limit or configure the application of noise to the simulated data. For example, the domain constraints set valid data ranges to prevent unrealistic or infeasible simulated data values. As such, the privacy-utility optimization engine enables configuration of statistical features (e.g., noise) that enable privacy protection and exposure mitigation associated with sensitive data features of the real-world data underlying the simulated data.

The privacy preservation framework 1050 can include a domain-specific privacy layer 1054 that enables protection of particular, domain-specific features of the real-world dataset and associated simulated dataset. For example, the domain-specific privacy layer 1054 includes a transaction privacy layer that defines privacy budgets associated with different elements of transactions (e.g., transaction amounts, merchants, timestamps, and locations) within the real-world dataset. In some implementations, the domain-specific privacy layer 1054 includes a regulatory mapping module enabling compliance with different regulatory regimes, such as PCI-DSS, GDPR, Basel II rules, and/or SOX audit trails. In some implementations, the domain-specific privacy layer 1054 enables risk calibration based on impact assessments, probability scoring, and sensitivity analyses, thereby enabling dynamic adjustment of privacy controls and other related parameter values. In some implementations, the privacy preservation framework 1050 includes anti-money laundering or anti-fraud features, including pattern preservation, anomaly retention, network analysis, and alert thresholds. To illustrate, the privacy preservation framework 1050 (e.g., via the core algorithms and implementation module 1056) leverages algorithms including budget optimization, adaptive composition, and threshold selection to enable domain-specific privacy-utility optimization and exposure mitigation.

In some implementations, the data generation platform 102 generates constraints with different priority levels and generate the synthetic data such that it is consistent with certain constraints depending on their priority levels. For example, the data generation platform 102 generates the set of constraints. A first constraint subset of the set of constraints can be associated with a first constraint priority level. A second constraint subset of the set of constraints can be associated with a second constraint priority level. The data generation platform 102 can determine a system status indicating a computational resource usage level associated with the computing system. The data generation platform 102 can determine, using the system status, a priority threshold level. The data generation platform 102 can determine that the first constraint priority level satisfies the priority threshold level and that the second constraint priority level does not satisfy the priority threshold level. In response to determining that the first constraint priority level satisfies the priority threshold level and the second constraint priority level does not satisfy the priority threshold level, the data generation platform 102 can input the first constraint subset into the data generation model to generate the simulated node dataset. The simulated node dataset is consistent with the first constraint subset and not consistent with the second constraint subset. As an illustrative example, the data generation platform 102 prioritizes regulatory compliance constraints (e.g., capital adequacy ratios, position limits, etc.) over optimization constraints (e.g., constraints that improve the performance or scalability of the synthetic data generation system) when computational resources are not limited. Additionally or alternatively, the data generation platform 102 also prioritizes optimization constraints when the data generation platform 102 detects that system resource usage is high (e.g., above a particular usage threshold). The adaptive constraint prioritization mechanism enables maintenance of computational efficiency while preserving technically important data characteristics for training or validation of the target models.

In some implementations, the data generation platform 102 leverages a topological sort to determine portions of the synthetic data to generate preferentially to other portions. For example, the data generation platform 102 determines, within the inferred entity-relationship network, at least two inferred nodes of the set of inferred nodes that are associated with a first inferred relationship of the set of inferred node relationships. In response to determining the at least two inferred nodes, the data generation platform 102 can determine a topological sort of portions of the inferred entity-relationship network. A first portion of the inferred entity-relationship network can include the at least two inferred nodes and the first inferred relationship. The data generation platform 102 can input, in an order consistent with the topological sort, the portions of the inferred entity-relationship network into the data generation model to generate the simulated node dataset. The at least two inferred nodes and the first inferred relationship can be input into the data generation model simultaneously. As an illustrative example, the data generation platform 102 first processes a financial trading network by generating synthetic data for prime brokers (e.g., with no dependencies). Subsequently, the data generation platform 102 generates synthetic data associated with hedge funds (e.g., which depend on prime brokers) and, finally, individual trading desks (e.g., which can depend on both prime brokers and hedge funds). By doing so, the dependent entities are generated in a manner that improves the accuracy and business logic of the financial transaction network, enabling the platform to maintain referential integrity and dependency constraints during synthetic data generation, reducing the computational overhead and preventing the generation of invalid entity relationships that would compromise the structural, statistical, or semantic validity of the synthetic financial network.

At 912, the data generation platform 102 can transmit the simulated node dataset to a user device. For example, the data generation platform 102 transmits the simulated node dataset to a user device to cause validation or training, using the simulated node dataset, of an artificial intelligence model. As an illustrative example, the data generation platform 102 transmits synthetic high-frequency trading data to regulatory compliance systems for automated stress-testing of capital adequacy models or to machine learning development environments for algorithmic trading systems without exposing proprietary marketing strategies or regulatorily protected information. As such, the data generation platform 102 enables automated integration with downstream analytical streams, improving the technical efficiency of model validation workflows in distributed computing environments.

In some implementations, the data generation platform 102 performs validations of the generated synthetic data based on structural, statistical, and/or semantic properties of the synthetic data. For example, the data generation platform 102 inputs the simulated node dataset into a validation model to generate a validation report for the simulated node dataset. The validation report can include an indication of at least one of: (1) a structural validation status comprising an indication of whether the simulated node dataset is consistent with the inferred entity-relationship network and the set of constraints, (2) a statistical validation status comprising an indication of whether the simulated node dataset is consistent with the inferred statistical dataset, or (3) a semantic validation status comprising an indication of whether the simulated node dataset is consistent with rule-based constraints associated with the set of constraints. The data generation platform 102 can input the simulated node dataset, the inferred entity-relationship network, and the validation report into the data generation model to generate an updated simulated node dataset, consistent with the inferred entity-relationship network and based on the simulated node dataset and the validation report. As an illustrative example, the data generation platform 102 validates synthetic trading data by verifying relationships between particular entities within the knowledge network (e.g., structural validation), that transactions comply with regulatory requirements (e.g., semantic validation), and/or that transaction volume distributions and other statistical metrics are consistent with historical patterns (e.g., statistical validation). The validation framework enables the platform to ensure that synthetic data quality and regulatory compliance are maintained in automated financial system testing environments, thereby providing a technical solution to validating complex financial models without exposing sensitive or proprietary information.

### Example Implementation of the Models of the Synthetic Data Generation Platform

FIG. 11 illustrates a layered architecture of an AI system 1100 that can implement the ML models of the data generation platform 102 of FIG. 1. Example ML models can include the models executed by the data generation platform 102, such as remediation models, anomaly detection models, and so forth. Accordingly, the AI models of the synthetic data generation platform can include one or more components of the AI system 1100.

As shown, the AI system 1100 can include a set of layers, which conceptually organize elements within an example network topology for the AI system's architecture to implement a particular AI model. Generally, an AI model is a computer-executable program implemented by the AI system 1100 that analyses data to make predictions. Information can pass through each layer of the AI system 1100 to generate outputs for the AI model. The layers can include a data layer 1102, a structure layer 1104, a model layer 1106, and an application layer 1108. The algorithm 1116 of the structure layer 1104 and the model structure 1120 and model parameters 1122 of the model layer 1106 together form an example AI model. The optimizer 1126, loss function engine 1124, and regularization engine 1128 work to refine and optimize the AI model, and the data layer 1102 provides resources and support for application of the AI model by the application layer 1108.

The data layer 1102 acts as the foundation of the AI system 1100 by preparing data for the AI model. As shown, the data layer 1102 can include two sub-layers: a hardware platform 1110 and one or more software libraries 1112. The hardware platform 1110 can be designed to perform operations for the AI model and include computing resources for storage, memory, logic and networking, such as the resources described in relation to FIG. 5. The hardware platform 1110 can process amounts of data using one or more servers. The servers can perform backend operations such as matrix calculations, parallel calculations, machine learning (ML) training, and the like. Examples of servers used by the hardware platform 1110 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1110 can include computing resources, (e.g., servers, memory, etc.) offered by a cloud services provider. The hardware platform 1110 can also include computer memory for storing data about the AI model, application of the AI model, and training data for the AI model. The computer memory can be a form of random-access memory (RAM), such as dynamic RAM, static RAM, and non-volatile RAM.

The software libraries 1112 can be thought of suites of data and programming code, including executables, used to control the computing resources of the hardware platform 1110. The programming code can include low-level primitives (e.g., fundamental language elements) that form the foundation of one or more low-level programming languages, such that servers of the hardware platform 1110 can use the low-level primitives to carry out specific operations. The low-level programming languages do not require much, if any, abstraction from a computing resource's instruction set architecture, enabling them to run quickly with a small memory footprint. Examples of software libraries 1112 that can be included in the AI system 1100 include INTEL Math Kernel Library, NVIDIA cuDNN, EIGEN, and OpenBLAS.

The structure layer 1104 can include an ML framework 1114 and an algorithm 1116. The ML framework 1114 can be thought of as an interface, library, or tool that enables users to build and deploy the AI model. The ML framework 1114 can include an open-source library, an API, a gradient-boosting library, an ensemble method, and/or a deep learning toolkit that work with the layers of the AI system facilitate development of the AI model. For example, the ML framework 1114 can distribute processes for application or training of the AI model across multiple resources in the hardware platform 1110. The ML framework 1114 can also include a set of pre-built components that have the functionality to implement and train the AI model and enable users to use pre-built functions and classes to construct and train the AI model. Thus, the ML framework 1114 can be used to facilitate data engineering, development, hyperparameter tuning, testing, and training for the AI model. Examples of ML frameworks 1114 that can be used in the AI system 1100 include TENSORFLOW, PYTORCH, SCIKIT-LEARN, KERAS, LightGBM, RANDOM FOREST, and AMAZON WEB SERVICES.

The algorithm 1116 can be an organized set of computer-executable operations used to generate output data from a set of input data and can be described using pseudocode. The algorithm 1116 can include complex code that enables the computing resources to learn from new input data and create new/modified outputs based on what was learned. In some implementations, the algorithm 1116 can build the AI model through being trained while running computing resources of the hardware platform 1110. This training enables the algorithm 1116 to make predictions or decisions without being explicitly programmed to do so. Once trained, the algorithm 1116 can run at the computing resources as part of the AI model to make predictions or decisions, improve computing resource performance, or perform tasks. The algorithm 1116 can be trained using supervised learning, unsupervised learning, semi-supervised learning, and/or reinforcement learning.

Using supervised learning, the algorithm 1116 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected from various source computing systems described in relation to FIG. 1. Furthermore, training data can include pre-processed data generated by various engines of the data generation platform 102 described in relation to FIG. 1. The user may label the training data based on one or more classes and trains the AI model by inputting the training data to the algorithm 1116. The algorithm determines how to label the new data based on the labeled training data. The user can facilitate collection, labeling, and/or input via the ML framework 1114. In some instances, the user may convert the training data to a set of feature vectors for input to the algorithm 1116. Once trained, the user can test the algorithm 1116 on new data to determine if the algorithm 1116 is predicting accurate labels for the new data. For example, the user can use cross-validation methods to test the accuracy of the algorithm 1116 and retrain the algorithm 1116 on new training data if the results of the cross-validation are below an accuracy threshold.

Supervised learning can include classification and/or regression. Classification techniques include teaching the algorithm 1116 to identify a category of new observations based on training data and are used when input data for the algorithm 1116 is discrete. Said differently, when learning through classification techniques, the algorithm 1116 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 1116 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 1116 is continuous. Regression techniques can be used to train the algorithm 1116 to predict or forecast relationships between variables. To train the algorithm 1116 using regression techniques, a user can select a regression method for estimating the parameters of the model. The user collects and labels training data that is input to the algorithm 1116 such that the algorithm 1116 is trained to understand the relationship between data features and the dependent variable(s). Once trained, the algorithm 1116 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1116 learns patterns from unlabeled training data. In particular, the algorithm 1116 is trained to learn hidden patterns and insights of input data, which can be used for data exploration or for generating new data. Here, the algorithm 1116 does not have a predefined output, unlike the labels output when the algorithm 1116 is trained using supervised learning. Said another way, unsupervised learning is used to train the algorithm 1116 to find an underlying structure of a set of data, group the data according to similarities, and represent that set of data in a compressed format. The data generation platform 102 can use unsupervised learning to identify patterns in claim history (e.g., to identify particular event sequences) and so forth. In some implementations, performance of the AI models of the data management platform that can use unsupervised learning is improved because the incoming dataset is pre-processed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 1116 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1116 may be trained to be an Isolation Forest, local outlier factor (LOF) algorithm, or K-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 1116 include factor analysis, item response theory, latent profile analysis, and latent class analysis.

The model layer 1106 implements the AI model using data from the data layer and the algorithm 1116 and ML framework 1114 from the structure layer 1104, thus enabling decision-making capabilities of the AI system 1100. The model layer 1106 includes a model structure 1120, model parameters 1122, a loss function engine 1124, an optimizer 1126, and a regularization engine 1128.

The model structure 1120 describes the architecture of the AI model of the AI system 1100. The model structure 1120 defines the complexity of the pattern/relationship that the AI model expresses. Examples of structures that can be used as the model structure 1120 include decision trees, support vector machines, regression analyses, Bayesian networks, Gaussian processes, genetic algorithms, and artificial neural networks (or, simply, neural networks). The model structure 1120 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1120 may include one or more hidden layers of nodes between the input and output layers. The model structure 1120 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1122 represent the relationships learned during training and can be used to make predictions and decisions based on input data. The model parameters 1122 can weight and bias the nodes and connections of the model structure 1120. For instance, when the model structure 1120 is a neural network, the model parameters 1122 can weight and bias the nodes in each layer of the neural networks, such that the weights determine the strength of the nodes and the biases determine the thresholds for the activation functions of each node. The model parameters 1122, in conjunction with the activation functions of the nodes, determine how input data is transformed into desired outputs. The model parameters 1122 can be determined and/or altered during training of the algorithm 1116.

The loss function engine 1124 can determine a loss function, which is a metric used to evaluate the AI model's performance during training. For instance, the loss function engine 1124 can measure the difference between a predicted output of the AI model and the actual output of the AI model and is used to guide optimization of the AI model during training to minimize the loss function. The loss function may be presented via the ML framework 1114, such that a user can determine whether to retrain or otherwise alter the algorithm 1116 if the loss function is over a threshold. In some instances, the algorithm 1116 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1126 adjusts the model parameters 1122 to minimize the loss function during training of the algorithm 1116. In other words, the optimizer 1126 uses the loss function generated by the loss function engine 1124 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1126 used may be determined based on the type of model structure 1120 and the size of data and the computing resources available in the data layer 1102.

The regularization engine 1128 executes regularization operations. Regularization is a technique that prevents over- and under-fitting of the AI model. Overfitting occurs when the algorithm 1116 is overly complex and too adapted to the training data, which can result in poor performance of the AI model. Underfitting occurs when the algorithm 1116 is unable to recognize even basic patterns from the training data such that it cannot perform well on training data or on validation data. The optimizer 1126 can apply one or more regularization techniques to fit the algorithm 1116 to the training data properly, which helps constraint the resulting AI model and improves its ability for generalized application. Examples of regularization techniques include lasso (L1) regularization, ridge (L2) regularization, and elastic (L1 and L2 regularization).

The application layer 1108 describes how the AI system 1100 is used to solve problem or perform tasks. In an example implementation, the application layer 1108 can include a front-end user interface of the data generation platform 102.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

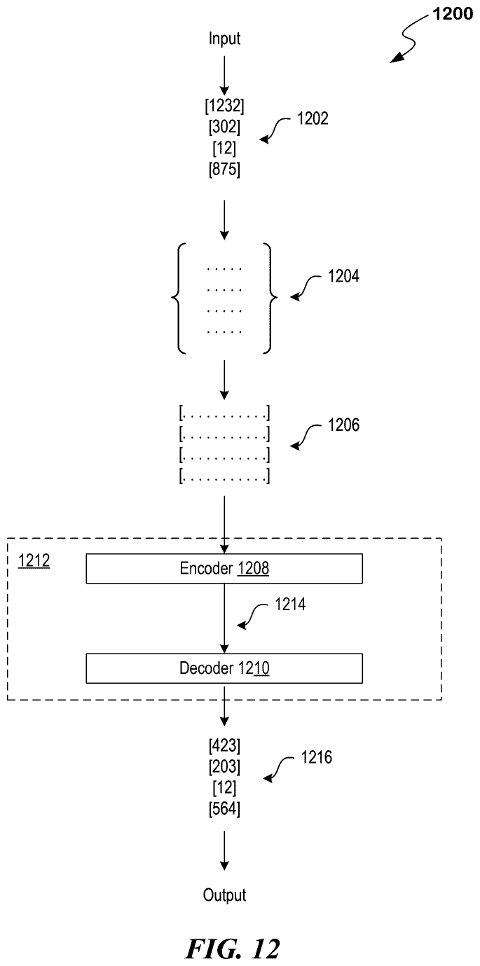

FIG. 12 is a block diagram of an example transformer 1212. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 1212 includes an encoder 1208 (which can comprise one or more encoder layers/blocks connected in series) and a decoder 1210 (which can comprise one or more decoder layers/blocks connected in series). Generally, the encoder 1208 and the decoder 1210 each include a plurality of neural network layers, at least one of which can be a self-attention layer. The parameters of the neural network layers can be referred to as the parameters of the language model.

The transformer 1212 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 1212 is trained to perform certain functions on other input formats than natural language input. For example, the input can include objects, images, audio content, or video content, or a combination thereof.

The transformer 1212 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 12 illustrates an example of how the transformer 1212 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 12, a short sequence of tokens 1202 corresponding to the input text is illustrated as input to the transformer 1212. Tokenization of the text sequence into the tokens 1202 can be performed by some pre-processing tokenization module such as, for example, a byte-pair encoding tokenizer (the “pre” referring to the tokenization occurring prior to the processing of the tokenized input by the LLM), which is not shown in FIG. 12 for simplicity. In general, the token sequence that is inputted to the transformer 1212 can be of any length up to a maximum length defined based on the dimensions of the transformer 1212. Each token 1202 in the token sequence is converted into an embedding vector 1206 (also referred to simply as an embedding 1206). An embedding 1206 is a learned numerical representation (such as, for example, a vector) of a token that captures some semantic meaning of the text segment represented by the token 1202. The embedding 1206 represents the text segment corresponding to the token 1202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1206 corresponding to the “write” token will be closer to another embedding corresponding to the “jot down” token in the vector space as compared to the distance between the embedding 1206 corresponding to the “write” token and another embedding corresponding to the “summary” token.

The vector space can be defined by the dimensions and values of the embedding vectors. Various techniques can be used to convert a token 1202 to an embedding 1206. For example, another trained ML model can be used to convert the token 1202 into an embedding 1206. In particular, another trained ML model can be used to convert the token 1202 into an embedding 1206 in a way that encodes additional information into the embedding 1206 (e.g., a trained ML model can encode positional information about the position of the token 1202 in the text sequence into the embedding 1206). In some examples, the numerical value of the token 1202 can be used to look up the corresponding embedding in an embedding matrix 1204 (which can be learned during training of the transformer 1212).

The generated embeddings 1206 are input into the encoder 1208. The encoder 1208 serves to encode the embeddings 1206 into feature vectors 1214 that represent the latent features of the embeddings 1206. The encoder 1208 can encode positional information (i.e., information about the sequence of the input) in the feature vectors 1214. The feature vectors 1214 can have very high dimensionality (e.g., on the order of thousands or tens of thousands), with each element in a feature vector 1214 corresponding to a respective feature. The numerical weight of each element in a feature vector 1214 represents the importance of the corresponding feature. The space of all possible feature vectors 1214 that can be generated by the encoder 1208 can be referred to as the latent space or feature space.

Conceptually, the decoder 1210 is designed to map the features represented by the feature vectors 1214 into meaningful output, which can depend on the task that was assigned to the transformer 1212. For example, if the transformer 1212 is used for a translation task, the decoder 1210 can map the feature vectors 1214 into text output in a target language different from the language of the original tokens 1202. Generally, in a generative language model, the decoder 1210 serves to decode the feature vectors 1214 into a sequence of tokens. The decoder 1210 can generate output tokens 1216 one by one. Each output token 1216 can be fed back as input to the decoder 1210 in order to generate the next output token 1216. By feeding back the generated output and applying self-attention, the decoder 1210 is able to generate a sequence of output tokens 1216 that has sequential meaning (e.g., the resulting output text sequence is understandable as a sentence and obeys grammatical rules). The decoder 1210 can generate output tokens 1216 until a special [EOT] token (indicating the end of the text) is generated. The resulting sequence of output tokens 1216 can then be converted to a text sequence in post-processing. For example, each output token 1216 can be an integer number that corresponds to a vocabulary index. By looking up the text segment using the vocabulary index, the text segment corresponding to each output token 1216 can be retrieved, the text segments can be concatenated together, and the final output text sequence can be obtained.

In some examples, the input provided to the transformer 1212 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computing Environment of the Data Management Platform

FIG. 13 is a block diagram showing some of the components typically incorporated in at least some of the computer systems and other devices 1300 on which the disclosed system operates. As shown, an example computer system 1300 can include: one or more processors 1302, main memory 1308, non-volatile memory 1312, a network interface device 1314, video display device 1320, an input/output device 1322, a control device 1324 (e.g., keyboard and pointing device), a drive unit 1326 that includes a machine-readable medium 1328, and a signal generation device 1332 that are communicatively connected to a bus 1318. The bus 1318 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computer system 1300 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 1300. In some implementations, the computer system 1300 can be an embedded computer system, a system-on-chip (SOC), a single-board computer system (SBC) or a distributed system such as a mesh of computer systems or include one or more cloud components in one or more networks. Where appropriate, one or more computer systems 1300 can perform operations in real-time, near real-time, or in batch mode.

The network interface device 1314 enables the computer system 1300 to exchange data in a network 1316 with an entity that is external to the computing system 1300 through any communication protocol supported by the computer system 1300 and the external entity. Examples of the network interface device 1314 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1308, non-volatile memory 1312, machine-readable medium 1328) can be local, remote, or distributed. Although shown as a single medium, the machine-readable medium 1328 can include multiple media (e.g., a centralized/distributed database and/or associated caches and servers) that store one or more sets of instructions 1330. The machine-readable (storage) medium 1328 can include any medium that is capable of storing, encoding, or carrying a set of instructions for execution by the computer system 1300. The machine-readable medium 1328 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1310, 1330) set at various times in various memory and storage devices in computing device(s). When read and executed by the processor 1302, the instruction(s) cause the computer system 1300 to perform operations to execute elements involving the various aspects of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration, but that various modifications can be made without deviating from the scope of the invention. Accordingly, the invention is not limited except as by the appended claims.

We claim:

1. A computing system comprising:
one or more processors; and
one or more non-transitory, computer-readable storage media storing instructions that, when executed by the one or more processors, cause the computing system to:
obtain a first input comprising (1) an input prompt associated with a domain, (2) a domain-specific key-value dataset, and (3) a domain-specific ontology map,
wherein the domain specifies a subset of a knowledge vector space,
wherein the domain-specific key-value dataset includes a key set representing a set of textual flags, associated with the domain, and a value set including a set of natural language descriptions,
wherein each key of the key set corresponds to a particular value of the value set, and
wherein the domain-specific ontology map comprises, in a computational logic ontology language format, a node set associated with the domain and a node relationship set between one or more nodes of the node set;
determine a version of the input prompt;
input the version of the input prompt, the domain-specific key-value dataset, and the domain-specific ontology map into a domain-sensitive language model to generate a first output set comprising a first natural language data set responsive to the version of the input prompt and associated with the domain;
input the domain-specific ontology map and the first output set into an ontology validation model to generate a first validation output set associated with the first output set,
wherein the first validation output set indicates whether the first output set is consistent with a rule set derived from the domain-specific ontology map, and
wherein the rule set includes at least one of: (1) structural rules, (2) semantic rules, (3) domain rules, or (4) compliance rules derived from the domain-specific ontology map;
in response to determining that the first validation output set indicates that the first output set is consistent with the rule set, determine a validated output set comprising the first output set;
in response to generating the validated output set, input the input prompt into a base language model to determine an unconstrained output set comprising natural language data responsive to the input prompt;
provide the validated output set and the unconstrained output set to a domain evaluation model to generate a domain-specificity indicator indicating whether the validated output set is specific to the domain based on a comparison between the validated output set and the unconstrained output set; and
in response to determining that the validated output set is specific to the domain, transmit the validated output set to a user device associated with the domain.

2. The computing system of claim 1, wherein the instructions for determining the version of the input prompt cause the computing system to:
input the input prompt, the domain-specific key-value dataset, and the domain-specific ontology map into the domain-sensitive language model to generate a preliminary output set comprising preliminary natural language data responsive to the input prompt;
input the domain-specific ontology map and the preliminary output set into the ontology validation model to generate a preliminary validation output set associated with the preliminary output set,
wherein the preliminary validation output set indicates that the preliminary output set is inconsistent with the rule set derived from the domain-specific ontology map;
in response to determining that the preliminary validation output set indicates that the preliminary output set is inconsistent with the rule set, generate, using at least one of the base language model or the domain-sensitive language model, the version of the input prompt comprising a modified version of the input prompt.

3. The computing system of claim 1, wherein the instructions for determining the version of the input prompt cause the computing system to:
obtain a latest version of a set of previous input versions of the input prompt,
wherein each version of the set of previous versions is input into the domain-sensitive language model to generate a corresponding preliminary output set that is used to generate a subsequent version of the set of previous versions;
determine an iteration count representing a number of iterations associated with the set of previous input versions;
compare the iteration count with a threshold iteration count representing a predetermined number of allowed iterations; and
in response to determining that the iteration count is equal to the threshold iteration count, determine that the version of the input prompt corresponds to the latest version of the set of previous input versions.

4. The computing system of claim 1, wherein the version of the input prompt comprises the input prompt.

5. The computing system of claim 1, wherein the instructions for generating the domain-specificity indicator cause the computing system to:
determine, using the domain-specific ontology map, a domain-specific characteristic set characterizing natural language datasets associated with the domain,
wherein the domain-specific characteristic set includes at least one of a domain-specific structural characteristic, a domain-specific semantic characteristic, or a domain-specific lexical characteristic;
determine a base characteristic metric value set for the unconstrained output set,
wherein each base characteristic metric value of the base characteristic metric value set indicates a particular degree of compliance of the unconstrained output set with a particular domain-specific characteristic of the domain-specific characteristic set;
determine a characteristic metric value set for the validated output set,
wherein each characteristic metric value of the characteristic metric value set indicates a particular degree of compliance of the validated output set with a particular domain-specific characteristic of the domain-specific characteristic set; and
compare the base characteristic metric value set with the characteristic metric value set; and
in response to comparing the base characteristic metric value set with the characteristic metric value set, generate the domain-specificity indicator including an indication that the validated output set is specific to the domain.

6. The computing system of claim 5, wherein the instructions for comparing the base characteristic metric value set with the characteristic metric value set cause the computing system to:
determine a difference metric value characterizing a difference between the characteristic metric value set and the base characteristic metric value set; and
determine that the difference metric value exceeds a threshold difference metric value.

7. The computing system of claim 1, wherein the instructions for generating the first output set cause the computing system to:
input at least one of the domain-specific ontology map or the domain-specific key-value dataset into the base language model to generate a generation template for output generation based on the version of the input prompt,
wherein the generation template includes at least one of: (1) domain-specific structural information, (2) domain-specific validation criteria, (3) domain-specific natural language constraint rules, or (4) a domain-specific example natural language dataset;
generate an augmented input prompt including a representation of the generation template; and
input the augmented input prompt into the base language model to generate the first output set.

8. The computing system of claim 1, wherein the instructions for obtaining the domain-specific ontology map further cause the computing system to:
obtain a preliminary domain-specific ontology map;
obtain a representation of a domain-related update,
wherein the domain-related update includes a modification in at least one of an ontological constraint, a validation criterion, a conceptual hierarchy attribute, or a reasoning rule set; and
provide the representation of the domain-related update and the preliminary domain-specific ontology map to the base language model to generate an updated domain-specific ontology map comprising the domain-specific ontology map.

9. The computing system of claim 1, wherein the instructions for obtaining the domain-specific ontology map further cause the computing system to:
obtain, via a graphical user interface of the user device, a representation of a domain-specific ontology comprising at least one of: a class hierarchy dataset, an object property dataset, a cardinality constraint dataset, a range constraint dataset, a complex logical expression dataset, or computational logic ontology language rule set;
provide the representation of the domain-specific ontology to a computational reasoner model to generate an inferred ontological rule set associated with the representation of the domain-specific ontology; and
generate the domain-specific ontology map based on the inferred ontological rule set.

10. The computing system of claim 1, wherein the instructions for obtaining the first input cause the computing system to:
obtain a simulated dataset associated with a data transformation pipeline comprising simulated node data for the one or more nodes of the node set,
wherein the simulated dataset is generated using the domain-specific ontology map;
generate the input prompt including a request to validate the simulated dataset against the domain-specific ontology map; and
generate the first input including the simulated dataset, the input prompt, the domain-specific key-value dataset, and the domain-specific ontology map.

11. One or more non-transitory, computer-readable storage media storing instructions that, when executed by one or more processors, cause a computing system to:
obtain a first input comprising (1) an input prompt associated with a domain, (2) a domain-specific lexical dataset, and (3) a domain-specific ontology map,
wherein the domain specifies a subset of a knowledge vector space,
wherein the domain-specific lexical dataset includes at least one of semantic or lexical information associated with the domain, and
wherein the domain-specific ontology map comprises, in a logical format, a node set associated with the domain and a node relationship set between one or more nodes of the node set;
input the input prompt, the domain-specific lexical dataset, and the domain-specific ontology map into a domain-sensitive artificial intelligence (AI) model to generate a first output set comprising a first data set responsive to the input prompt and associated with the domain;
input the domain-specific ontology map and the first output set into an ontology validation model to generate a first validation output set associated with the first output set,
wherein the first validation output set indicates whether the first output set is consistent with a logical rule set derived from the domain-specific ontology map;
in response to determining that the first validation output set indicates that the first output set is consistent with the rule set, determine a validated output set comprising the first output set;
in response to generating the validated output set, input the input prompt into a base AI model to determine an unconstrained output set comprising natural language data responsive to the input prompt;
provide the validated output set and the unconstrained output set to a domain evaluation model to generate a domain-specificity indicator indicating whether the validated output set is specific to the domain based on a comparison between the validated output set and the unconstrained output set; and
in response to determining that the validated output set is specific to the domain, transmit the validated output set to a user device associated with the domain.

12. The one or more non-transitory, computer-readable storage media of claim 10, wherein the instructions further cause the computing system to:
obtain a latest version of a set of previous versions of the input prompt,
wherein each version of the set of previous versions is input into the domain-sensitive AI model to generate a corresponding preliminary output set that is used to generate a subsequent version of the set of previous versions;
determine an iteration count representing a number of iterations associated with the set of previous versions;
compare the iteration count with a threshold iteration count representing a predetermined number of allowed iterations; and
in response to determining that the iteration count is equal to the threshold iteration count, determine that the input prompt corresponds to the latest version of the set of previous versions.

13. The one or more non-transitory, computer-readable storage media of claim 11, wherein the instructions for generating the domain-specificity indicator cause the computing system to:
determine, using the domain-specific ontology map, a domain-specific characteristic set characterizing natural language datasets associated with the domain, wherein the domain-specific characteristic set includes at least one of a domain-specific structural characteristic, a domain-specific semantic characteristic, or a domain-specific lexical characteristic;
determine a base characteristic metric value set for the unconstrained output set,
wherein each base characteristic metric value of the base characteristic metric value set indicates a particular degree of compliance of the unconstrained output set with a particular domain-specific characteristic of the domain-specific characteristic set;
determine a characteristic metric value set for the validated output set,
wherein each characteristic metric value of the characteristic metric value set indicates a particular degree of compliance of the validated output set with a particular domain-specific characteristic of the domain-specific characteristic set; and
compare the base characteristic metric value set with the characteristic metric value set; and
in response to comparing the base characteristic metric value set with the characteristic metric value set, generate the domain-specificity indicator including an indication that the validated output set is specific to the domain.

14. The one or more non-transitory, computer-readable storage media of claim 13, wherein the instructions for comparing the base characteristic metric value set with the characteristic metric value set cause the computing system to:
determine a difference metric value characterizing a difference between the characteristic metric value set and the base characteristic metric value set; and
determine that the difference metric value exceeds a threshold difference metric value.

15. The one or more non-transitory, computer-readable storage media of claim 11, wherein the instructions for generating the first output set cause the computing system to:
input at least one of the domain-specific ontology map or the domain-specific lexical dataset into the base AI model to generate a generation template for output generation based on the input prompt,
wherein the generation template includes at least one of: (1) domain-specific structural information, (2) domain-specific validation criteria, (3) domain-specific natural language constraint rules, or (4) a domain-specific example natural language dataset;
generate an augmented input prompt including a representation of the generation template; and
input the augmented input prompt into the base AI model to generate the first output set.

16. The one or more non-transitory, computer-readable storage media of claim 11, wherein the instructions for obtaining the domain-specific ontology map further cause the computing system to:
obtain a preliminary domain-specific ontology map;
obtain a representation of a domain-related update,
wherein the domain-related update includes a modification in at least one of an ontological constraint, a validation criterion, a conceptual hierarchy attribute, or a reasoning rule set; and
provide the representation of the domain-related update and the preliminary domain-specific ontology map to the base AI model to generate an updated domain-specific ontology map comprising the domain-specific ontology map.

17. The one or more non-transitory, computer-readable storage media of claim 11, wherein the instructions for obtaining the domain-specific ontology map further cause the computing system to:
obtain, via a graphical user interface of the user device, a representation of a domain-specific ontology comprising at least one of: a class hierarchy dataset, an object property dataset, a cardinality constraint dataset, a range constraint dataset, a complex logical expression dataset, or computational logic ontology language rule set;
provide the representation of the domain-specific ontology to a computational reasoner model to generate an inferred ontological rule set associated with the representation of the domain-specific ontology; and
generate the domain-specific ontology map based on the inferred ontological rule set.

18. A method comprising:
obtaining (1) an input associated with a domain, (2) a domain-specific lexical dataset, and (3) a domain-specific ontology map,
wherein the domain specifies an indication of a subject matter area,
wherein the domain-specific lexical dataset includes at least one of semantic or lexical information associated with the domain, and
wherein the domain-specific ontology map comprises, in a logical format, a node set associated with the domain and a node relationship set between one or more nodes of the node set;
inputting the input, the domain-specific lexical dataset, and the domain-specific ontology map into a domain-sensitive AI model to generate a first output set comprising a first data set responsive to the input and associated with the domain;
inputting the domain-specific ontology map and the first output set into an ontology validation model to generate a first validation output set associated with the first output set,
wherein the first validation output set indicates whether the first output set is consistent with a logical rule set derived from the domain-specific ontology map;
in response to determining that the first validation output set indicates that the first output set is consistent with the rule set, determining a validated output set comprising the first output set;
inputting, in parallel with generating the first output set, the input into a base AI model to determine an unconstrained output set comprising natural language data responsive to the input;
providing the validated output set and the unconstrained output set to a domain evaluation model to generate a domain-specificity indicator indicating whether the validated output set is specific to the domain based on a comparison between the validated output set and the unconstrained output set; and
in response to determining that the validated output set is specific to the domain, transmitting the validated output set to a user device associated with the domain.

19. The method of claim 18, further comprising:
obtaining a latest version of a set of previous versions of the input,
wherein each version of the set of previous versions is input into the domain-sensitive AI model to generate a corresponding preliminary output set that is used to generate a subsequent version of the set of previous versions;
determining an iteration count representing a number of iterations associated with the set of previous versions;
comparing the iteration count with a threshold iteration count representing a predetermined number of allowed iterations; and
in response to determining that the iteration count is equal to the threshold iteration count, determining that the input corresponds to the latest version of the set of previous versions.

20. The method of claim 18, wherein generating the domain-specificity indicator comprises:
determining, using the domain-specific ontology map, a domain-specific characteristic set characterizing natural language datasets associated with the domain, wherein the domain-specific characteristic set includes at least one of a domain-specific structural characteristic, a domain-specific semantic characteristic, or a domain-specific lexical characteristic;
determining a base characteristic metric value set for the unconstrained output set,
wherein each base characteristic metric value of the base characteristic metric value set indicates a particular degree of compliance of the unconstrained output set with a particular domain-specific characteristic of the domain-specific characteristic set;
determining a characteristic metric value set for the validated output set,
wherein each characteristic metric value of the characteristic metric value set indicates a particular degree of compliance of the validated output set with a particular domain-specific characteristic of the domain-specific characteristic set; and
comparing the base characteristic metric value set with the characteristic metric value set; and
in response to comparing the base characteristic metric value set with the characteristic metric value set, generating the domain-specificity indicator including an indication that the validated output set is specific to the domain.
